(19) United States
(12) Patent Application Publication
(10) Pub. No.: US 2026/0220575 A1
(43) Pub. Date: Jul. 30, 2026

(54) Platform-Enabled Orchestration and Optimization of Digital Workflows

(71) Applicant: Istari Digital, Inc., Charleston, SC (US)

(72) Inventors: William Roper, JR., Charleston, SC (US); Christopher Lee Benson, Arlington, VA (US); Sriram Krishnan, Cambridge, MA (US); Steven Douglas Lauver, Alexandria, VA (US); Baha aldeen E. A. Abunojaim, Roslindale, MA (US); Peter Galvin, Watertown, MA (US); Ellie Daw, Kirkland, WA (US)

(21) Appl. No.: 19/569,041

(22) Filed: Mar. 17, 2026

Related U.S. Application Data
(63) Continuation of application No. PCT/US24/47434, filed on Sep. 19, 2024.
(60) Provisional application No. 63/584,165, filed on Sep. 20, 2023.

(51) Int. Cl. G06Q 10/0631; H04L 9/40

(52) U.S. Cl. CPC G06Q 10/06316; H04L 63/105

(57) ABSTRACT

Systems and methods for optimizing a digital workflow within a digital platform are provided. An illustrative method includes generating, based on a user request, a decentralized digital thread associated with the digital workflow, and generating a workflow data structure based on the decentralized digital thread. The method also includes calculating a workflow cost associated with executing one or more workflow tasks of the workflow data structure, and identifying a cost-reducing modification to the workflow data structure. Finally, the method includes generating an updated workflow data structure and a corresponding updated decentralized digital thread based on the identified modification. In various embodiments, the cost-reducing modification is identified using expert user feedback, a graph optimization algorithm, a workflow optimization machine learning model, and/or a prediction machine learning model.

### REFERENCE TO RELATED APPLICATIONS

If an Application Data Sheet (“ADS”) or PCT Request Form (“Request”) has been filed on the filing date of this application, it is incorporated by reference herein. Any applications claimed on the ADS or Request for priority under 35 U.S.C. §§ 119, 120, 121, or 365 (c), and any and all parent, grandparent, great-grandparent, etc. applications of such applications, are also incorporated by reference, including any priority claims made in those applications and any material incorporated by reference, to the extent such subject matter is not inconsistent herewith.

Furthermore, this application is related to the U.S. patent applications listed below, which are incorporated by reference in their entireties herein, as if fully set forth herein:
PCT application No. PCT/US24/44938 (Docket No. IST-03.006PCT), filed on Sep. 1, 2024 entitled “Multimodal Digital Document Interfaces for Dynamic and Collaborative Reviews,” describes interface enhancement for digital software platforms.
PCT application No. PCT/US24/42768 (Docket No. IST-02.004PCT), filed on Aug. 16, 2024, entitled “Artificial Intelligence (AI) Assisted Automation of Testing in Software Environments,” describes workflow enhancement for digital software platforms.
PCT application No. PCT/US24/40624 (Docket No. IST-03.003PCT), filed on Aug. 1, 2024, entitled “Machine Learning Engine for Workflow Enhancement in Digital Workflows,” describes workflow enhancement for digital software platforms.
PCT application No. PCT/US24/40468 (Docket No. IST-03.004PCT), filed on Jul. 31, 2024, entitled “Multimodal User Interfaces for Interacting with Digital Model Files,” describes multimodal user interfaces for digital software platforms.
PCT application No. PCT/US24/38878 (Docket No. IST-03.002PCT), filed on Jul. 19, 2024, entitled “Generative Artificial Intelligence (AI) for Digital Workflows,” describes efficient AI-assisted script generation methods that preserve customer data sovereignty.
PCT application No. PCT/US24/35885 (Docket No. IST-02.002PCT), filed on Jun. 27, 2024, entitled “Artificial Intelligence (AI) Assisted Integration of New Digital Model Types and Tools into Integrated Digital Model Platform,” describes the enhancement of model splicer technology through AI-assistance.
PCT application No. PCT/US24/27912 (Docket No. IST-02.003PCT), filed on May 5, 2024, entitled “Secure and Scalable Sharing of Digital Engineering Documents,” describes secure and scalable document splicing technology.
PCT application No. PCT/US24/27898 (Docket No. IST-03.001PCT), filed on May 4, 2024, entitled “Digital Twin Enhancement using External Feedback within Integrated Digital Model Platform,” describes digital and physical twin management and the integration of external feedback within a DE platform.
PCT application No. PCT/US24/19297 (Docket No. IST-01.002PCT), filed on Mar. 10, 2024, entitled “Software-Code-Defined Digital Threads in Digital Engineering Systems with Artificial Intelligence (AI) Assistance,” describes AI-assisted digital threads for digital engineering platforms.
PCT application No. PCT/US24/18278 (Docket No. IST-02.001PCT), filed on Mar. 3, 2024, entitled “Secure and Scalable Model Splicing of Digital Engineering Models for Software-Code-Defined Digital Threads,” describes model splicing for digital engineering platforms.
PCT application No. PCT/US24/14030 (Docket No. IST-01.001PCT), filed on Feb. 1, 2024, entitled “Artificial Intelligence (AI) Assisted Digital Documentation for Digital Engineering,” describes AI-assisted documentation for digital engineering platforms.
U.S. provisional patent application No. 63/442,659 (Docket No. IST-01.001P), filed on Feb. 1, 2023, entitled “AI-Assisted Digital Documentation for Digital Engineering with Supporting Systems and Methods,” describes AI-assistance tools for digital engineering (DE), including modeling and simulation applications, and the certification of digitally engineered products.
U.S. provisional patent application No. 63/451,545 (Docket No. IST-01.002P), filed on Mar. 10, 2023, entitled “Digital Threads in Digital Engineering Systems, and Supporting AI-Assisted Digital Thread Generation,” describes model splicer and digital threading technology.
U.S. provisional patent application No. 63/451,577 (Docket No. IST-02.001P1), filed on Mar. 11, 2023, entitled “Model Splicer and Microservice Architecture for Digital Engineering,” describes model splicer technology.
U.S. provisional patent application No. 63/462,988 (Docket No. IST-02.001P2), filed on Apr. 29, 2023, also entitled “Model Splicer and Microservice Architecture for Digital Engineering,” describes model splicer technology.
U.S. provisional patent application No. 63/511,583 (Docket No. IST-02.002P), filed on Jun. 30, 2023, entitled “AI-Assisted Model Splicer Generation for Digital Engineering,” describes model splicer technology with AI-assistance.
U.S. provisional patent application No. 63/516,624 (Docket No. IST-02.003P), filed on Jul. 31, 2023, entitled “Document and Model Splicing for Digital Engineering,” describes document splicer technology.
U.S. provisional patent application No. 63/520,643 (Docket No. IST-02.004P), filed on Aug. 20, 2023, entitled “Artificial Intelligence (AI)-Assisted Automation of Testing in a Software Environment,” describes software testing with AI-assistance.
U.S. provisional patent application No. 63/590,420 (Docket No. IST-02.005P), filed on Oct. 14, 2023, entitled “Commenting and Collaboration Capability within Digital Engineering Platform,” describes collaborative capabilities.
U.S. provisional patent application No. 63/586,384 (Docket No. IST-02.006P), filed on Sep. 28, 2023, entitled “Artificial Intelligence (AI)-Assisted Streamlined Model Splice Generation, Unit Testing, and Documentation,” describes streamlined model splicing, testing and documentation with AI-assistance.
U.S. provisional patent application No. 63/470,870 (Docket No. IST-03.001P), filed on Jun. 3, 2023, entitled “Digital Twin and Physical Twin Management with Integrated External Feedback within a Digital Engineering Platform,” describes digital and physical twin management and the integration of external feedback within a DE platform.
U.S. provisional patent application No. 63/515,071 (Docket No. IST-03.002P), filed on Jul. 21, 2023, entitled “Generative Artificial Intelligence (AI) for Digital Engineering,” describes an AI-enabled digital engineering task fulfillment process within a DE software platform.
U.S. provisional patent application No. 63/517,136 (Docket No. IST-03.003P), filed on Aug. 2, 2023, entitled “Machine Learning Engine for Workflow Enhancement in Digital Engineering,” describes a machine learning engine for model splicing and DE script generation.
U.S. provisional patent application No. 63/516,891 (Docket No. IST-03.004P), filed on Aug. 1, 2023, entitled “Multimodal User Interfaces for Digital Engineering,” describes multimodal user interfaces for DE systems.
U.S. provisional patent application No. 63/580,384 (Docket No. IST-03.006P), filed on Sep. 3, 2023, entitled “Multimodal Digital Engineering Document Interfaces for Certification and Security Reviews,” describes multimodal user interfaces for certification and security reviews.
U.S. provisional patent application No. 63/613,556 (Docket No. IST-03.008P), filed on Dec. 21, 2023, entitled “Alternative Tool Selection and Optimization in an Integrated Digital Engineering Platform,” describes tool selection and optimization.
U.S. provisional patent application No. 63/584,165 (Docket No. IST-03.010P), filed on Sep. 20, 2023, entitled “Methods and Systems for Improving Workflows in Digital Engineering,” describes workflow optimization in a DE platform.
U.S. provisional patent application No. 63/590,456 (Docket No. IST-04.001P), filed on Oct. 15, 2023, entitled “Data Sovereignty Assurance for Artificial Intelligence (AI) Models,” relates to data sovereignty assurance during AI model training and evaluation.
U.S. provisional patent application No. 63/606,030 (Docket No. IST-04.001P2), filed on Dec. 4, 2023, also entitled “Data Sovereignty Assurance for Artificial Intelligence (AI) Models,” further details data sovereignty assurances during AI model training and evaluation.
U.S. provisional patent application No. 63/419,051, filed on Oct. 25, 2022, entitled “Interconnected Digital Engineering and Certification Ecosystem.”
U.S. non-provisional patent application Ser. No. 17/973,142 (Docket No. 54332-0057001) filed on Oct. 25, 2022, entitled “Interconnected Digital Engineering and Certification Ecosystem.”
U.S. non-provisional patent application Ser. No. 18/383,635 (Docket No. 54332-0059001), filed on Oct. 25, 2023, entitled “Interconnected Digital Engineering and Certification Ecosystem.”
U.S. provisional patent application No. 63/489,401, filed on Mar. 9, 2023, entitled “Security Architecture for Interconnected Digital Engineering and Certification Ecosystem.”

### Notice of Copyrights and Tradedress

A portion of the disclosure of this patent document contains material which is subject to copyright protection. This patent document may show and/or describe matter which is or may become tradedress of the owner. The copyright and tradedress owner has no objection to the facsimile reproduction by anyone of the patent disclosure as it appears in the U.S. Patent and Trademark Office files or records, but otherwise reserves all copyright and tradedress rights whatsoever.

ISTARI DIGITAL is a trademark name carrying embodiments of the present invention, and hence, the aforementioned trademark name may be interchangeably used in the specification and drawings to refer to the products/process offered by embodiments of the present invention. The terms ISTARI and ISTARI DIGITAL may be used in this specification to describe the present invention, as well as the company providing said invention.

### FIELD OF THE INVENTION

This invention relates to digital software platforms, and more specifically to improving and optimizing digital workflows within said digital software platforms.

### BACKGROUND OF THE INVENTION

The statements in the background of the invention are provided to assist with understanding the invention and its applications and uses, and may not constitute prior art.

Digital workflows have become indispensable across various fields of human endeavor, revolutionizing how tasks are accomplished. From healthcare and finance to manufacturing and creative industries, these automated sequences of digital operations streamline complex procedures, enhance collaboration, and boost productivity. By leveraging technology to orchestrate tasks, manage data flow, and facilitate decision-making, digital workflows enable organizations to operate with greater efficiency, accuracy, and scalability. They not only reduce manual errors and save time but also provide valuable insights through data analytics, allowing for continuous improvement and innovation in diverse sectors of the economy and society.

Current approaches to digital workflows often suffer from inefficiencies due to the fragmentation of tools and processes across large teams. Organizations find themselves grappling with a patchwork of disparate and incompatible software solutions, each serving a specific function but failing to integrate seamlessly with other software. This lack of cohesion leads to data silos, communication breakdowns, and redundant work as team members struggle to transfer information between systems. Consequently, valuable time and resources are lost in manual data entry, format conversions, and reconciling conflicting information across platforms. These inefficiencies not only slow down project timelines but also increase the risk of errors and miscommunications, ultimately hampering productivity and innovation potential.

For example, within the field of engineering, current approaches to digital engineering involve inefficient processes with a large number of engineers working with many disparate engineering tools. This typically requires massive teams of highly specialized engineers and software developers working with data and models from the siloed tools, while cross-platform collaboration is often further impeded by the mismatch of software skill sets among highly expensive subject matter experts, given the sheer number of different digital engineering model types in use today. The resulting “spaghetti monster” of code, data, and engineering models is difficult to track and update, especially with limited budgets. The vast resources dedicated to digital engineering are thus compounded by massive overhead related to the size of the engineering teams and to the file-by-file integration of hundreds of digital engineering models, leading to repetitive work and to an explosion of in the budget.

In the realm of digital engineering (DE), digital threads are instrumental in carrying out digital engineering workflows such as the execution of certification requirements. Digital threads enable the integration of various engineering disciplines into a unified workflow, facilitating the sharing and management of data across different stages of the product life cycle. This includes design data, simulation results, testing data, and operational data, all of which are integral to meeting certification requirements. By leveraging digital threads, digital engineers can ensure that their workflows are executed successfully. In particular, they can ensure that designs comply with the relevant certification requirements from the outset, thereby reducing the risk of non-compliance and rework. Moreover, digital threads can enhance the traceability and transparency of the engineering process, thus providing a comprehensive record of the product's lifecycle that may be invaluable for ongoing product certification.

Like any digital workflow, meeting certification requirements can be a complex and inefficient process. One of the main challenges is the redundancy in the assessment process. For instance, the same model may be evaluated multiple times by different teams or individuals, leading to unnecessary duplication of effort. This not only wastes valuable resources but can also lead to inconsistencies in the assessment results.

Digital workflows in fields outside of digital engineering experience similar limitations, and would greatly benefit from streamlined orchestration and optimization of such digital workflows.

Therefore, there is an unsolved need for a system that streamlines the management and optimization of digital workflows in general, and digital certification processes in digital engineering in particular. Accordingly, it would be an advancement in the state of the art to enable the systematic enhancement of digital workflows in order to eliminate redundancies and increase overall efficiency in the process. Such a process would facilitate more integrated and efficient digital workflows, particularly within a digital software platform integrating multidisciplinary models from disparate, disconnected tools.

It is against this background that various embodiments of the present invention are developed.

### BRIEF SUMMARY OF THE INVENTION

This summary of the invention provides a broad overview of the invention, its application, and uses, and is not intended to limit the scope of the present invention, which will be apparent from the detailed description when read in conjunction with the drawings.

The advent of model splicing as described below, and as further described in PCT applications No. PCT/US24/18278 (Docket No. IST-02.001PCT), No. PCT/US24/19297 (Docket No. IST-01.002PCT), No. PCT/US24/18278 (Docket No. IST-02.001PCT), and No. PCT/US24/27898 (Docket No. IST-03.001PCT), enables the scripting of digital model operations encompassing disparate digital software tools into a corpus of normative program code. As a consequence, a large space of digital activities can be threaded into program code, including model generation, model modification, model data sharing, thread generation, thread modification, thread data extraction, thread data sharing, digital twin generation, digital twin modification, digital twin data extraction, and digital twin sharing.

In turn, the transformation of digital operations into software-code-defined digital threads enables a more systematic mapping between coded and graphical representations of workflows, thus enabling the tracing and elimination of workflow inefficiencies. Furthermore, the transformation of digital operations into code also enables the generation and training of AI modules for the purpose of analyzing and optimizing digital workflows. This allows for programmable, machine-learnable, and dynamic analysis and enhancement of digital workflows, and ultimately to the corresponding digital or physical twins and/or processes. Furthermore, it allows for powerful continuous integration and development (CI/CD) tools, as discussed below.

Specifically, the creation and integration of digital twins and digital threads face several key challenges, as identified in recent research, particularly by the National Academy of Engineering (NAE). A major challenge is interoperability, where seamless data integration across diverse platforms is critical. Efficient real-time data management is essential for reflecting changes in physical systems accurately, requiring advanced processing architectures. Verification, validation, and uncertainty quantification (VVUQ) are crucial to ensuring the reliability of digital twins, especially as they evolve alongside their physical counterparts. Additionally, cybersecurity concerns arise due to the sensitive data digital twins handle, necessitating robust protection mechanisms. Lastly, scalability remains a significant issue, particularly when integrating multiple digital twins into comprehensive digital threads that span entire system lifecycles. Addressing these challenges is central to developing more integrated and user-friendly digital modeling platforms. The digital platform described herein presents a system where digital threads on the IDMP uniquely solve many of the challenges identified in the NAE report.

Therefore, the cross-tool scripting of any digital operation related to the creation and manipulation of digital model files and digital threads, as described herein, potentially leads to dramatic reductions in costs and delays throughout all phases of a digital product and/or process lifecycle. In particular, the transformation of digital operations into code enables the representation of digital workflows as graphs, for example, as directed acyclic graphs (DAGs). This enables the use of systematic methods to reduce workflow complexity by eliminating inefficiencies, as discussed below.

Accordingly, various methods, processes, and non-transitory storage media storing program code for optimizing a digital workflow within a digital platform are within the scope of the present invention.

In a first aspect, an embodiment of the present invention is a non-transitory physical storage medium storing program code. The program code is executable by a hardware processor. The hardware processor when executing the program code causes the hardware processor to execute a computer-implemented process for optimizing a digital workflow within a digital platform.

The non-transitory storage medium may include program code to receive a user request from a user related to the digital workflow in the digital platform. The non-transitory storage medium may also include program code to generate a decentralized digital thread associated with the digital workflow based on the user request. The decentralized digital thread may provide access to at least two different digital artifacts from two or more distinct security networks and/or from two or more distinct software tools. The non-transitory storage medium may include program code to generate a workflow data structure based on the decentralized digital thread. The workflow data structure may include one or more workflow nodes representing one or more workflow tasks. One or more workflow connections may represent data flow required by the one or more workflow tasks. The non-transitory storage medium may include program code to calculate a workflow cost associated with executing the one or more workflow tasks in the workflow data structure. The non-transitory storage medium may include program code to identify at least one modification to the workflow data structure by processing the workflow data structure. The at least one modification to the workflow data structure may reduce the workflow cost. The non-transitory storage medium may include program code to generate an updated workflow data structure based on the workflow data structure and the at least one modification. Finally, the non-transitory storage medium may include program code to generate an updated decentralized digital thread based on the updated workflow data structure.

In one embodiment, the at least two different digital artifacts may have at least two distinct security access levels.

In another embodiment, the workflow cost may include a sum of workflow connection costs. A given workflow connection cost may be associated with a given data flow between two or more given workflow nodes.

In yet another embodiment, the workflow cost may include a sum of workflow node costs. A given workflow node cost may be associated with a given workflow task represented by a given workflow node.

In one embodiment, the at least one modification may include at least one of deleting a workflow node, deleting a workflow connection, adding a workflow node, and adding a workflow connection.

In another embodiment, the at least one modification may include at least one of modifying a workflow node, modifying a workflow connection, modifying a connection cost, and modifying a node cost.

In yet another embodiment, the workflow data structure may be a graph.

In one embodiment, the graph may be a directed acyclic graph (DAG).

In another embodiment, the program code to process the workflow data structure may utilize a graph optimization algorithm. The updated workflow data structure may be generated based on an output of the graph optimization algorithm.

In yet another embodiment, the graph optimization algorithm may be a minimum spanning tree (MST) algorithm.

In one embodiment, one of the at least two different digital artifacts may be accessed by the decentralized digital thread through a model representation.

In another embodiment, the model representation may include a model splice connected to a digital model file. The model splice may include one or more splice data items and a splice function providing an Application Programming Interface (API) or Software Development Kit (SDK) endpoint to access to the digital artifact.

In yet another embodiment, the digital workflow may be a certification workflow in a digital engineering process.

In one embodiment, the non-transitory storage medium may further include program code to provide a visual representation of the updated workflow data structure to the user, receive feedback data from the user, and further update the updated workflow data structure based on the feedback data.

In a second aspect or in another embodiment, a method for optimizing a digital workflow within a digital platform is provided. The method may include receiving a user request from a user related to the digital workflow in the digital platform. The method may also include generating a decentralized digital thread associated with the digital workflow based on the user request. The decentralized digital thread may provide access to at least two different digital artifacts from two or more distinct security networks and/or from two or more distinct software tools. The method may also include generating a workflow data structure based on the decentralized digital thread. The workflow data structure may include one or more workflow nodes representing one or more workflow tasks. One or more workflow connections may represent data flow required by the one or more workflow tasks. The method may also include calculating a workflow cost associated with executing the one or more workflow tasks in the workflow data structure. The method may also include identifying at least one modification to the workflow data structure by processing the workflow data structure. The at least one modification to the workflow data structure may reduce the workflow cost. The method may also include generating an updated workflow data structure based on the workflow data structure and the at least one modification. Finally, the method may also include generating an updated decentralized digital thread based on the updated workflow data structure.

Embodiments as set out for the first aspect apply equally to the second aspect.

In a third aspect or in another embodiment, a system for optimizing a digital workflow within a digital platform is provided. The system comprises at least one hardware processor, and at least one memory storing program code. The program code is executable by the at least one hardware processor to cause the at least one hardware processor to execute the aforementioned steps.

Embodiments as set out for the first and second aspects apply equally to the third aspect.

In a fourth aspect or in another embodiment, a non-transitory physical storage medium storing program code is provided. The program code is executable by a hardware processor. The hardware processor when executing the program code causes the hardware processor to execute a computer-implemented process for optimizing a digital workflow within a digital platform.

The non-transitory storage medium may include program code to receive a user request from a user related to the digital workflow in the digital platform. The non-transitory storage medium may include program code to generate a decentralized digital thread associated with the digital workflow based on the user request. The decentralized digital thread may provide access to at least two different digital artifacts from two or more distinct security networks and/or from two or more distinct software tools. The non-transitory storage medium may include program code to generate a workflow data structure based on the decentralized digital thread. The workflow data structure may include one or more workflow nodes representing one or more workflow tasks, and one or more workflow connections representing data flow required by the one or more workflow tasks.

The non-transitory storage medium may include program code to generate an updated workflow data structure based on the workflow data structure using a workflow optimization machine learning (ML) model. The workflow optimization machine learning (ML) model may be trained using a workflow dataset of the digital platform including a plurality of sample workflow data structures and a plurality of corresponding modified sample workflow data structures. In the workflow dataset, a workflow cost of a given sample workflow data structure of the workflow dataset may be higher that a modified workflow cost of a given corresponding modified sample workflow data structure. In the workflow dataset, the workflow cost of the given sample workflow data structure may be associated with executing one or more given workflow tasks of the given sample workflow data structure.

Finally, the non-transitory storage medium may include program code to generate an updated decentralized digital thread based on the updated workflow data structure.

In one embodiment, the program code to generate the updated workflow data structure may further include program code to predict a predicted data structure element using a workflow prediction machine learning (ML) model. The workflow prediction machine learning (ML) model may be trained using a prediction dataset of the digital platform including two or more sample workflow data structures and two or more corresponding predicted data structure elements. The predicted data structure element may include at least one of a workflow node and a workflow connection. Finally, the updated workflow data structure may include the predicted data structure element.

In another embodiment, at least one workflow of the workflow dataset may be derived from one or more sample user actions stored by the digital platform in a user action database of the digital platform.

In yet another embodiment, the non-transitory storage medium may further include program code to provide a visual representation of the updated workflow data structure to the user, receive feedback data from the user, and further update the workflow data structure based on the feedback data.

Embodiments as set out for the previous aspects apply equally to the fourth aspect.

In a fifth aspect or in another embodiment, a non-transitory physical storage medium storing program code is provided. The program code is executable by a hardware processor. The hardware processor when executing the program code causes the hardware processor to execute a computer-implemented process for optimizing a digital workflow within a digital platform.

The non-transitory storage medium may include program code to receive a user request from a user related to the digital workflow in the digital platform.

The non-transitory storage medium may also include program code to generate a decentralized digital thread associated with the digital workflow based on the user request. The decentralized digital thread may provide access to at least two different digital artifacts from two or more distinct security networks and/or from two or more distinct software tools.

The non-transitory storage medium may also include program code to generate a workflow data structure based on the decentralized digital thread. The workflow data structure may include one or more workflow nodes representing one or more workflow tasks, and one or more workflow connections representing data flow required by the one or more workflow tasks.

The non-transitory storage medium may also include program code to provide a visual representation of the workflow data structure to the user.

The non-transitory storage medium may also include program code to calculate a workflow cost associated with executing the one or more workflow tasks in the workflow data structure.

The non-transitory storage medium may also include program code to receive at least one modification to the workflow data structure from the user, where the at least one modification to the workflow data structure may reduce the workflow cost.

The non-transitory storage medium may also include program code to generate an updated workflow data structure based on the workflow data structure and the at least one modification.

Finally, the non-transitory storage medium may include program code to generate an updated decentralized digital thread based on the updated workflow data structure.

Embodiments as set out for the previous aspects apply equally to the fifth aspect.

In another aspect, an embodiment of the present invention is a computer program product. The computer program product may be used for optimizing a digital workflow within a digital platform, and may include a computer-readable storage medium having program instructions, or program code, embodied therewith, the program instructions executable by a processor to cause the processor to perform the aforementioned steps.

In another aspect, an embodiment of the present invention is a system for optimizing a digital workflow within a digital platform, the system including a memory that stores computer-executable components, and a hardware processor, operably coupled to the memory, and that executes the computer-executable components stored in the memory, where the computer-executable components may include components communicatively coupled with the processor that execute the aforementioned steps.

In another aspect, an embodiment of the present invention is a system for optimizing a digital workflow within a digital platform, the system including a user device having a processor, a display, a first memory; a server including a second memory and a data repository; a communications link between said user device and said server; and a plurality of computer codes embodied on said first and second memory of said user device and said server, said plurality of computer codes which when executed causes said server and said user device to execute a process including the steps described herein.

In another aspect, an embodiment of the present invention is a computerized server including at least one processor, memory, and a plurality of computer codes embodied on said memory, said plurality of computer codes which when executed causes said processor to execute a process including the steps described herein. Other aspects and embodiments of the present invention include the methods, processes, and algorithms including the steps described herein, and also include the processes and modes of operation of the systems and servers described herein.

In yet another aspect, an embodiment of the present invention is an edge computerized system running on a physical system or physical twin with either access to, or dedicated, processing, memory, computer code stored on a non-transitory computer-readable storage medium of the physical system or physical twin, and a plurality of sensor data being measured on said physical system or physical twin, the computer code causing the processor to perform the aforementioned steps.

Features which are described in the context of separate aspects and/or embodiments of the invention may be used together and/or be interchangeable wherever possible. Similarly, where features are, for brevity, described in the context of a single embodiment, those features may also be provided separately or in any suitable sub-combination. Features described in connection with the non-transitory physical storage medium may have corresponding features definable and/or combinable with respect to a digital documentation system and/or method and/or system, or vice versa, and these embodiments are specifically envisaged.

Yet other aspects and embodiments of the present invention will become apparent from the detailed description of the invention when read in conjunction with the attached drawings.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. For clarity, simplicity, and flexibility, not all elements, components, or specifications are defined in all drawings. Not all drawings corresponding to specific steps or embodiments of the present invention are drawn to scale. Emphasis is instead placed on illustration of the nature, function, and product of the manufacturing method and devices described herein.

Embodiments of the present invention described herein are exemplary, and not restrictive. Embodiments will now be described, by way of examples, with reference to the accompanying drawings, in which:

### Interconnected Digital Model/Engineering Platform

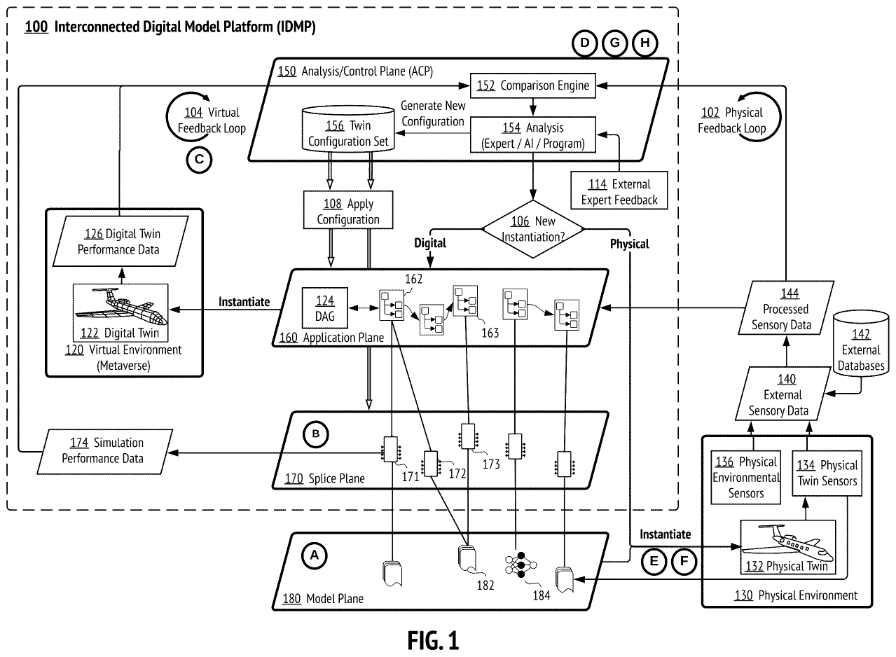

FIG. 1 shows an exemplary interconnected digital model/engineering platform (IDMP/IDEP) architecture, in accordance with some embodiments of the present invention.

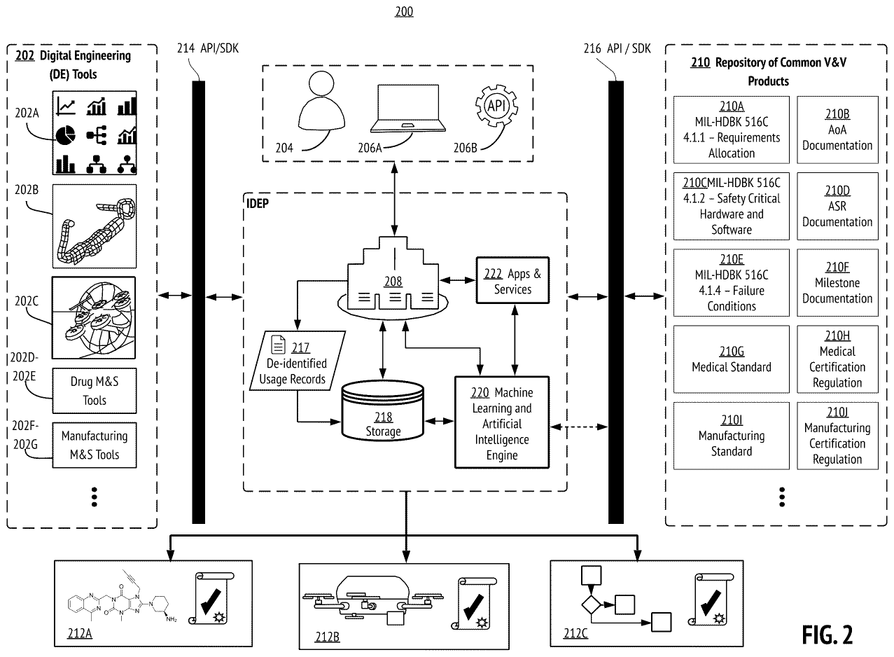

FIG. 2 shows an exemplary implementation of the IDEP as an interconnected digital engineering (DE) and certification ecosystem, and exemplary digitally certified products, in accordance with some embodiments of the present invention.

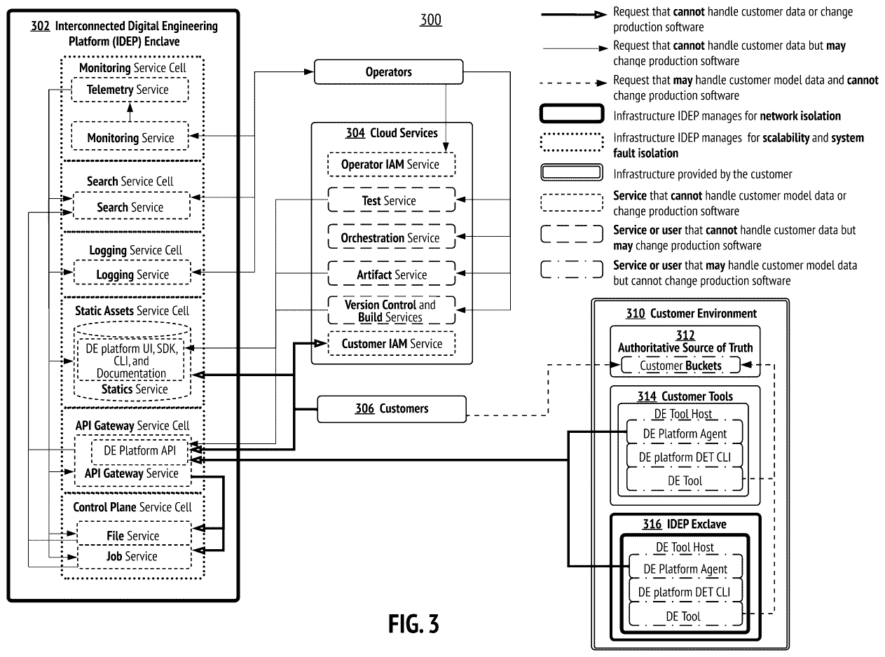

FIG. 3 shows another exemplary implementation of the IDEP illustrating its offered services and features, in accordance with some embodiments of the present invention.

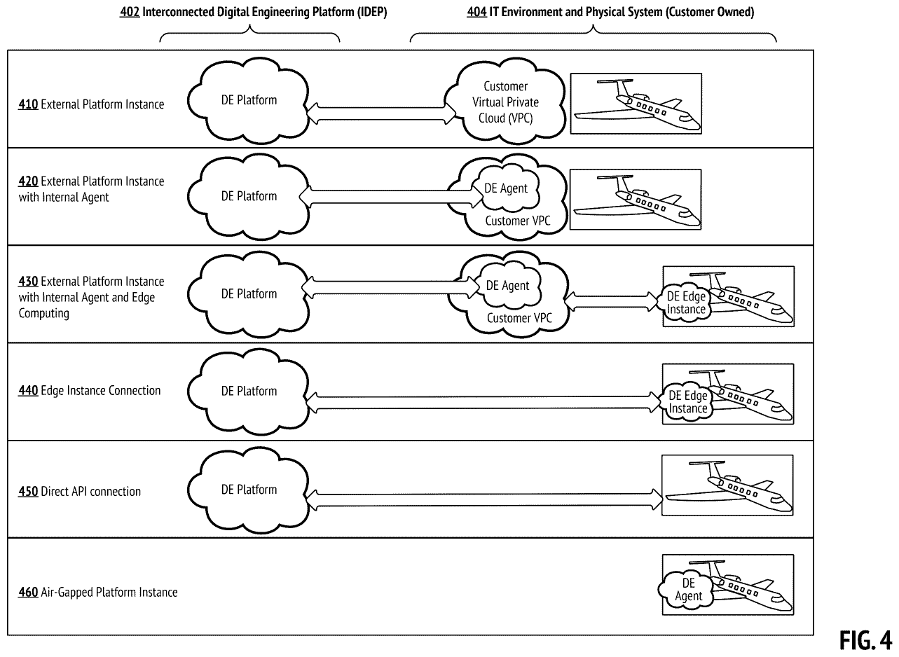

FIG. 4 shows potential scenarios for instantiating an IDEP in connection to a customer's physical system and IT environment, in accordance with some embodiments of the present invention.

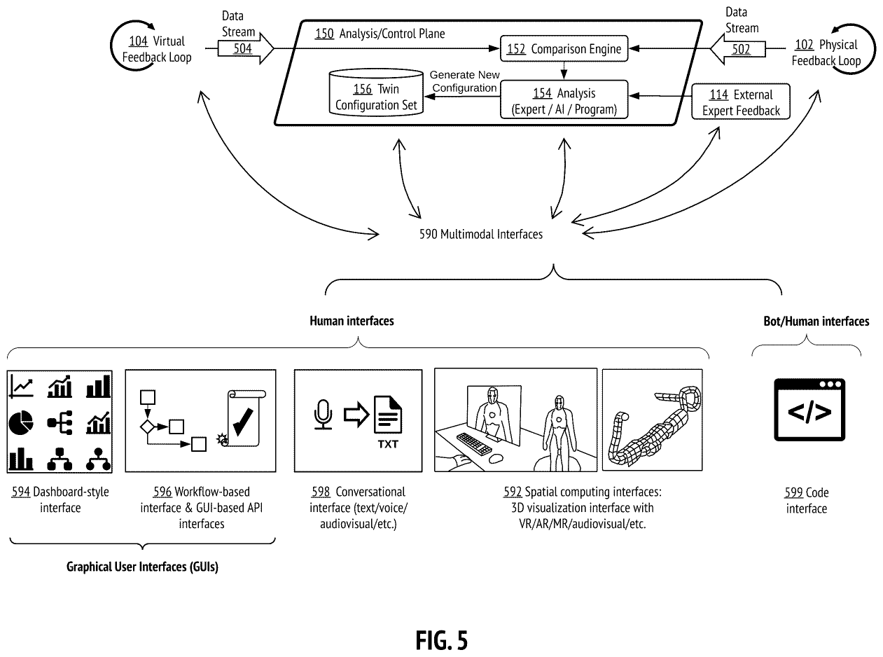

FIG. 5 shows exemplary multimodal interface designs for integration of feedback in am IDEP, in accordance with some embodiments of the present invention.

Digital Model Platform Links Digital Models into Digital Threads

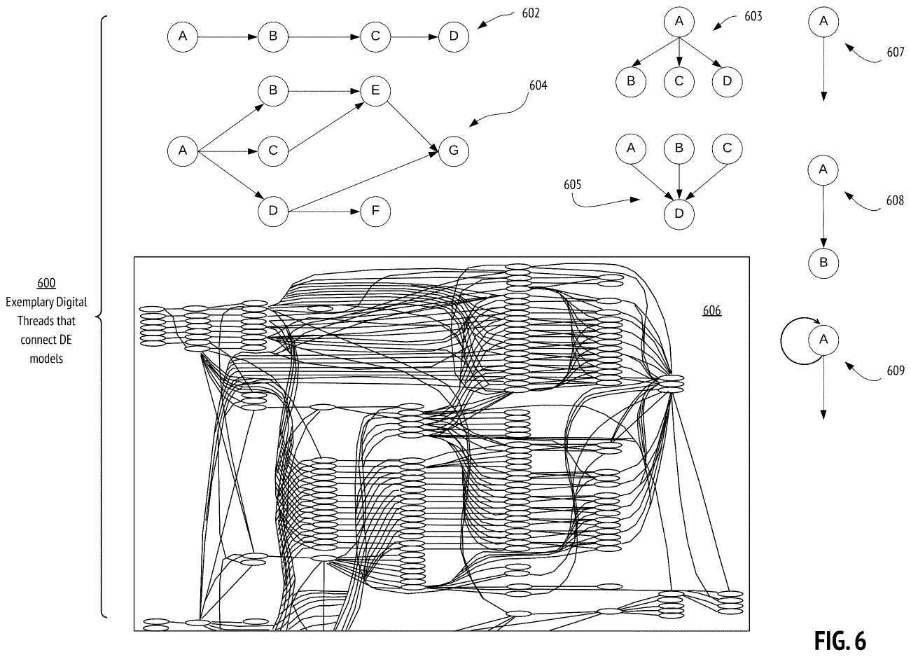

FIG. 6 is a schematic diagram comparing exemplary digital threads that connect DE models, in accordance with some embodiments of the present invention.

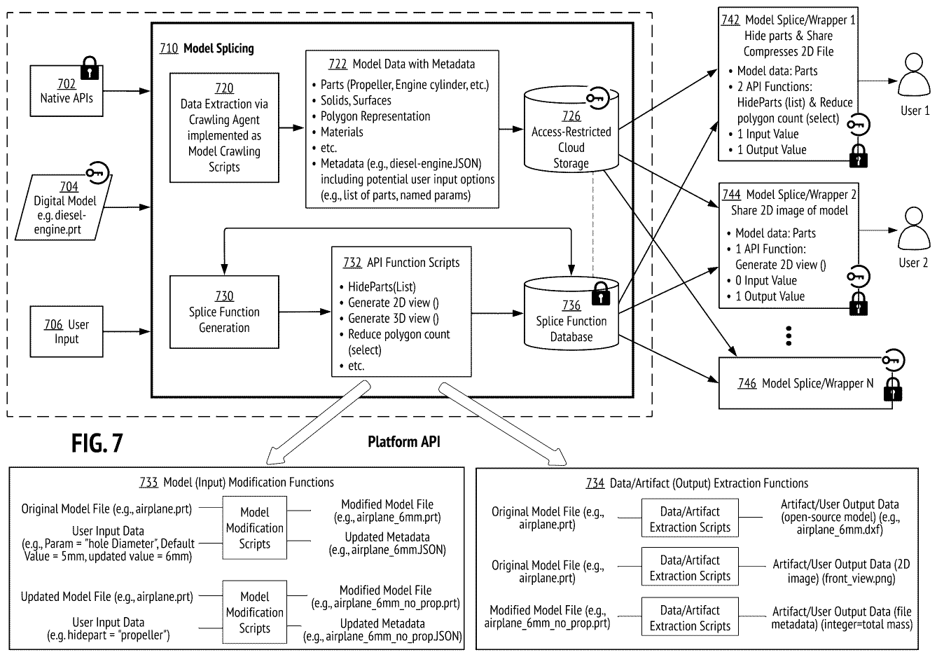

FIG. 7 is a schematic showing an exemplary DE model splicing setup, in accordance with some embodiments of the present invention.

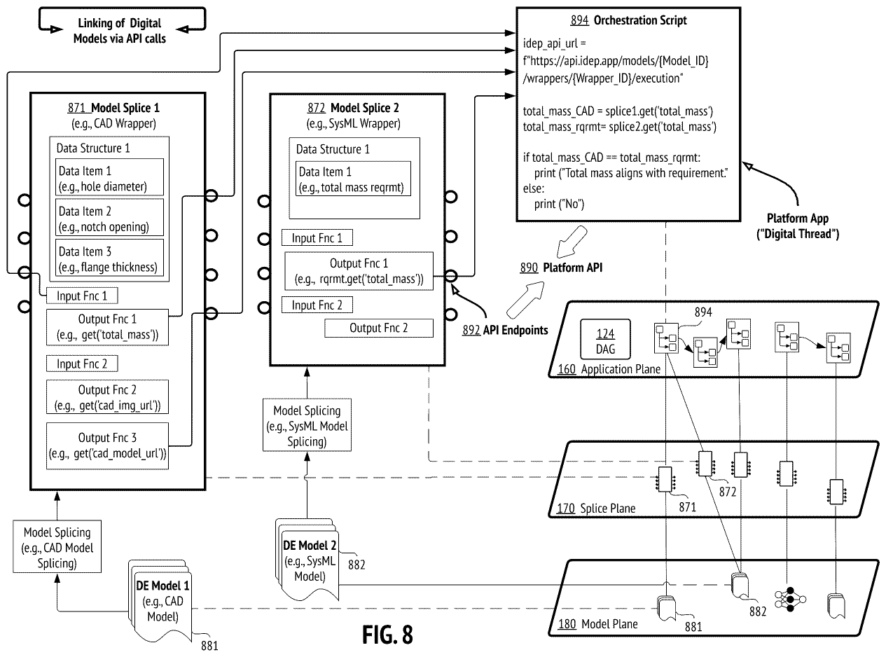

FIG. 8 is a schematic showing digital threading of DE models via model splicing, in accordance with some embodiments of the present invention.

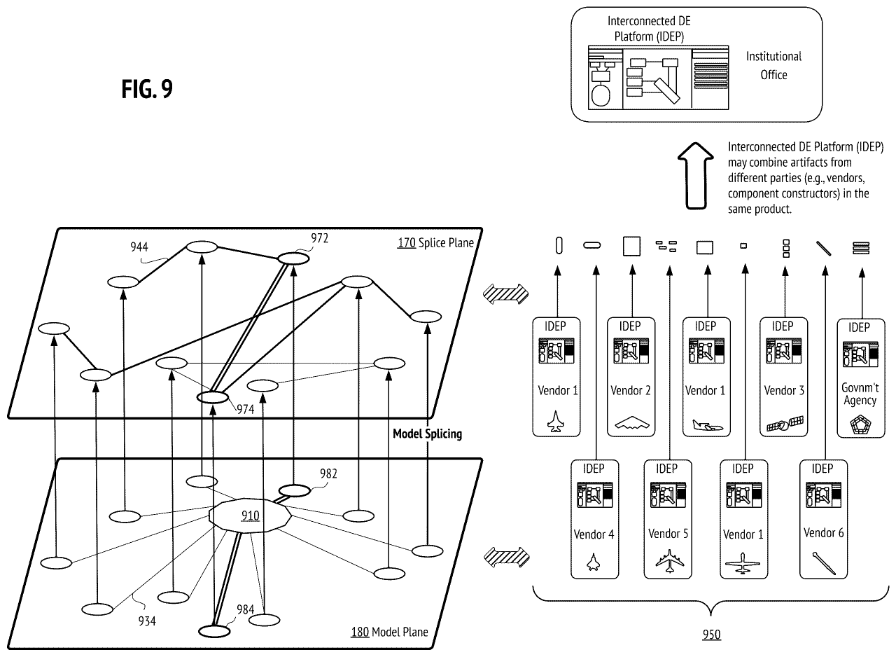

FIG. 9 is a schematic illustrating the linking of DE model splices in a splice plane and comparing digital threading with and without model splicing, in accordance with some embodiments of the present invention.

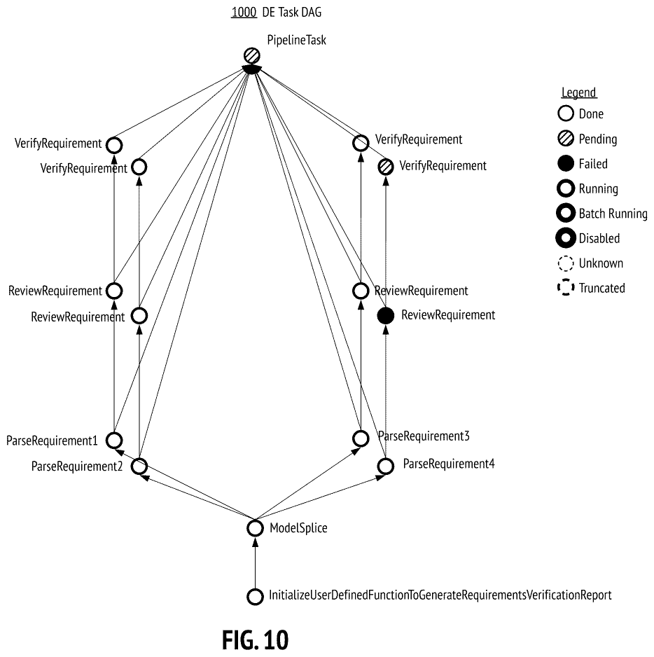

FIG. 10 shows an exemplary directed acyclic graph (DAG) representation of pipelined DE tasks related to digital threads, in accordance with some embodiments of the present invention.

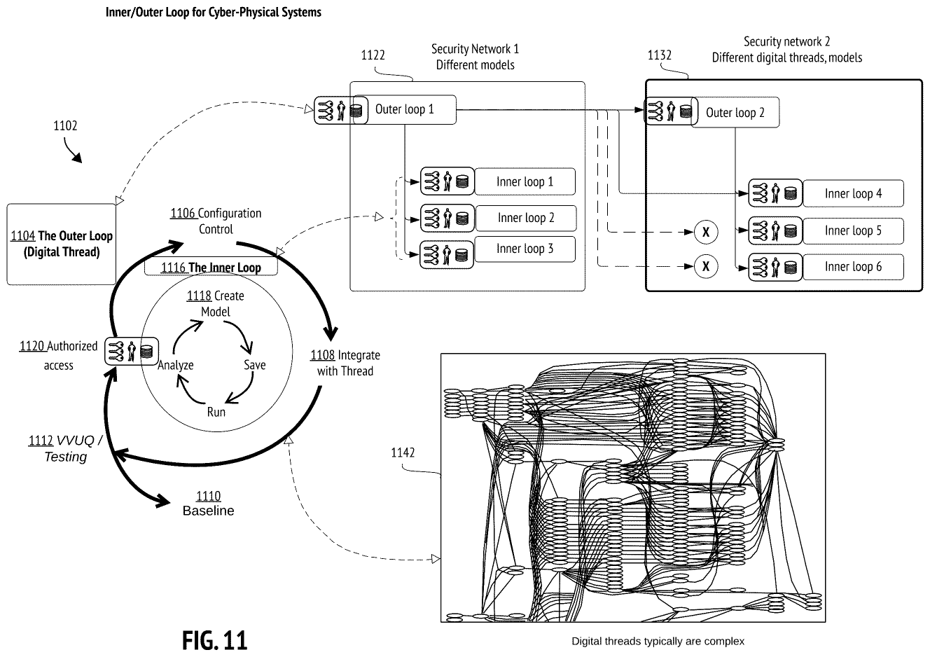

FIG. 11 illustrates the interplay between a digital thread and the individual models or artifacts it uses, defining outer and inner loop processes, according to one embodiment of the present invention.

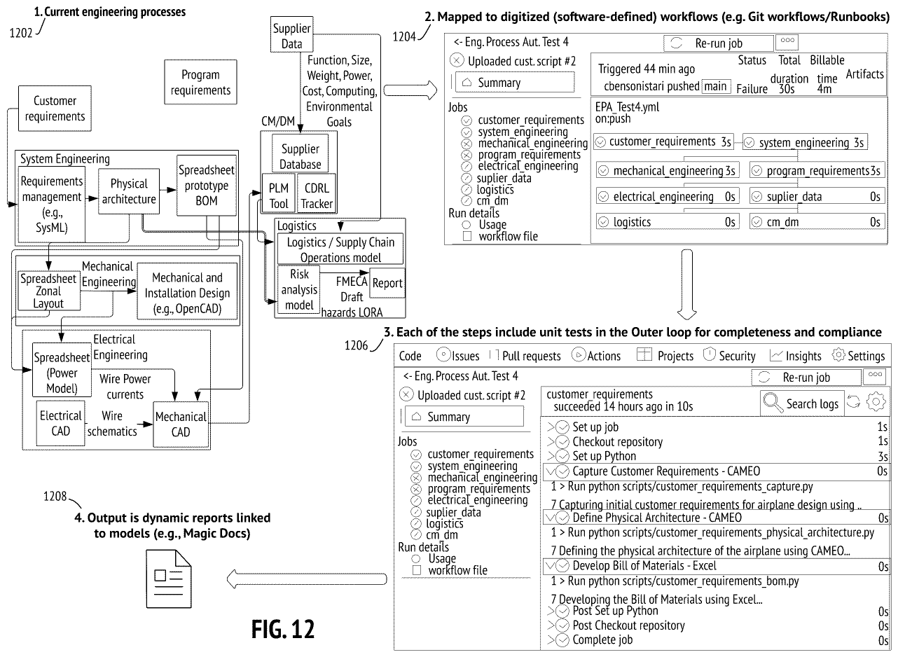

FIG. 12 illustrates an exemplary digital engineering process in the aerospace industry, showing outer loop processes, according to one embodiment of the present invention.

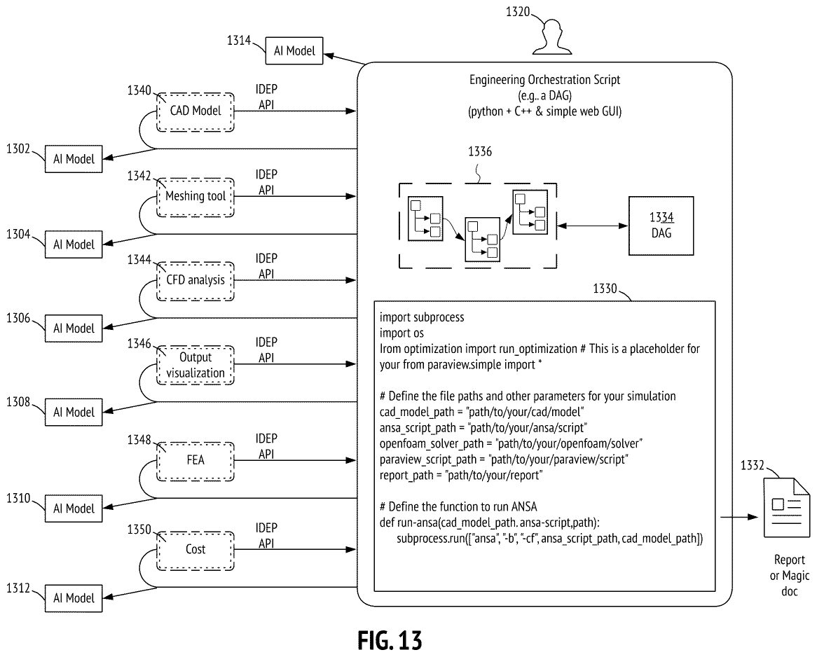

FIG. 13 shows an example of evaluating CAD models within a simulation environment, enhanced through AI-enabled processes over the IDEP, in accordance with the examples disclosed herein.

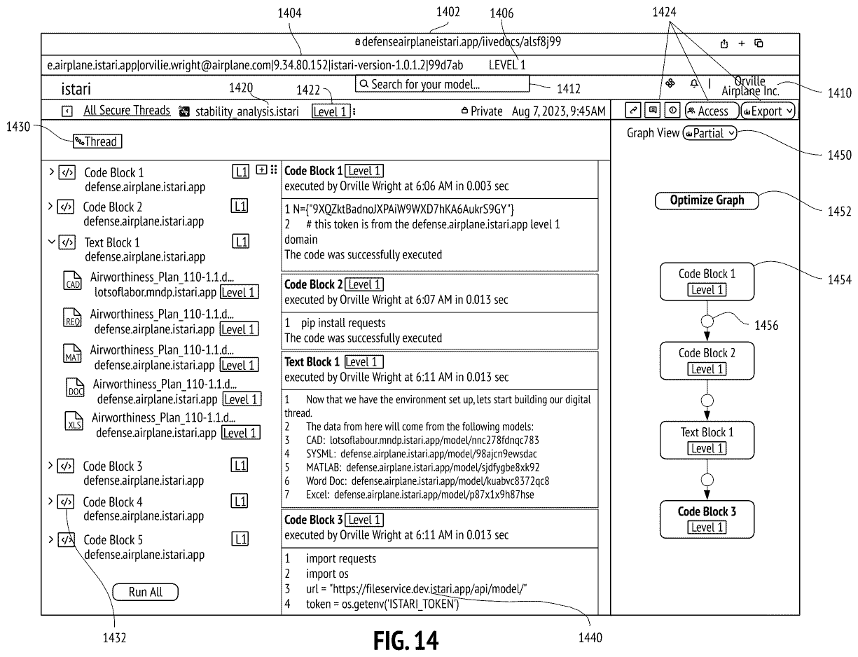

FIG. 14 shows a screenshot of an exemplary graphical user interface (GUI) used to operate a digital thread over the IDMP, according to one embodiment of the present invention.

Optimizing a Digital Workflow within a Digital Platform

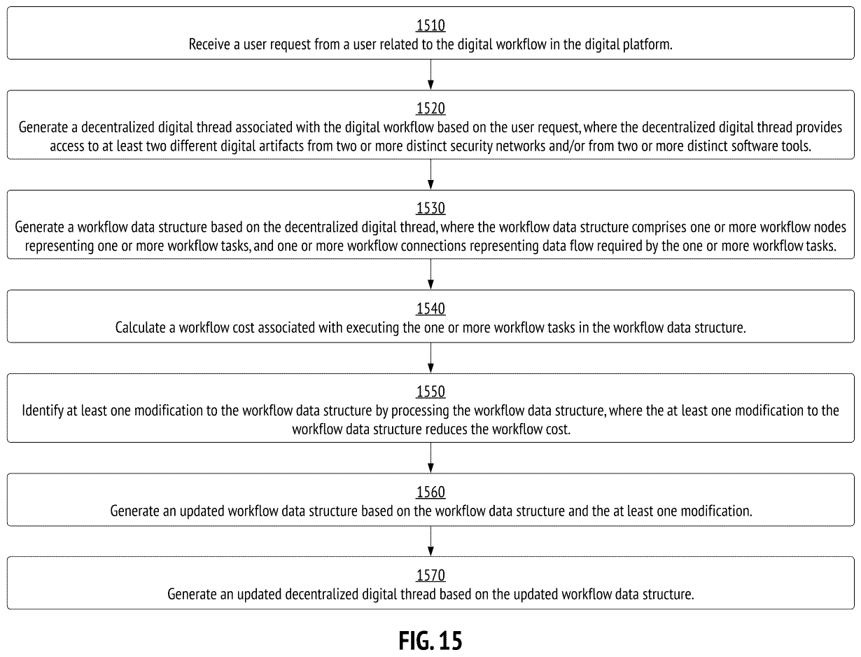

FIG. 15 shows an exemplary flow chart for optimizing a digital workflow within a digital platform, in accordance with some embodiments of the present invention.

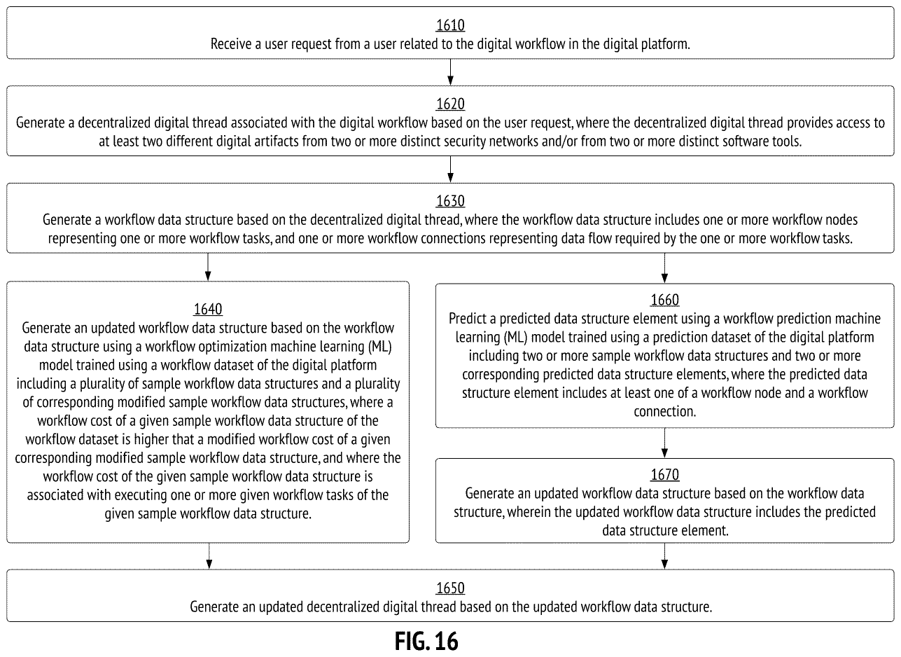

FIG. 16 shows an alternative exemplary flow chart for optimizing a digital workflow within a digital platform, in accordance with some embodiments of the present invention.

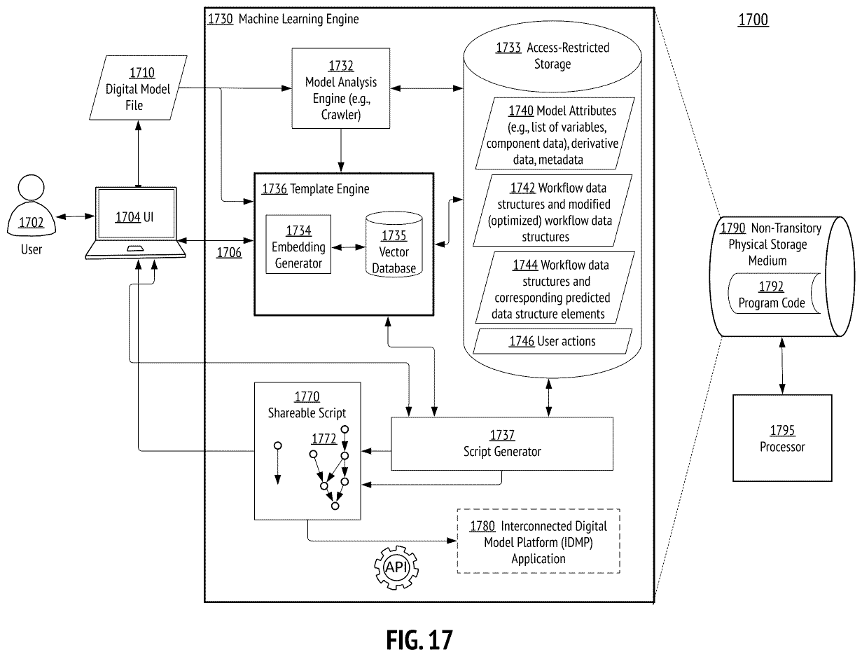

FIG. 17 shows an exemplary system illustrating the generation of a sharable script and the optimization of a digital workflow using a machine learning (ML) engine, in accordance with some embodiments of the present invention.

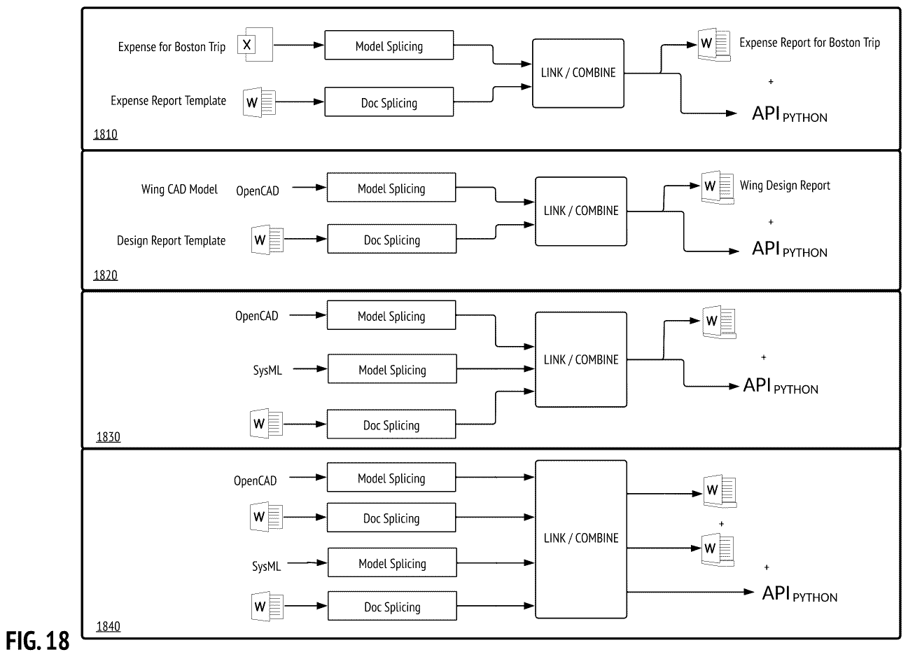

FIG. 18 shows illustrative setups for digital model splice and document splice linking, illustrating exemplary digital workflows, according to some embodiments of the present invention.

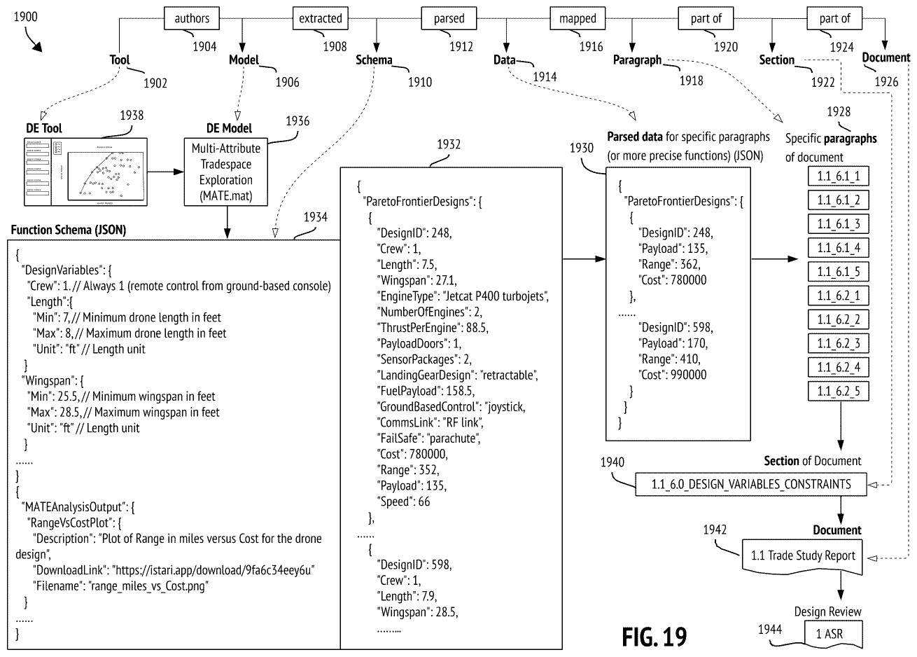

FIG. 19 illustrates the complex process of documenting digital threads in a technical review, in accordance with example embodiments of the present invention.

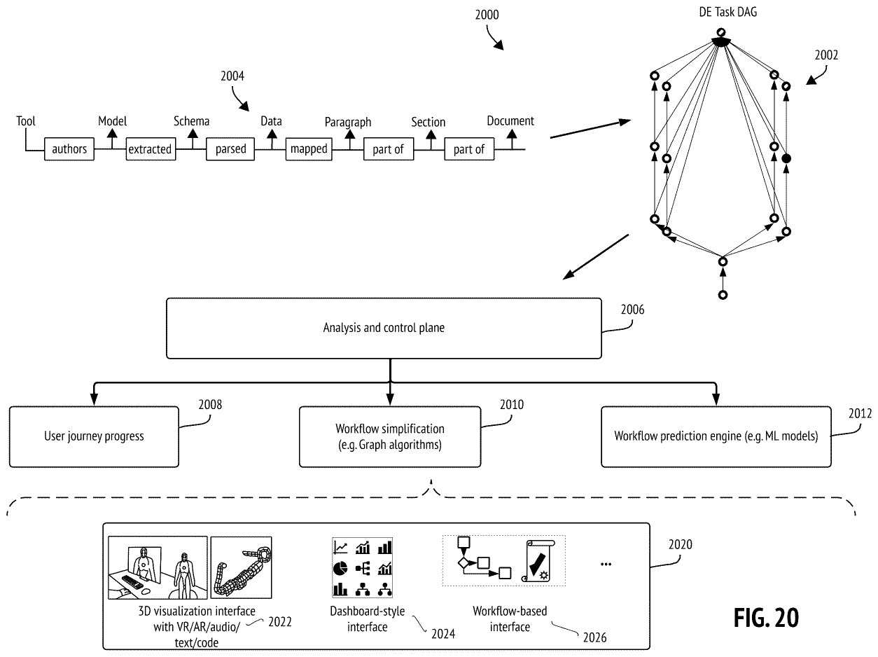

FIG. 20 shows an overview of potential approaches to optimize certification digital workflows within a digital platform, according to embodiments of the present invention.

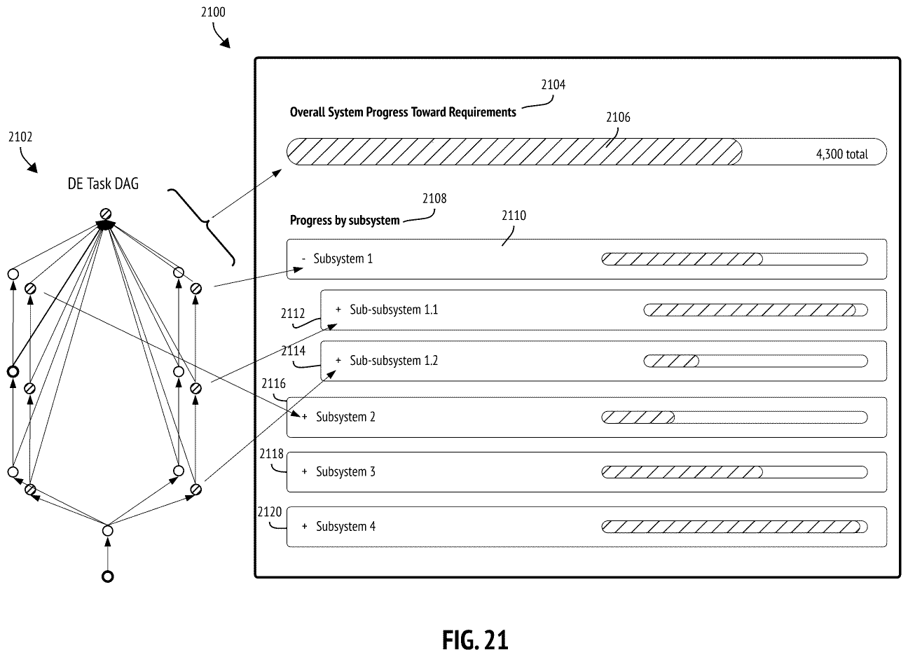

FIG. 21 shows an exemplary user's view of a digital platform dashboard indicating the progress of individual systems and subsystems towards a given certification.

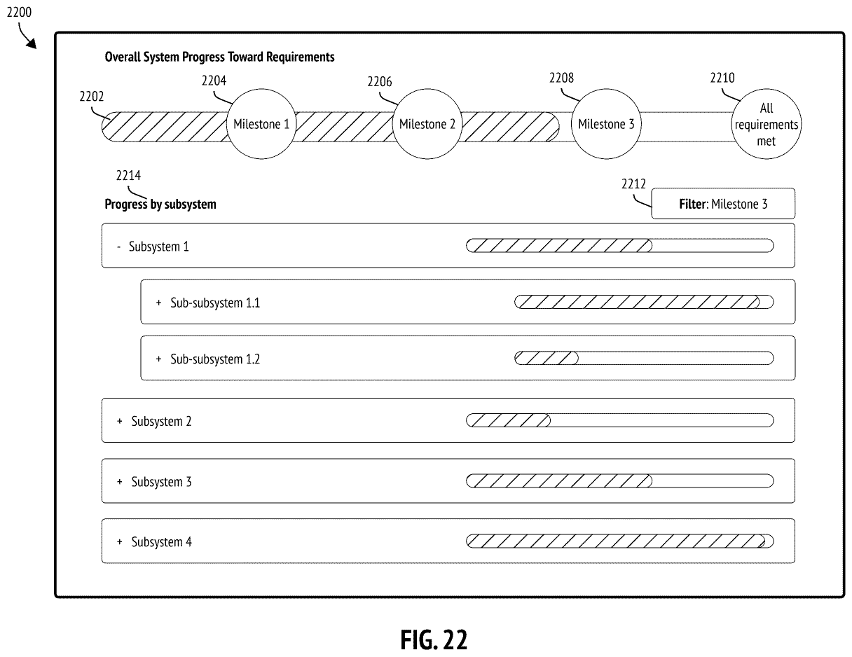

FIG. 22 shows an alternative exemplary user's view of a digital platform dashboard indicating the progress of individual systems and subsystems towards a given certification.

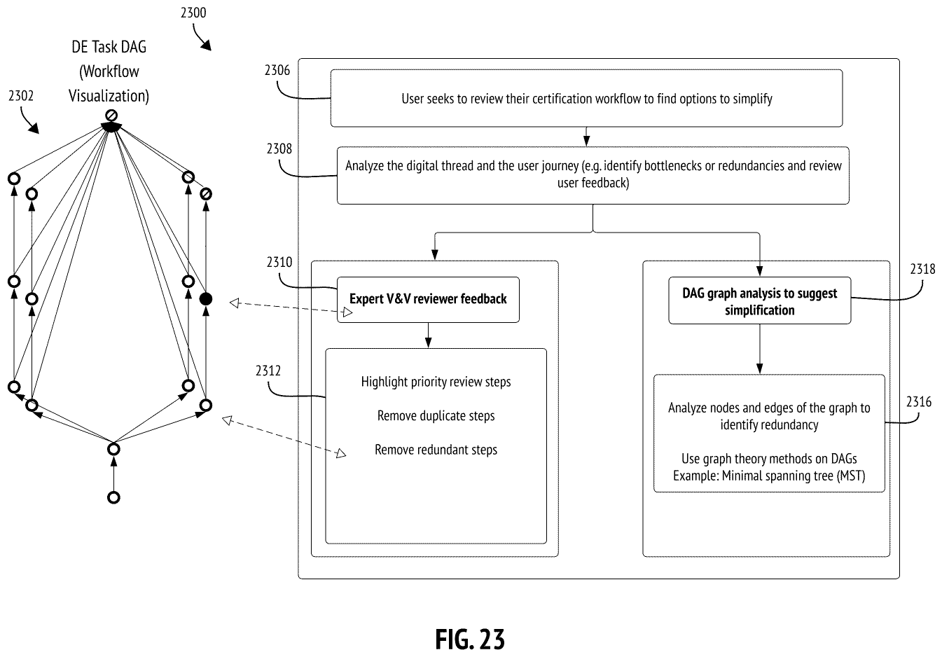

FIG. 23 illustrates exemplary methods for workflow simplification, according to embodiments of the present invention.

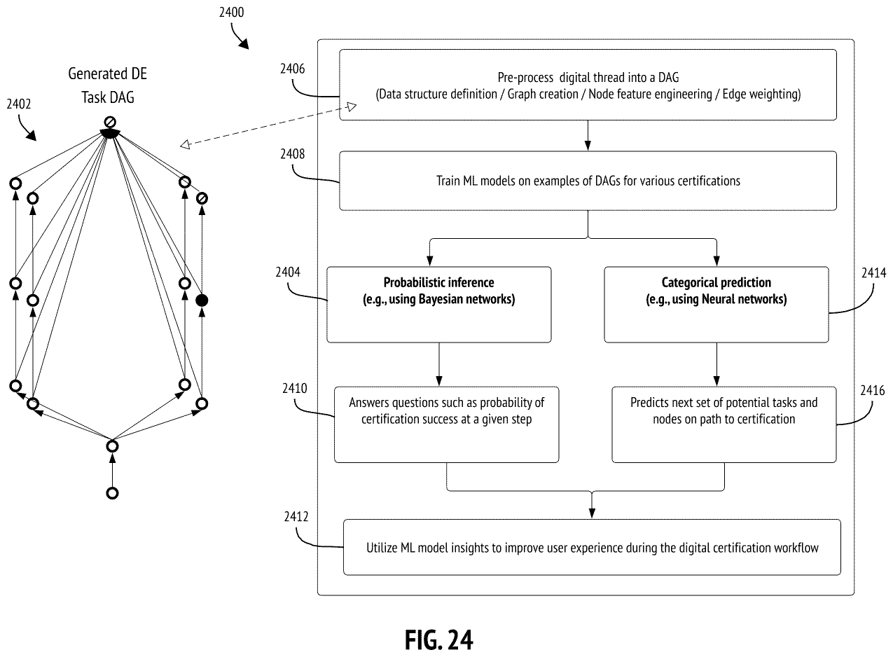

FIG. 24 illustrates exemplary methods for workflow prediction, according to embodiments of the present invention.

### Machine Learning Implementation Architecture for IDMP Operations

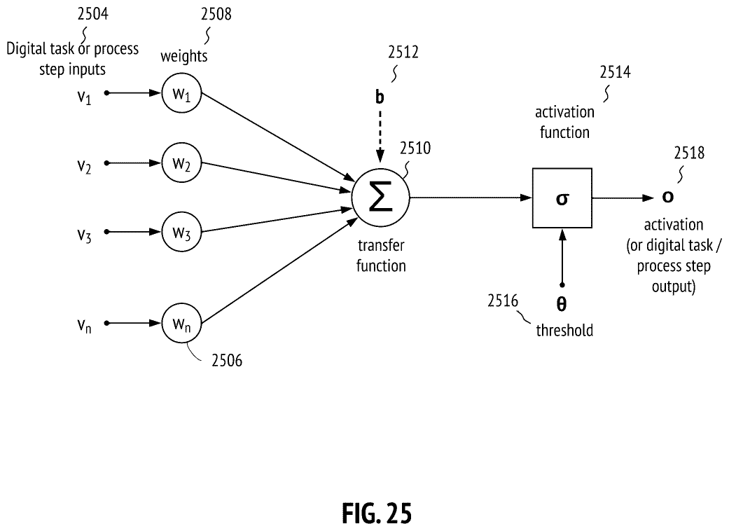

FIG. 25 describes neural network operation fundamentals, in accordance with some embodiments of the present invention.

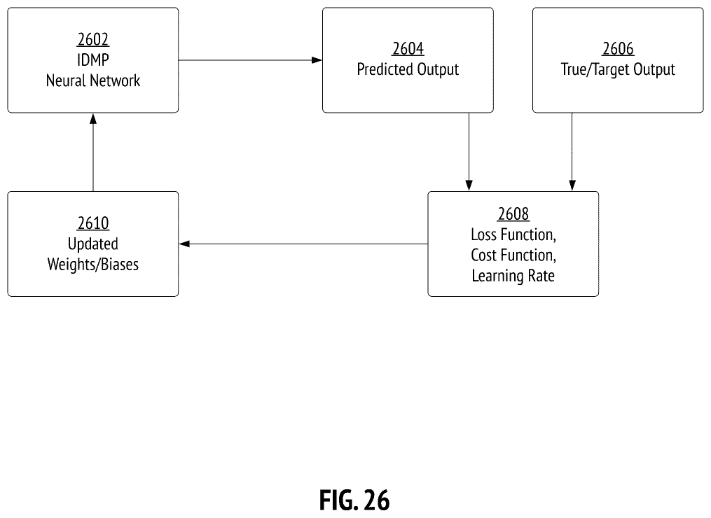

FIG. 26 shows an overview of an IDMP neural network training process, in accordance with some embodiments of the present invention.

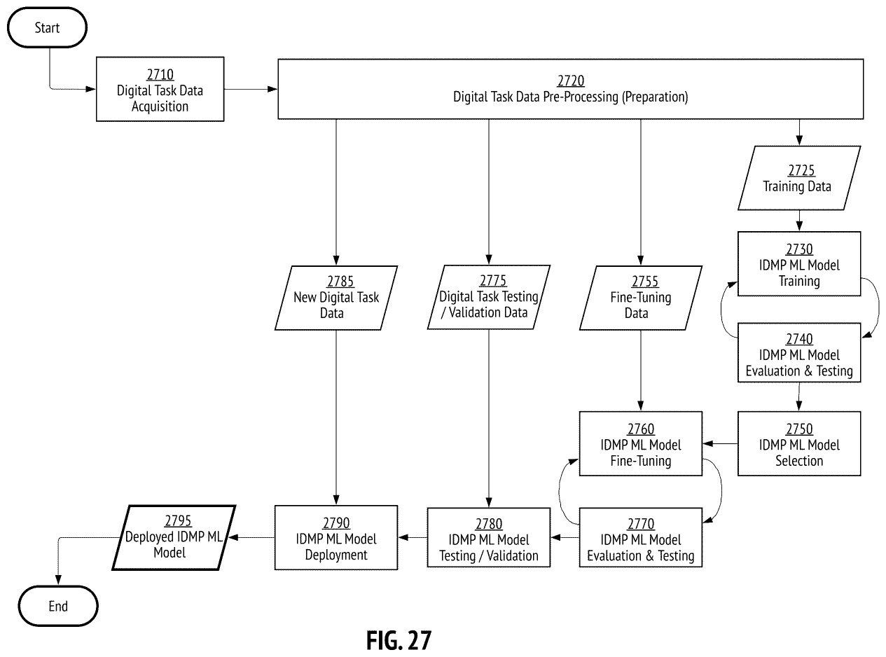

FIG. 27 is an illustrative flow diagram showing the different phases and datasets involved in training an IDMP machine learning model, in accordance with some embodiments of the present invention.

### Hardware and Software Architecture for IDMP Operations

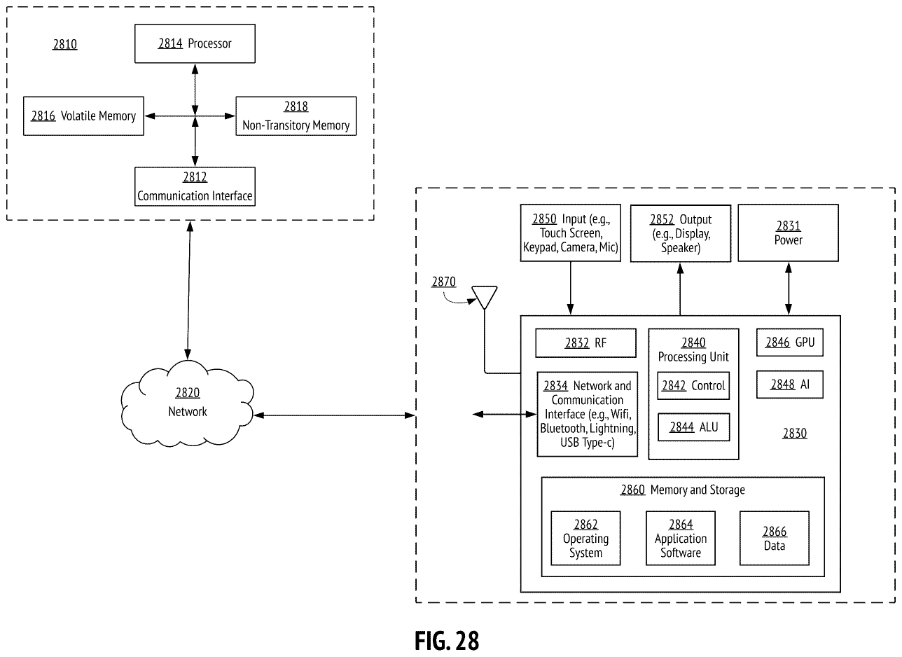

FIG. 28 provides illustrative schematics of a server (management computing entity) and a client (user computing entity) used for documentation within an IDMP, in accordance with some embodiments of the present invention.

### DETAILED DESCRIPTION OF THE INVENTION

In the following description, for purposes of explanation, numerous specific details are set forth in order to provide a thorough understanding of the invention. It will be apparent, however, to one skilled in the art that the invention can be practiced without these specific details. In other instances, structures, devices, activities, methods, and processes are shown using schematics, use cases, and/or diagrams in order to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

The methods and systems disclosed herein address the growing need for efficient and secure AI-assisted digital workflows in complex system design and management. Motivated by the challenges of integrating AI tools into fragmented software environments, ensuring data privacy, and improving scalability, the methods and systems disclosed herein introduce a novel three-phase approach to the AI-enabled generation of orchestration script implementing a digital task over an interconnected digital model platform (IDMP). The first phase focuses on determining the context of the digital task, driven by the need to accurately identify essential process steps, their required software tools, and one or more specialized AI models to carry out the script generation. The second phase focuses on scripting syntax by generating an adaptable and effective script implementing the process steps and connecting the relevant digital models. In various embodiments, the second phase generates a template script that is devoid of key sensitive customer parameters, thus requiring an additional third phase to integrate sensitive customer data within the generated script, responding to critical security concerns and data sovereignty requirements. By separating these phases and employing advanced ML techniques, including fine-tuned (e.g., through LoRA) or RAG-enabled transformer models, the invention enables safe and effective deployment of generative AI in digital workflows, ultimately streamlining design, validation, verification, certification, assembly, operations, and maintenance processes of complex systems.

With reference to the figures, embodiments of the present invention are now described in detail. First, the digital model platform (IDMP) and its digital engineering embodiment (IDEP) are explained in detail. Then, the digital splicing and threading operations enabling orchestration script generation are described in detail. Finally, the phases of script generation, optimization, and simplification are detailed.

### Terminology

Some illustrative terminologies used herein are provided at the end of this document to assist in understanding the present invention, but these are not to be read as restricting the scope of the present invention. The terms may be used in the form of nouns, verbs, or adjectives, within the scope of the definition.

### An Interconnected Digital Model Platform (IDMP) Architecture

FIG. 1 shows an exemplary interconnected digital model platform (IDMP) architecture, in accordance with some embodiments of the present invention. In the context of digital engineering (DE), the IDMP 100 streamlines the process of product development from conception to production, by using a virtual representation or digital twin (DTw) 122 of the product to optimize and refine features before building a physical prototype or physical twin (PTw) 132, and to iteratively update DTw 122 until DTw 122 and PTw 132 are in sync to meet the product's desired performance goals. In the context of digital engineering (DE), the IDMP 100 may be identified as an Interconnected Digital Engineering Platform (IDEP). An IDEP may be considered a special class of IDMP in the field of digital engineering.

Specifically, a product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) manufacturer may use IDMP platform 100 to develop a new product. The engineering team from the manufacturer may create or instantiate digital twin (DTw) 122 of the product in a virtual environment 120, encompassing detailed computer-aided design (CAD) models and finite element analysis (FEA) or computational fluid dynamics (CFD) simulations of component systems such as fuselage, wings, engines, propellers, tail assembly, and aerodynamics. DTw 122 represents the product's design and performance characteristics virtually, allowing the team to optimize and refine features before building a physical prototype 132 in a physical environment 130. In some embodiments, PTw 132 may be an existing entity, while DTw 122 is a digital instance that replicates individual configurations of PTw 132, as-built or as-maintained. In the present disclosure, for illustrative purposes only, DTw 122 and PTw 132 are discussed in the context of building a new product, but it would be understood by persons of ordinary skill in the art that the instantiation of DTw 122 and PTw 132 may take place in any order, based on the particular use case under consideration.

Digital models (e.g., CAD models, FEA models, CFD models) used for creating DTw 122 are shown within a model plane 180 in FIG. 1. Also shown in model plane 180 is a neural network (NN) model 184, which may provide machine-learning based predictive modeling and simulation for a DE process. A DE model such as 182 may be spliced into one or more model splices, such as 172 and 173 within a splice plane 170. Individual DTws such as 122 are instantiated from splice plane 170 via an application plane 160. A model splice such as 172 may be linked to another model splice such as 171 by a platform script or application 162 on application plane 160 into a digital thread. Multiple digital threads such as 162 and 163 may be further linked across different stages or phases of a product life cycle, from concept, design, testing, to production. Digital threads further enable seamless data exchange and collaboration between departments and stakeholders, ensuring optimized and validated designs.

As model splicing provides input and output splice functions that can access and modify DE model data, design updates and DE tasks associated with the digital threads may be represented by scripted, interconnected, and pipelined tasks arranged in directed acyclic graphs (DAGs) such as 124. A DE task DAG example is discussed in further detail with reference to FIG. 10.

To enhance the design, external sensory data 140 may be collected, processed, and integrated into application plane 160. This process involves linking data from different sources, such as physical sensors 134 on prototype 132, physical environmental sensors 136, and other external data streams such as simulation data from model plane 180. API endpoints provide access to digital artifacts from various environments (e.g., physical twin (PTw) sensor 134 data) and integrate them into the spliced plane 170 for the DTw 122. Model splices on the splice plane 170 enable autonomous data linkages and digital thread generation, ensuring DTw 122 accurately represents the product's real-world performance and characteristics.

To validate DTw 122's accuracy, the engineering team may build or instantiate PTw 132 based on the same twin configuration (i.e., digital design). Physical prototype 132 may be equipped with numerous sensors 134, such as accelerometers and temperature sensors, to gather real-time performance data. This data may be compared with the DTw's simulations to confirm the product's performance and verify its design.

Processed sensory data 144 may be used to estimate parameters difficult to measure directly, such as aerodynamic forces or tire contact patch forces. Such processed sensory data provide additional data for DTw 122, further refining its accuracy and reliability. Processed sensory data 144 may be generated from physical environment sensors 136 with physical environment 130, and may be retrieved from other external databases 142, as discussed below.

During development, feedback from customers and market research may be collected to identify potential improvements or adjustments to the product's design. At an analysis & control plane (ACP) 150, subject matter experts (SMEs) may analyze processed sensory data 144 and external expert feedback 114, to make informed decisions on necessary design changes. Such an analysis 154 may be enhanced or entirely enabled by algorithms (i.e., static program code) or artificial intelligence (AI) modules. Linking of digital threads such as 162, physical sensors 134 and 136, processed sensory data 144, and expert feedback data 114 occurs at ACP 150, where sensor and performance data is compared, analyzed, leading to modifications of the underlying model files through digital threads.

In particular, sensory data 144 from physical environment 130 and performance data 126 from virtual environment 120 may be fed into a comparison engine 152. Comparison engine 152 may comprise tools that enable platform users to compare various design iterations with each other and with design requirements, identify performance lapses and trends, and run verification and validation (V&V) tools.

Model splicing is discussed in further detail with reference to FIGS. 7 to 9. Model splicing enables the scripting of any DE operation involving DE model files in model plane 180, where each DE model is associated with disparate and siloed DE tools. Codification of DE models and DE operations with a unified corpus of scripts enable IDMP 100 to become an aggregator where a large space of DE activities associated with a given product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) may be threaded through program code. Thus, model splicing enables the linking and manipulation of all model files (e.g., 182, 184) associated with a given product within the same interconnected platform or DE ecosystem 100. As a consequence, the generation and training of AI modules for the purpose of manipulating DE models (e.g., 182), digital threads (e.g., 162), and digital twins (e.g., 122) become possible over the programmable and unified IDMP 100.

### Virtual and Physical Feedback Loops

FIG. 1 uses letter labels “A” to “H” to denote different stages of a product's lifecycle. At each stage, IDMP 100 enables feedback loops whereby data emanating from a PTw or a DTw is analyzed at ACP 150, leading to the generation of a new twin configuration based on design modifications. The new twin configuration may be stored in a twin configuration set and applied through the application and splice planes, yielding modified model files that are registered on the digital thread.

A virtual feedback loop 104 starts with a decision 106 to instantiate new DTw 122. A DAG of hierarchical tasks 124 allows the automated instantiation of DTw 122 within virtual environment 120, based on a twin configuration applied at a process step 108 from a twin configuration set 156. DTw 122 and/or components thereof are then tested in virtual environment 120, leading to the generation of DTw performance data 126. Concurrently, DTw 122 and/or components thereof may be tested and simulated in model plane 180 using DE software tools, giving rise to test and simulation performance data 174. Performance data 126 and 174 may be combined, compared via engine 152, and analyzed at ACP 150, potentially leading to the generation and storage of a new twin configuration. The eventual decision to instantiate a DTw from the new twin configuration completes virtual feedback loop 104.

A physical feedback loop 102 starts with a decision 106 to instantiate a new PTw 132. PTw 132 may be instantiated in a physical environment 130 from the model files of model plane 180 that are associated with an applied twin configuration from the twin configuration set 156. PTw 132 and/or components thereof are then tested in physical environment 132, leading to the generation of sensory data from PTw sensors 134 and environmental sensors 136 located in physical environment 130. This sensory data may be combined with data from external databases to yield processed sensory data 144. In one exemplary embodiment, temperature readings from environmental sensors located within the physical environment are completed, adjusted (e.g., shifted), and/or calibrated using data from external temperature databases.

Data from PTw sensors 134 may be directly added to the model files in model plane 180 by the DE software tools used in the design process of PTw 132. Alternatively, PTw sensor data may be added to digital thread 162 associated with PTw 132 directly via application plane 160. In addition, processed sensory data 144 may be integrated into IDMP 100 directly via application plane 160. For example, processed sensory data 144 may be sent to ACP 150 for analysis, potentially leading to the generation and storage of a new twin configuration. The eventual decision to instantiate a PTw from the new twin configuration completes physical feedback loop 102.

At each stage A to H of the product life cycle, the system may label one twin configuration as a current design reference, herein described as an “authoritative twin” or “authoritative reference”. The authoritative twin represents the design configuration that best responds to actual conditions (i.e., the ground truth). PCT application No. PCT/US24/27898 (Docket No. IST-03.001PCT) provides a more complete description of authoritative twins and their determination, and is incorporated by reference in its entirety herein.

With faster feedback loops from sensor data and expert recommendations, the system updates DTw 122 to reflect latest design changes. This update process may involve engineering teams analyzing feedback 154 and executing the changes through IDMP 100, or automated changes enabled by IDMP 100 where updates to DTw 122 are generated through programmed algorithms or AI modules. This iterative updating process continues until DTw 122 and PTw 132 are in sync and the product's performance meets desired goals. While IDMP 100 may not itself designate the authoritative reference between a DTw or a PTw, the platform provides configurable mechanisms such as policies, algorithms, voting schema, and statistical support, whereby agents may designate a new DTw as the authoritative DTw, or equivalently in what instances the PTw is the authoritative source of truth.

When significant design improvements are made, a new PTw prototype may be built based on the updated DTw. This new prototype undergoes further testing and validation, ensuring the product's performance and design align with project objectives.

Once DTw 122 and PTw 132 have been validated and optimized, the product is ready for production. A digital thread connecting all stages of development can be queried via splice plane 170 to generate documentation as needed to meet validation and verification requirements. The use of model splicing, along with the feedback architecture shown in FIG. 1, improves the efficiency of the overall product innovation process.

### Interconnected DE Platform and Product Lifecycle

In FIG. 1, letter labels “A” to “H” indicate the following major steps of a product lifecycle, according to some embodiments of the current invention:

A. Digital models reside within customer environments: a product may be originally represented by model files that are accessible via software tools located within customer environments. Model plane 180 encompasses all model files (e.g., 182) associated with the product.

B. Preparatory steps for design in the digital realm: splice plane 170 encompasses model splices (e.g., 172) generated from DE model file through model splicing. Model splicing enables the integration and sharing of DE model files within a single platform, as described in detail with reference to FIGS. 7 to 9.

C. Link threads as needed among model splices: to implement a product, model splices are linked through scripts within application plane 160. A digital twin (DTw) 122 englobing as-designed product features may be generated from application plane 160 for running in virtual environment 120. The complete twin configuration of a generated DTw is saved in twin configuration set 156 located at the analysis & control plane (ACP) 150. Features or parts of DTw 122 may be simulated in model plane 180, with performance data 174 accessed through splice plane 170. In one embodiment, features or parts of PTw 132 or DTw 122 configuration may be simulated outside the platform, where performance data is received by the ACP 150 for processing, in a similar way as performance data 126 received from DTw 122.

D. Finalize “As-designed”: performance data 126 from DTw 122 or simulation performance data 174 attained through model plane 180 and accessed through model splicing may be collected and sent to ACP 150 for analysis. Performance data from different iterations of DTw 122 may be compared via engine 152 to design requirements. Analysis of the differences may lead to the generation of new twin configurations that are stored at twin configuration set 156. Each twin configuration in twin configuration set 156 may be applied at application plane 160 and splice plane 170 via process step 108 to instantiate a corresponding DTw. Multiple DTws may be generated and tested, consecutively or simultaneously, against the design requirements, through comparison engine 152 and analysis module 154. Verification and validation tools may be run on the various DTw iterations.

E. Finalize “As-manufactured”: once a DTw 122 satisfies the design requirements, a corresponding PTw 132 prototype may be instantiated from the spliced model files (e.g., 172). Sensor data originating from the PTw 134 or from within the physical environment 136 may be collected, combined with other external data 142 (e.g., sensor data from other physical environments). The resulting processed sensory data 144 may be sent to the analysis & control plane 150 to be compared with performance data 126 from DTws and simulations (e.g., 174), leading to further DTw 122 and PTw 132 iterations populating the twin configuration set 156. Processed sensory data 144 may also be mapped to the digital threads (e.g., 164) and model splices (e.g., 172) governing the tested PTw 132 through the application plane 160.

F. Finalize “As-assembled”: once the manufacturing process is completed for the various parts, as a DTw and as a PTw, the next step is to finalize the assembled configuration. This involves creating a digital representation of the assembly to ensure it meets the specified requirements. The digital assembly takes into account the dimensions and tolerances of the “as-manufactured” parts. To verify the feasibility of the digital assembly, tests are conducted using the measured data obtained from the physical assembly and its individual components. Measurement data from the physical component parts may serve as the authoritative reference for the digital assembly, ensuring alignment with the real-world configuration. The digital assembly is compared with the actual physical assembly requirements for validation of the assembled configuration. Subsequently, the digital assembly tests and configurations serve as an authoritative reference for instructions to guide the physical assembly process and ensure accurate replication. IDMP 100 components described above may be used in the assembly process. In its authoritative iteration, DTw 122 ultimately captures the precise details of the physical assembly, enabling comprehensive analysis and control in subsequent stages of the process.

G. Finalize “As-operated”: to assess the performance of the physical assembly or its individual component parts, multiple digital twins 122 may be generated as needed. These digital twins are created based on specific performance metrics and serve as virtual replicas of the physical system. Digital twins 122 are continuously updated and refined in real-time using the operational data (e.g., 144) collected from monitoring the performance of the physical assembly or its components. This data may include, but is not limited to, processed sensory data, performance indicators, and other relevant information. By incorporating this real-time operational data, digital twins 122 stay synchronized with the actual system and provide an accurate representation of its operational performance. Any changes or improvements observed via sensory data 144 during the real-world operation of the assembly are reflected in DE models within the digital twins and recorded in the twin configuration set 156. This ensures that the digital twins remain up-to-date and aligned with the current state of the physical system.

H. Predictive analytics/Future performance: The design process may continue iteratively in virtual environment 120 through new DTw 122 configurations as the product is operated. Multiple digital twins may be created to evaluate the future performance of the physical assembly or its component parts based on specific performance metrics. Simulations are conducted with various control policies to assess the impact on performance objectives and costs. The outcome of these simulations helps in deciding which specific control policies should be implemented (e.g., tail volume coefficients and sideslip angle for an airplane product). The digital twin DE models (e.g., 182) are continuously updated and refined using the latest sensor data, control policies, and performance metrics to enhance their predictive accuracy. This iterative process ensures that the digital twins (e.g., 122, 156) provide reliable predictions of future performance and assist in making informed decisions.

The hardware components making up IDMP 100 (e.g., servers, computing devices, storage devices, network links) may be centralized or distributed among various entities, including one or more DE service providers and DE clients, as further discussed in the context of FIGS. 3 and 4. FIG. 4 shows an illustration of various potential configurations for instancing a DE platform within a customer's physical system and information technology (IT) environment, usually a virtual private cloud (VPC) protected by a firewall.

Digital Documentation with Live or Magic Documents

The methods and systems described herein enable the updating and generation of DE documents using the full functionality of the IDEP shown in FIG. 1. In FIG. 1, the IDEP virtual feedback loop 104 allows the scripting of program code within a digital thread 162 for the generation, storing, and updating of digital twins 122 and twin configurations 156. Similarly, the IDEP virtual feedback loop 104 also allows the scripting of program code within a digital thread 162 for the generation, storing, and updating of DE documents. This enables the creation and maintenance of so-called live digital engineering documents.

Live DE documents are more akin to a DTw than a conventional static document in that they are configured, through a digital thread, to be continuously updated to reflect the most current changes within a particular twin configuration. In particular, an authoritative live DE document is configured to reflect the latest authoritative twin configuration. The “printing” of a live DE document corresponds to the generation of a frozen (i.e., static) time-stamped version of a live DE document. Therefore, “printing”—for a live DE document—is equivalent to “instantiation” for a DTw.

Live DE documents may also be known as magic documents as changes implemented within a twin configuration (e.g., through a modification of a model file) may appear instantaneously within the relevant data fields and sections of the live DE document. Similarly, authoritative live DE documents may also be known as authoritative magic documents as they continuously reflect data from the authoritative twin, thus always representing the authoritative source of truth.

Given the massive quantities of data and potential modifications that are carried out during a product's lifecycle, the scripts implementing live DE documentation may be configured to allow for a predefined maximum delay between the modification of a model file and the execution of the corresponding changes within a live DE document. Moreover, for similar reasons, the scripts implementing live DE documentation may be restricted to operate over a specified subset of model files within a DTw, thus reflecting changes only to key parameters and configurations of the DTw.

In one embodiment of the present invention, an IDEP script (e.g., an IDEP application) having access to model data via one or more model splices and DE document templates to create and/or update a live DE document may dynamically update the live DE document using software-defined digital threads over an IDEP platform. In such an embodiment, the IDEP script may receive user interactions dynamically. In response to the user updating data for a model and/or a specific parameter setting, the IDEP script may dynamically propagate the user's updates into the DE document through a corresponding digital thread.

In another embodiment of the present invention, the IDEP script may instantiate a DE document with sufficient specification to generate a physical twin (PTw). In such an embodiment, the IDEP script may receive a digital twin configuration of a physical twin, generate a live DE document associated with the digital twin configuration, receive a predetermined timestamp, and generate a printed DE document (i.e., a static, time-stamped version of the live DE document at the predetermined timestamp). Such an operation may be referred to as the “printing of a digital twin”.

In yet another embodiment of the present invention, an IDEP script may instantiate (i.e., “print”) a DE document specifying an updated digital twin upon detecting the update. In such an embodiment, the IDEP script may detect a modification of a DE model or an associated digital thread. In response to detecting the modification, the IDEP script may update relevant data fields and sections of the live DE document based on the detected modification, and generate an updated printed DE document with the updated relevant data fields and sections based on the always-updated live DE document.

In various embodiments, a software-defined digital thread can be associated with a companion magic document (or “magic doc”) that encompasses live updates for one or more core parameters of the digital thread. In one embodiment, the magic doc includes key parameters describing the implementation of a user's intent. For example, In one embodiment, a companion magic doc for a given digital thread may include key data points and key orchestration script examples illustrating a user's intent (e.g., “increase a drone's wing span by 1%”). In one embodiment, a script-generating ML model receiving as input pseudocode or detailed user instructions derived from a user's intent is trained on prior IDEP digital threads and documents. In addition to generating a digital thread (with orchestration scripts and comments), the script-generating ML model is also configured to generate a magic doc that explains how the generated digital thread addresses the user intent.

In some embodiments, receiving user interactions with a DE model, modifications to a DE model, or modifications to an associated digital thread, may be carried out through a push configuration, where a model splicer or a script of the digital thread sends any occurring relevant updates to the IDEP script immediately or within a specified maximum time delay. In other embodiments, receiving user interactions with a DE model, modifications of a DE model, or modifications of an associated digital thread, may be carried out through a pull configuration, where a model splicer or a script of the digital thread flag recent modifications until the IDEP script queries relevant DE models (via their model splices) or associated digital threads, for flagged modification. In these embodiments, the IDEP script may extract the modified information from the modified DE models (via their model splices) or the modified digital threads, in order to update a live DE document. In yet other embodiments, receiving user interactions with a DE model, modifications of a DE model, or modifications of an associated digital thread, may be carried out through a pull configuration, where the IDEP script regularly checks relevant DE models (via their model splices) or associated digital threads, for modified data fields, by comparing the data found in the live DE document with regularly extracted model and digital thread data. In these embodiments, the IDEP script may use the modified data to update the live DE document.

### Dynamic Document Updates

Some embodiments described herein center around documentation, or document preparation and update and on document management (e.g., for reviews). As discussed, some embodiments of the system allow for dynamic updates to documents, which pertain to software-defined digital threads in the IDEP platform and the accompanying documentation.

Use of an ML engine with the model data and templates to create and/or update documents almost instantaneously as a one-time action have been presented. Furthermore, the digital engineering platform interacts dynamically with the user. As the user interacts with the system and updates data for a model or a specific parameter setting, these changes may be propagated through the corresponding digital threads and to the associated documentation. The AI architectures involved include locally-instanced large language model (LLMs, for data security reasons) as well as non-LLM approaches (e.g., NLP-based), in order to create, update, or predict documentation in the form of sentences, paragraphs, and whole documents. At the same time, trying to update the entire system of digital threads for every update may be prohibitively slow and may present security risks to the system. Generating live DE documents that are updated based on a subset of a system's DE models and within a maximum time delay may therefore be more efficient.

### Interconnected Digital Engineering and Certification Ecosystem

FIG. 2 shows an exemplary implementation of the IDEP as an interconnected digital engineering (DE) and certification ecosystem 200, and exemplary digitally certified products, in accordance with some embodiments of the present invention. Interconnected DE and certification ecosystem 200 may be viewed as a particular instantiation or implementation of IDEP 100 shown in FIG. 1. The IDEP may also be referred to as a “DE Metaverse.”

Interconnected DE and certification ecosystem 200 is a computer-based system that links models and simulation tools with their relevant requirements in order to meet verification, validation, and certification purposes. Verification refers to methods of evaluating whether a product, service, or system meets specified requirements and is fit for its intended purpose. For example, in the aerospace industry, a verification process may include testing an aircraft component to ensure it can withstand the forces and conditions it will encounter during flight. Verification also includes checking externally against customer or stakeholder needs. Validation refers to methods of evaluating whether the overall performance of a product, service, or system is suitable for its intended use, including its compliance with regulatory requirements and its ability to meet the needs of its intended users. Validation also includes checking internally against specifications and regulations. Interconnected DE and certification ecosystem 200 as disclosed herein is designed to connect and bridge large numbers of disparate DE tools and models from multitudes of engineering domains and fields, or from separate organizations who may want to share models with each other but have no interactions otherwise. In various embodiments, the system implements a robust, scalable, and efficient DE model collaboration platform, with extensible model splices having data structures and accompanying functions for widely distributed DE model types and DE tools, an application layer that links or connects DE models via APIs, digital threads that connect live engineering model files for collaboration and sharing, digital documentation management to assist with the preparation of engineering and certification documents appropriate for verification and validation (V&V) purposes, and AI-assistance with the functionalities of the aforementioned system components.

More specifically, FIG. 2 shows an example of an interconnected DE and certification ecosystem and examples of digitally certified products 212A, 212B, and 212C (collectively referred to as digitally certified products 212). For example, in some implementations, digitally certified product 212A may be an unmanned aerial vehicle (UAV) or other aircraft, digitally certified product 212B may be a drug or other chemical or biologic compound, and the digitally certified product 212C may be a process such as a manufacturing process. In general, the digitally certified products 212 can include any product, process, or solution that can be developed, tested, or certified (partially or entirely) using DE tools such as 202. In some implementations, digitally certified products 212 may not be limited to physical products, but can include non-physical products such as methodologies, processes and software, etc. While physical and physically-interacting systems often require multiple DE tools to assess for compliance with common V&V products simply by virtue of the need for modeling and simulation (M&S), many complex non-physical systems may also require multiple DE tools for product development, testing, and/or certification. With this in mind, various other possibilities for digitally certified products will be recognized by one of ordinary skills in the art. The inclusion of regulatory and certification standards, compliances, calculations, and tests (e.g., for the development, testing, and certification of products and/or solutions) enables users to incorporate relevant regulatory and certification standards, compliances, calculations, and test data directly into their DE workflow. Regulatory and certification standards, compliances, calculations, and tests are sometimes referred to herein as “common validation and verification (V&V) products.”

Digitally certified products 212 in FIG. 2 may be designed and/or certified using interconnected DE and certification ecosystem 200. Interconnected DE and certification ecosystem 200 may include a user device 206A, API 206B, or other similar human-to-machine, or machine-to-machine communication interfaces operated by a user. A user may be a human 204 of various skill levels, or artificial users such as algorithms, artificial intelligence, or other software that interface with ecosystem 200 through API 206B. Ecosystem 200 may further comprise a computing and control system 208 (“computing system 208” hereinafter) connected to and/or including a data storage unit 218, an artificial intelligence (AI) engine 220, and an application and service layer 222. In some embodiments, the artificial intelligence (AI) engine 220 is a machine learning (ML) engine. References to “machine learning engine 220 “or “ML engine 220” may be extended to artificial intelligence (AI) engines 220 more generally. For the purposes of clarity, any user selected from various potential human or artificial users are referred to herein simply as the user 204. In some implementations, computing system 208 may be a centralized computing system; in some implementations, computing system 208 may be a distributed computing system. In some cases, user 204 may be considered part of ecosystem 200, while in other implementations, user 204 may be considered separately from ecosystem 200. Ecosystem 200 may include one or more DE tools 202, such as data analysis tool 202A, computer-aided design (CAD) and finite element analysis (FEA) tool 202B, simulation tool 202C, drug modeling and simulation (M&S) tools 202D-202E, manufacturing M&S tools 202F-202G, etc. Ecosystem 200 may also include a repository of common V&V products 210, such as regulatory standards 210A-210F related to the development and certification of a UAV, medical standard 210G (e.g., CE marking (Europe), FCC Declaration of Conformity (USA), IECEE CB Scheme (Europe, North America, parts of Asia & Australia), CDSCO (India), FDA (USA), etc.), medical certification regulation 210H (e.g., ISO 13485, ISO 14971, ISO 9001, ISO 62304, ISO 10993, ISO 15223, ISO 11135, ISO 11137, ISO 11607, IEC 60601, etc.), manufacturing standard 210I (e.g., ISO 9001, ISO 9013, ISO 10204, EN 1090, ISO 14004, etc.), and manufacturing certification regulation 210J (e.g., General Certification of Conformity (GCC), etc.), etc.

In FIG. 2, computing system 208 is centrally disposed within the architecture and is configured to communicate with (e.g., receive data from and transmit data to) user device 206A or API 206B such as an API associated with an artificial user, DE tools 202 via an API or software development kit (SDK) 214, and repository of common V&V products 210 via an API/SDK interface 216. For example, computing system 208 may be configured to communicate with user device 206A and/or API 206B to send or receive data corresponding to a prototype of a design, information about a user (e.g., user credentials), engineering-related inputs/outputs associated with DE tools 202, digitized common V&V products, an evaluation of a product design, user instructions (e.g., search requests, data processing instructions, etc.), and more. Computing system 208 may also be configured to communicate with one or more DE tools 202 to send engineering-related inputs for executing analyses, models, simulations, tests, etc. and to receive engineering-related outputs associated with the results. Computing system 208 may also be configured to communicate with repository of common V&V products 210 to retrieve data corresponding to one or more digitized common V&V products 210 and/or upload new common V&V products, such as those received from user 204, to repository of common V&V products 210. All communications may be transmitted and corroborated securely, for example, using methods relying on zero-trust security. In some implementations, the computing system of the ecosystem may interface with regulatory and/or certification authorities (e.g., via websites operated by the authorities) to retrieve digitized common V&V products published by the regulatory authorities that may be relevant for a product that a user is designing. In some implementations, the user may upload digitized common V&V products to the ecosystem themselves.

Computing and control system 208 may process and/or store the data that it receives to perform analysis and control functionalities, and in some implementations, may access machine learning engine 220 and/or application and service layer 222, to identify useful insights based on the data, as further described herein. The central disposition of computing system 208 within the architecture of the ecosystem has many advantages including reducing the technical complexity of integrating the various DE tools; improving the product development experience of user 204; intelligently connecting common V&V products such as standards 210A-210F to DE tools 202 most useful for satisfying requirements associated with the common V&V products; and enabling the monitoring, storing, and analysis of the various data that flows between the elements of the ecosystem throughout the product development process. In some implementations, the data flowing through and potentially stored by the computing system 208 can also be auditable to prevent a security breach, to perform data quality control, etc. Similarly, any analysis and control functions performed via computing system 208 may be tracked for auditability and traceability considerations.

Referring to one particular example shown in FIG. 2, user 204 may use the DE and certification ecosystem to produce a digitally certified UAV 212B. For example, user 204 may be primarily concerned with certifying the UAV as satisfying the requirements of a particular regulatory standard 210E relating to failure conditions of the UAV (e.g., “MIL-HDBK 516C 4.1.4-Failure Conditions”). In this usage scenario, user 204 may develop a digital prototype of the UAV on user device 206A or using API 206B and may transmit prototype data (e.g., as at least one of a CAD file, a MBSE file, etc.) to computing system 208. Along with the prototype data, user 204 can transmit, via user device 206A, additional data including an indication of the common V&V product that user 204 is interested in certifying the product for (e.g., regulatory standard 210E), user credential information for accessing one or more capabilities of computing system 208, and/or instructions for running one or more digital models, tests, and/or simulations using a subset of DE tools 202.

Referring to another example shown in FIG. 2, user 204 can use the DE and certification ecosystem to produce a digitally certified drug, chemical compound, or biologic 212A. For example, user 204 may be primarily concerned with certifying drug, chemical compound, or biologic 212A as satisfying the requirements of a particular medical standard 210G and medical certification regulation 210H. In this usage scenario, user 204 can develop a digital prototype of the drug, chemical compound, or biologic on user device 206A or using API 206B and can transmit the prototype data (e.g., as a molecular modeling file) to computing system 208. Along with the prototype data, user 204 can transmit, via user device 206A, additional data including an indication of the common V&V products that user 204 is interested in certifying the product for (e.g., medical standard 210G and medical certification regulation 210H), user credential information for accessing one or more capabilities of computing system 208, and/or instructions for running one or more digital models, tests, and/or simulations using a subset of DE tools 202 (e.g., drug M&S tools 202D-202E).

Referring to yet another example shown in FIG. 2, user 204 can use the digital engineering and certification ecosystem to produce a digitally certified manufacturing process 212C. For example, user 204 may be primarily concerned with certifying manufacturing process 212C as satisfying the requirements of a particular manufacturing standard 210I and manufacturing certification regulation 210J. In this usage scenario, user 204 can develop a digital prototype of the manufacturing process on user device 206A or using API 206B and can transmit the prototype data to computing system 208. Along with the prototype data, user 204 can transmit, via the user device 206A, additional data including an indication of the common V&V products that user 204 is interested in certifying the process for (e.g., manufacturing standard 210I and manufacturing certification regulation 210J), user credential information for accessing one or more capabilities of computing system 208, and/or instructions for running one or more digital models, tests, and/or simulations using a subset of DE tools 202 (e.g., manufacturing M&S tools 202F-202G).

In any of the aforementioned examples, computing system 208 can receive the data transmitted from user device 206A and/or API 206B and can process the data to evaluate whether the common V&V product of interest (e.g., regulatory standard 210E, medical standard 210G, medical certification regulation 210H, manufacturing standard 210I, manufacturing certification regulation 210J, etc.) is satisfied by the user's digital prototype, in the context of analysis and control plane 150 shown in FIG. 1. For example, this can involve communicating with the repository of common V&V products 210 via the API/SDK 216 to retrieve the relevant common V&V product of interest and processing the regulatory and/or certification data associated with the common V&V product to identify one or more requirements for the UAV prototype; the drug, chemical compound, or biologic prototype; the manufacturing process prototype; etc. In some implementations, repository of common V&V products 210 can be hosted by a regulatory and/or certification authority (or another third party), and retrieving the regulatory and/or certification data can involve using API/SDK 216 to interface with one or more data resources maintained by the regulatory and/or certification authority (or the another third party). In some implementations, the regulatory and/or certification data can be provided directly by user 204 via user device 206A and/or API 206B (e.g., along with the prototype data).

Evaluating whether the common V&V product of interest is satisfied by the user's digital prototype can also involve processing the prototype data received from user device 206A or API 206B to determine if the one or more identified requirements are actually satisfied. In some implementations, computing system 208 can include one or more plugins, local applications, etc. to process the prototype data directly at the computing system 208. For example, model splicing and digital threading applications are discussed in detail later with reference to FIGS. 6 to 9. In some implementations, the computing system can simply pre-process the received prototype data (e.g., to derive inputs for DE tools 202) and can then transmit instructions and/or input data to a subset of DE tools 202 via API/SDK 214 for further processing.

Not all DE tools 202 are necessarily required for the satisfaction of particular regulatory and/or certification standards. Therefore, in the UAV example provided in FIG. 2, computing system 208 may determine that only a data analysis tool 202A and a finite element analysis tool 202B are required to satisfy regulatory standard 210E for failure conditions. In the drug, chemical compound, or biologic example provided in FIG. 2, computing system 208 may determine that only drug M&S tools 202D-202E are required to satisfy medical standard 210G and medical certification regulation 210H. In the manufacturing process example provided in FIG. 2, computing system 208 may determine that only manufacturing M&S tools 202F-202G are required to satisfy manufacturing standard 210I and manufacturing certification regulation 210J. In other implementations, user 204 may themselves identify the particular subset of DE tools 202 that should be used to satisfy the common V&V product of interest, provided that user 204 is a qualified subject matter expert (SME). In other implementations, user 204 may input to computing system 208 some suggested DE tools 202 to satisfy a common V&V product of interest, and computing system 208 can recommend to user 204 a modified subset of DE tools 202 for final approval by user 204, provided that user 204 is a qualified SME. After a subset of DE tools 202 has been identified, computing system 208 can then transmit instructions and/or input data to the identified subset of DE tools 202 to run one or more models, tests, and/or simulations. The results (or “engineering-related data outputs” or “digital artifacts”) of these models, tests, and/or simulations can be transmitted back and received at computing system 208.

In still other implementations, user 204 may input a required DE tool such as 202F for meeting a common V&V product 210I, and the computing system 208 can determine that another DE tool such as 102G is also required to satisfy common V&V product 210I. The computing system can then transmit instructions and/or input data to both DE tools (e.g., 202F and 202G), and the outputs of these DE tools can be transmitted and received at computing system 208. In some cases, the input data submitted to one of the DE tools (e.g., 202G) can be derived (e.g., by computing system 208) from the output of another of the DE tools (e.g., 202F).

After receiving engineering-related data outputs or digital artifacts from DE tools 202, computing system 208 can then process the received engineering-related data outputs to evaluate whether or not the requirements identified in the common V&V product of interest (e.g., regulatory standard 210E, medical standard 2110G, medical certification regulation 210H, manufacturing standard 210I, manufacturing certification regulation 210J, etc.) are satisfied. For example, applications and services 222 may provide instructions for orchestrating validation or verification activities. In some implementations, computing system 208 can generate a report summarizing the results of the evaluation and can transmit the report to device 206A or API 206B for review by user 204. If all of the requirements are satisfied, then the prototype can be certified, resulting in digitally certified product 212 (e.g., digitally certified drug, chemical compound, or biologic 212A; digitally certified UAV 212B; digitally certified manufacturing process 212C, etc.). However, if some of the regulatory requirements are not satisfied, then additional steps may need to be taken by user 204 to certify the prototype of the product. In some implementations, the report that is transmitted to the user can include recommendations for these additional steps (e.g., suggesting one or more design changes, suggesting the replacement of one or more components with a previously designed solution, suggesting one or more adjustments to the inputs of the models, tests, and/or simulations, etc.). If the requirements of a common V&V product are partially met, or are beyond the collective capabilities of distributed engineering tools 202, computing systems 208 may provide user 204 with a report recommending partial certification, compliance, or fulfillment of a subset of the common V&V products (e.g., digital certification of a subsystem or a sub-process of the prototype). The process of generating recommendations for user 204 is described in further detail below.

In response to reviewing the report, user 204 can make design changes to the digital prototype locally and/or can send one or more instructions to computing system 208 via user device 206A or API 206B. These instructions can include, for example, instructions for computing system 208 to re-evaluate an updated prototype design, use one or more different DE tools 202 for the evaluation process, and/or modify the inputs to DE tools 202. Computing system 208 can, in turn, receive the user instructions, perform one or more additional data manipulations in accordance with these instructions, and provide user 204 with an updated report. Through this iterative process, user 204 can utilize the interconnected digital engineering and certification ecosystem to design and ultimately certify (e.g., by providing certification compliance information) the prototype (e.g., the UAV prototype, drug prototype, manufacturing process prototype, etc.) with respect to the common V&V product of interest. Importantly, since all of these steps occur in the digital world (e.g., with digital prototypes, digital models/tests/simulations, and digital certification), significant amount of time, cost, and materials can be saved in comparison to a process that would involve the physical prototyping, evaluation and/or certification of a similar UAV, drug, manufacturing process, etc. If the requirements associated with a common V&V product are partially met, or are beyond the collective capabilities of DE tools 202, computing system 208 may provide user 204 with a report recommending partial certification, compliance or fulfillment of a subset of the common V&V products (e.g., digital certification of a subsystem or a sub-process of the prototype).

While the examples described above focus on the use of the interconnected digital engineering and certification ecosystem by a single user, additional advantages of the ecosystem can be realized through the repeated use of the ecosystem by multiple users. As mentioned above, the central positioning of computing system 208 within the architecture of the ecosystem enables computing system 208 to monitor and store the various data flows through the ecosystem. Thus, as an increasing number of users utilize the ecosystem for digital product development, data associated with each use of the ecosystem can be stored (e.g., in storage 218), traced (e.g., with metadata), and analyzed to yield various insights, which can be used to further automate the digital product development process and to make the digital product development process easier to navigate for non-subject matter experts.

Indeed, in some implementations, user credentials for user 204 can be indicative of the skill level of user 204, and can control the amount of automated assistance the user is provided. For example, non-subject matter experts may only be allowed to utilize the ecosystem to browse pre-made designs and/or solutions, to use DE tools 202 with certain default parameters, and/or to follow a predetermined workflow with automated assistance directing user 204 through the product development process. Meanwhile, more skilled users may still be provided with automated assistance, but may be provided with more opportunities to override default or suggested workflows and settings.

In some implementations, computing system 208 can host applications and services 222 that automate or partially automate components of common V&V products; expected or common data transmissions, including components of data transmissions, from user 204; expected or common interfaces and/or data exchanges, including components of interfaces, between various DE tools 202; expected or common interfaces and/or data exchanges, including components of interfaces, with machine learning (ML) models implemented on computing system 208 (e.g., models trained and/or implemented by the ML engine 220); and expected or common interfaces and/or data exchanges between the applications and services themselves (e.g., within applications and services layer 222).

In some implementations, the data from multiple uses of the ecosystem (or a portion of said data) can be aggregated to develop a training dataset. For example, usage records 217 collected via computing system 208 may be de-identified or anonymized, before being added to the training set. Such usage records may comprise model parameters and metadata, tool configurations, common V&V product matching to specific models or tools, user interactions with the system including inputs and actions, and other user-defined or system-defined configurations or decisions in using the ecosystem for digital engineering and certification. For instance, an exemplary de-identified usage record may comprise the combination of a specific DE tool, a specific target metric, a specific quantity deviation, and a corresponding specific user update to a DE model under this configuration. Another exemplary de-identified usage record may comprise a user-identified subset of DE tools 202 that should be used to satisfy a common V&V product of interest.

This training dataset can then be used to train ML models (e.g., using ML engine 220) to learn the steps and actions for certification processes and to perform a variety of tasks including the identification of which of DE tools 202 to use to satisfy a particular common V&V product; the identification of specific models, tests, and/or simulations (including inputs to them) that should be performed using DE tools 202; the identification of the common V&V products that need to be considered for a product of a particular type; the identification of one or more recommended actions for user 204 to take in response to a failed regulatory requirement; the estimation of model/test/simulation sensitivity to particular inputs; etc. The outputs of the trained ML models can be used to implement various features of the interconnected digital engineering and certification ecosystem including automatically suggesting inputs (e.g., inputs to DE tools 202) based on previously entered inputs, forecasting time and cost requirements for developing a product, predictively estimating the results of sensitivity analyses, and even suggesting design changes, original designs or design alternatives (e.g., via assistive or generative AI) to a user's prototype to overcome one or more requirements (e.g., regulatory and/or certification requirements) associated with a common V&V product. In some implementations, with enough training data, ML engine 220 may generate new designs, models, simulations, tests, common V&V products and/or digital threads on its own based on data collected from multiple uses of the ecosystem. Furthermore, such new designs, models, simulations, tests, common V&V products and digital threads generated by ML engine 220, once approved and adjusted by a user, may be added to the training set for further fine-tuning of ML algorithms in a reinforcement learning setup.

As shall be discussed in the context of FIGS. 7 to 9, the aforementioned collection of training datasets and the training of ML and AI modules including ML engine 220 may be enabled by model splicing technologies. Model splicing, as described herein, allows the scripting of DE model operations encompassing disparate DE tools into a corpus of normative program code, and facilitates the code-defined digital threading of a large space of DE activities involving DE models across different disciplines. ML and AI techniques may be used to create scripts to carry out almost any DE task and to execute any digital thread, allowing for programmable, machine-learnable, and dynamic changes to DE model files, digital threads, and ultimately to digital or physical twins, throughout the product life cycle. For example, in the embodiment shown in FIG. 2, ML engine 220 may manage or orchestrate the interactions between spliced DE models, DE tools, and common V&V products (e.g., DE requirements), based on digital thread options specific to user's intent and input. Sample DE tasks that may be carried out by ML engine 220 include, but are not limited to, (1) aligning models/analysis to certification lifecycle requirement steps, (2) optimizing compute by determining the appropriate fidelity of each model, (3) optimizing compute resources for specific tools/models, or (4) optimizing compute resources across multiple models. ML-enabled executions of DE tasks are not limited to certification or resource optimization, but encompass the whole DE space of operations. Rather, ML engine 220 may act as an AI multiplexer for the DE platform.

In addition to storing usage data to enable the development of ML models, previous prototype designs and/or solutions (e.g., previously designed components, systems, models, simulations and/or other engineering representations thereof) can be stored within the ecosystem (e.g., in storage 218) to enable users to search for and build upon the work of others. For example, previously designed components, systems, models, simulations and/or other engineering representations thereof can be searched for by user 204 and/or suggested to user 204 by computing system 208 in order to satisfy one or more requirements associated with a common V&V product. The previously designed components, systems, models, simulations and/or other engineering representations thereof can be utilized by user 204 as is, or can be utilized as a starting point for additional modifications. This store, or repository, of previously designed components, systems, models, simulations and/or other engineering representations thereof (whether or not they were ultimately certified) can be monetized to create a marketplace of digital products, which can be utilized to save time during the digital product development process, inspire users with alternative design ideas, avoid duplicative efforts, and more. In some implementations, data corresponding to previous designs and/or solutions may only be stored if the user who developed the design and/or solution opts to share the data. In some implementations, the repository of previous designs and/or solutions can be containerized for private usage within a single company, team, organizational entity, or technical field for private usage (e.g., to avoid the unwanted disclosure of confidential information). In some implementations, user credentials associated with user 204 can be checked by computing system 208 to determine which designs and/or solutions stored in the repository can be accessed by user 204. In some implementations, usage of the previously designed components, systems, models, simulations and/or other engineering representations thereof may be available only to other users who pay a fee for a usage.

### Exemplary IDEP Implementation Architecture with Services and Features

FIG. 3 shows another exemplary implementation of the IDEP illustrating its offered services and features, in accordance with some embodiments of the present invention. Specifically, an exemplary implementation architecture diagram 300 is shown in FIG. 3 to include multiple illustrative components: an IDEP enclave 302, cloud services 304, and a customer environment 310 which optionally includes an IDEP exclave 316. This exemplary architecture 300 for the IDEP is designed in accordance with zero-trust security principles and is further designed to support scalability as well as robust and resilient operations. IDEP enclave 302 and IDEP exclave 316 together instantiate IDEP 100 shown in FIG. 1, with IDEP exclave 316 implementing model splicing and splice plane 170 in some embodiments of the present invention. An enclave is an independent set of cloud resources that are partitioned to be accessed by a single customer (i.e., single-tenant) or market (i.e., multi-tenant) that does not take dependencies on resources in other enclaves. An exclave is a set of cloud resources outside enclaves managed by the IDEP, to perform work for individual customers. Examples of exclaves include virtual machines (VMs) and/or servers that the IDEP maintains to run DE tools for customers who need such services.

In particular, IDEP enclave or DE platform enclave 302 may serve as a starting point for services rendered by the IDEP, and may be visualized as a central command and control hub responsible for the management and orchestration of all platform operations. For example, enclave 302 may be implemented using computer system 208 of the interconnected DE and certification ecosystem shown in FIG. 2. DE platform enclave 302 is designed to integrate both zero-trust security models and hyperscale capabilities, resulting in a secure and scalable processing environment tailored to individual customer needs. Zero-trust security features include, but are not limited to, strict access control, algorithmic impartiality, and data isolation. Enclave 302 also supports an ML engine such as 220 for real-time analytics, auto-scaling features for workload adaptability, and API-based interoperability with third-party services. Security and resource optimization are enhanced through multi-tenancy support, role-based access control, and data encryption both at rest and in transit. DE platform enclave 302 may also include one or more of the features described below.

First, IDEP enclave 302 may be designed in accordance with zero-trust security principles. In particular, DE platform enclave 302 may employ zero-trust principles to ensure that no implicit trust is assumed between any elements, such as digital models, platform agents or individual users (e.g., users 204) or their actions, within the system. That is, no agent may be inherently trusted and the system may always authenticate or authorize for specific jobs. The model is further strengthened through strict access control mechanisms, limiting even the administrative team (e.g., a team of individuals associated with the platform provider) to predetermined, restricted access to enclave resources. To augment this robust security stance, data encryption is applied both at rest and in transit, effectively mitigating risks of unauthorized access and data breaches.

IDEP enclave 302 can also be designed to maintain isolation and independence. A key aspect of the enclave's architecture is its focus on impartiality and isolation. DE enclave 302 disallows cryptographic dependencies from external enclaves and enforces strong isolation policies. The enclave's design also allows for both single-tenant and multi-tenant configurations, further strengthening data and process isolation between customers 306 (e.g., users 204). Additionally, DE enclave 302 is designed with decoupled resource sets, minimizing interdependencies and thereby promoting system efficiency and autonomy.

IDEP enclave 302 can further be designed for scalability and adaptability, aligning well with varying operational requirements. For example, the enclave 302 can incorporate hyperscale-like properties in conjunction with zero-trust principles to enable scalable growth and to handle high-performance workloads effectively.

IDEP enclave 302 can further be designed for workflow adaptability, accommodating varying customer workflows and DE models through strict access control mechanisms. This configurability allows for a modular approach to integrate different functionalities ranging from data ingestion to algorithm execution, without compromising on the zero-trust security posture. Platform 300's adaptability makes it highly versatile for a multitude of use-cases, while ensuring consistent performance and robust security.

IDEP enclave 302 can further be designed to enable analytics for robust platform operations. At the core of the enclave's operational efficiency is a machine learning engine (e.g., machine learning engine 220) capable of performing real-time analytics. This enhances decision-making and operational efficiency across platform 300. Auto-scaling mechanisms can also be included to enable dynamic resource allocation based on workload demand, further adding to the platform's responsiveness and efficiency.

In the exemplary embodiment shown in FIG. 3, IDEP enclave 302 includes several components as described in further detail herein.

A “Monitoring Service Cell. may provide “Monitoring Service” and “Telemetry Service.” A cell may refer to a set of microservices, for example, a set of microservices executing within a kubernetes pod. These components focus on maintaining, tracking and analyzing the performance of platform 300 to ensure good service delivery, including advanced machine learning capabilities for real-time analytics. A “Search Service Cell” provides “Search Service” to aid in the efficient retrieval of information from DE platform 300, adding to its overall functionality. A “Logging Service Cell” and a “Control Plane Service Cell” provides “Logging Service,” “File Service”, and “Job Service” to record and manage operational events and information flow within platform 300, and are instrumental in the functioning of platform 300. A “Static Assets Service Cell,” provides “Statics Service”, and may house user interface, SDKs, command line interface (CLI), and documentation for platform 300. An “API Gateway Service Cell” provides “API Gateway Service,” and may provide DE platform API(s) (e.g., APIs 214, 216) and act as a mediator for requests between the client applications (e.g., DE tools 202, the repository of common V&V products 210, etc.) and the platform services. In some embodiments, the API gateway service cell may receive and respond to requests from agents such as DE platform exclave 316 to provide splice functions for model splicing purposes.

As shown in FIG. 3, the architecture of DE platform 300 may also include a cloud services 304 that provide services which cannot interact with customer data but can modify the software for the orchestration of DE platform operations. In example implementations, several cloud resources provide support and foundational services to the platform. For example, in the embodiment of the DE platform 300 shown in FIG. 3, cloud services 304 includes a “Customer Identity and Access Management (IAM) Service” that ensures secure and controlled access to platform 300. Cloud services 304 also includes a “Test Service” that tests tools to validate platform operations. Cloud services 304 may also include an “Orchestration Service” that controls and manages the lifecycle of containers on the platform 300. Cloud services 304 may also include an “Artifact Service” and “Version Control and Build Services,” which may be used to maintain the evolution of projects, codes, and instances in the system, while also managing artifacts produced during the product development process.

As shown in FIG. 3, the architecture of DE platform 300 may also include a customer environment 310 with an “Authoritative Source of Truth” 312, customer tools 314, and an optional DE platform exclave 316. Customer environment 310 is where customer data resides and is processed in a zero-trust manner by DE platform 300. As described previously, DE platform enclave 302, by focusing on both zero-trust principles and hyperscale-like properties, provides a robust and scalable environment for the secure processing of significant workloads, according to the customer's unique needs. In some examples, DE platform exclave 316 may be situated within customer environment 310 in order to assist the customer(s) 306 with their DE tasks and operations, including model splicing and digital threading.

When a customer 306 (e.g., user 204) intends to perform a DE task using DE platform 300 (e.g., IDEP 100), typical operations may include secure data ingestion and controlled data retrieval. Derivative data generated through the DE operations, such as updated digital model files or revisions to digital model parameters, may be stored only within customer environment 310, and DE platform 300 may provide tools to access the metadata of the derivative data. Here metadata refers to data that can be viewed without opening the original data, and may comprise versioning information, time stamps, access control properties, and the like. Example implementations may include secure data ingestion, which utilizes zero-trust principles to ensure customer data is securely uploaded to customer environment 310 through a pre-validated secure tunnel, such as Secure Socket Layer (SSL) tunnel. This can enable direct and secure file transfer to a designated cloud storage, such as a simple storage service (S3) bucket, within customer environment 310. Example implementations may also include controlled data retrieval, in which temporary, pre-authenticated URLs generated via secure token-based mechanisms are used for controlled data access, thereby minimizing the risk of unauthorized interactions. Example implementations may also include immutable derivative data, with transformed data generated through operations like data extraction being securely stored within customer environment 310 while adhering to zero-trust security protocols. Example implementations may also include tokenization utility, in which a specialized DE platform tool referred to as a “tokenizer” is deployed within customer environment 310 for secure management of derivative metadata, conforming to zero-trust guidelines.

Customer environment 310 may interact with other elements of secure DE platform 300 and includes multiple features that handle data storage and secure interactions with platform 300. For example, one element of the customer environment 310 is “Authoritative Source of Truth” 312, which is a principal repository for customer data, ensuring data integrity and accuracy. Nested within this are “Customer Buckets” where data is securely stored with strict access controls, limiting data access to authorized users or processes through pre-authenticated URL links. This setup ensures uncompromising data security within customer environment 310 while providing smooth interactions with other elements of DE platform 300.

Customer environment 310 may also include additional software tools such as customer tools 314 that can be utilized based on specific customer requirements. For example, a “DE Tool Host” component may handle necessary DE applications for working with customer data. It may include a DE Tools Command-Line Interface (DET CLI), enabling user-friendly command-line operation of DE tools (e.g., DE tools 102). A “DE platform Agent” ensures smooth communication and management between customer environment 310 and elements of DE platform 300. Furthermore, there can be another set of optional DE tools designed to assist customer-specific DE workflows. Native DE tools are typically access-restricted by proprietary licenses and end-user license agreements paid for by the customer. IDEP platform functions call upon native DE tools that are executed within customer environment 310, therefore closely adhering to the zero-trust principle of the system design. Exemplary DE tools include, but are not limited to, proprietary and open-source versions of model-based systems engineering (MBSE) tools, augmented reality (AR) tools, computer aided design (CAD) tools, data analytics tools, modeling and simulation (M&S) tools, product lifecycle management (PLM) tools, multi-attribute trade-space tools, simulation engines, requirements model tools, electronics model tools, test-plan model tools, cost-model tools, schedule model tools, supply-chain model tools, manufacturing model tools, cyber security model tools, or mission effects model tools.

In some cases, an optional “IDEP Exclave” 316 may be employed within customer environment 310 to assist with customer DE tasks and operations, supervise data processing, and rigorously adhering to zero-trust principles while delivering hyperscale-like platform performance. IDEP exclave 316 is maintained by the IDEP to run DE tools for customers who need such services. IDEP exclave 316 may contain a “DE Tool Host” that runs DE tools and a “DE Platform Agent” necessary for the operation. Again, native DE tools are typically access-restricted by proprietary licenses and end-user license agreements paid for by the customer. IDEP exclave 316 utilities and manages proprietary DE tools hosted with customer environment 310, for example, to implement model splicing and digital threading functionalities.

In some embodiments, the machine learning (ML) models and artificial intelligence (AI) assistance approaches as described herein adapt to suit different customer instances of the IDEP (see FIG. 4) and the availability of training data. In an example, a pre-trained ML or AI model (e.g., within the IDEP enclave 302) is deployed in instances where there are restrictions around sharing customer data. In another example, AI models are deployed in a federated manner adjacent to DE agents and DE tools in the customer environment (e.g., within IDEP exclave 316). In another example, an AI model deployed inside the customer environment is trained behind its firewalls. In yet another example, the customer may allow sharing of subsets of their metadata for a training database located within the IDEP enclave.

### IDEP Deployment Scenarios

FIG. 4 shows potential scenarios for instantiating an IDEP in connection to a customer's physical system and IT environment, in accordance with some embodiments of the present invention. Specifically, FIG. 4 illustrates various potential configurations for instancing or instantiating an IDEP (“DE platform) 402 in connection to a customer's IT environment and physical system 404. The IT environment may be located on a virtual private cloud (VPC) protected by a firewall. The physical system may refer to a physical twin as discussed with reference to FIG. 1. In some embodiments, IDEP 402 may be instanced as an enclave such as 302 shown in FIG. 3. For example, IDEP 402 may be instanced on the cloud, possibly in a software-as-a-service (SaaS) configuration. The platform instances in these embodiments include software and algorithms, and may be described as follows:
1. External Platform Instance 410: This option showcases the IDEP as a separate platform instance. The platform interacts with the physical system through the customer's virtual environment, or a Customer Virtual Private Cloud (“Customer VPC″), which is connected to the physical system.
2. External Platform Instance with Internal Agent 420: The IDEP is instantiated as a separate platform, connected to an internal agent (“DE Agent”) wholly instanced within the Customer VPC. For example, the IDEP may be instantiated as enclave 302, and the DE agent may be instantiated as exclave 316 within the Customer VPC linked to the physical system.
3. External Platform Instance with Internal Agent and Edge Computing 430: This scenario displays the IDEP as a separate instantiation, connected to an internal DE Agent wholly instanced within the Customer VPC, which is further linked to an edge instance (“DE Edge Instance”) on the physical system. The DE agent is nested within the customer environment, with a smaller edge computing instance attached to the physical system.
4. Edge Instance Connection 440: This option shows the DE platform linked directly to a DE edge instance on the physical system. The DE platform and the physical system are depicted separately, connected by an edge computing instance in the middle, indicating the flow of data.
5. Direct API Connection 450: This deployment scenario shows the DE platform connecting directly to the physical system via API calls. In this depiction, an arrow extends directly from the platform sphere to the physical system sphere, signifying a direct interaction through API.
6. Air-Gapped Platform Instance 460: This scenario illustrates the IDEP being completely instanced on an air-gapped, or isolated, physical system as a DE agent. The platform operates independently from any networks or Internet connections, providing an additional layer of security by eliminating external access points and potential threats. Interaction with the platform in this context would occur directly on the physical system, with any data exchange outside the physical system being controlled following strict security protocols to maintain the air-gapped environment.

Across these deployment scenarios, the IDEP plays an important role in bridging the gap between a digital twin (DTw) established through the IDEP and its physical counterpart. Regardless of how the IDEP is instantiated, it interacts with the physical system, directly or through the customer's virtual environment. The use of edge computing instances in some scenarios demonstrates the need for localized data processing and the trade-offs between real-time analytics and more precise insights in digital-physical system management. Furthermore, the ability of the platform to connect directly to the physical system through API calls underscores the importance of interoperability in facilitating efficient data exchange between the digital and physical worlds. In all cases, the DE platform operates with robust security measures.

In some embodiments, the IDEP deployment for the same physical system can comprise a combination of the deployment scenarios described above. For example, for the same customer, some physical systems may have direct API connections to the DE platform (scenario 5), while other physical systems may have an edge instance connection (scenario 4).

### Multimodal User Interfaces

FIG. 5 illustrates the use of multimodal user interfaces 590 (or multimodal interfaces) for the interconnected DE platform, which can handle various input and output modalities such as Virtual Reality (VR), Mixed Reality (MR), auditory, text, and code. These interfaces are designed to manage the complexity of data streams and decision-making processes, and provide decision support including option visualization, impact prediction, and specific decision invocation. Specifically, data streams 502 and 504 are processed in the Analysis & Control Plane (ACP) 150 of FIG. 1. The user interface may receive data streams from physical and virtual feedback loops 102 and 104, as well as external expert feedback 114, analysis module 154, and twin configuration set 156 of ACP 150.

The multimodal interfaces illustrated in FIG. 5 are configured to carry out all the DE tasks and actions described in the context of FIG. 1, by catering to both humans and bots/algorithms, handling the intricacies of data stream frequency and complexity, decision-making time scales, and latency impacts. In the case of human decision makers, the user interface may need to manage inputs and outputs while for algorithmic decision making, the user interface may need to present rationale and decision analysis to human users. Some examples of human interfaces include a dashboard-style interface 594, a workflow-based interface 596, conversational interfaces 598, spatial computer interfaces 592, and code interfaces 599.

Dashboard-style interface 594 offers a customizable overview of data visualizations, performance metrics, and system status indicators. It enables monitoring of relevant information, sectional review of documents, and decision-making based on dynamic data updates and external feedback. Such an interface may be accessible via web browsers and standalone applications on various devices.

Workflow-based interface 596 guides users through the decision-making process, presenting relevant data, options, and contextual information at each stage. It integrates external feedback and is designed as a progressive web app or a mobile app. In the context of alternative tool selection, workflow-based interface 596 may provide options on individual tools at each stage, or provide combinations of tool selections through various stages to achieve better accuracy or efficiency for the overall workflow.

Conversational interfaces 598 are based on the conversion of various input formats such as text, prompt, voice, audio-visual, etc. into input text, then integrating the resulting input text within the DE platform workflow. Outputs from the DE platform may undergo the reverse process. This enables interoperability with the DE platform, and specifically the manipulation of model splices. In the broad context of audio-visual inputs, the conversational interfaces may comprise data sonification, which involves using sound to represent data, information, or events, and using auditory cues or patterns to communicate important information to users, operators, or reviewers. Sonified alerts (e.g., alerts sent via sound, e.g., via a speaker) are especially useful when individuals need to process information quickly without having to visually focus on a screen. For example, sonified alerts can be used to notify security analysts of potential threats or breaches.

FIG. 5 also illustrates the use of spatial computing interfaces 592 and code interfaces 599 in the management of DTws and PTws. Spatial computing interfaces allow for more immersive and intuitive user experiences, and enable real-time synchronization between DTws and PTws. Code interfaces allow bots and digital engineers to interact with the DE platform through scripting and code. It also allows the collection of user preference, task history, and tool usage patterns for alternative tool selection purposes.

### Digital Threads and Autonomous Data Linkages

As discussed previously, a “digital thread” is intended to connect two or more digital engineering (DE) models for traceability across the systems engineering lifecycle, and collaboration and sharing among individuals performing DE tasks. In a digital thread, appropriate outputs from a preceding digital model may be provided as the inputs to a subsequent digital model, allowing for information and process flow. That is, a digital thread may be viewed as a communication framework or data-driven architecture that connects traditionally siloed elements to enable the flow of information and actions between digital models.

FIG. 6 describes the architecture and inherent complexity of digital threads, in accordance with the examples disclosed herein. Specifically, FIG. 6 is a schematic diagram comparing exemplary digital threads 600 of various complexities that manipulate and/or connect DE models, in accordance with some embodiments of the present invention. In the most basic sense, a digital thread may “thread” together DE models into a simple daisy-chain architecture 602 where modifications in any upstream DE model will affect all DE models downstream from the modified DE model. For example, a modification of any parameter or process of a DE model B will cause changes in DE model C, which in turn will cause changes in DE model D. Cause-and-effect changes will therefore cascade downstream. As another example, diagram 604 represents a more complex digital thread where a change in one DE model may affect more than one downstream model. In both 602 and 604, digital threads are represented by a directed acyclic graph (DAG).

DAGs are frequently used in many kinds of data processing and structuring tasks, such as scheduling tasks, data compression algorithms, and more. In the context of service platforms and network complexities, a DAG might be used to represent the relationships between different components or services within the platform. In digital thread 604, different models may depend on each other in different ways. Model A may affect models B, C, and D, with models B and C affecting model E, and models D and E affecting model G. Such dependencies are denoted as a DAG, where each node is associated with a component (e.g., a model), and each directed edge represents a dependency.

A major issue with dealing with interdependent DE models is that graph consistencies can be polynomial, and potentially exponential, in complexity. Hence, if a node fails (e.g., a model is unreliable), this can have a cascading effect on the rest of the digital thread, disrupting the entire design. Furthermore, adding nodes or dependencies to the graph does not yield a linear increase in complexity because of the interdependencies between models. If a new model is added that affects or depends on several existing models, the resulting increase in graph complexity is multiplicative in nature, hence potentially exponential. The multiplicative nature of digital thread consistencies is compounded by the sheer number of interconnected models, which may number in the hundreds or thousands. Diagram 606 is a partial representation of a real-world digital thread, illustrating the complexity of digital threads and its multiplicative growth.

FIG. 6 further shows special cases 603, 605, 607, 608, and 609 of exemplary simple digital threads. Diagram 607 represents a degenerate digital thread where data is shared from a single DE model. Diagram 608 represents a model-to-document digital thread where data (e.g., system attributes, performance attributes) extracted from a single DE model may be used to generate or update a text-based document (e.g., a Capability Development Document (CDD)). Diagrams 603 and 605 are generalized from 608 to represent cases where data extracted from a single model may be used to update multiple models, or vice versa. Specifically, diagram 605 may represent the dynamic updates of live or magic documents discussed in the context of FIG. 1. Here, the logic to connect the DE models shown is clear: data are extracted from multiple DE models A, B, and C to update a document model D. There are no interactions between the extracted data. Furthermore, diagram 609 shows a special case of a digital thread where data is loaded to and extracted from only a single model A. For example, as discussed in the context of FIG. 7 next, input splice functions of the model A shown in 609 may be executed to update the model, and output splice functions of model A shown in 609 may be executed to produce digital artifacts for sharing. For these special simple threads, the IDEP may provide a GUI-based interface to the user to connect the models and execute the digital threads. For complex threads such as 606, a code-based interface may be necessary.

### Model Splicing for Digital Threading and Digital Twin Generation

As disclosed herein, model splicing encapsulates and compartmentalizes digital engineering (DE) model data and model data manipulation and access functionalities. As such, model splices provide access to selective model data within a DE model file without exposing the entire DE model file, with access control to the encapsulated model data based on user access permissions. Model splicing also provides the DE model with a common, externally-accessible Application Programming Interface (API) for the programmatic execution of DE models. Model splices thus generated may be shared, executed, revised, or further spliced independently of the native DE tool and development platform used to generate the input digital model. The standardization of DE model data and the generalization of API interfaces and functions allow the access of DE model type files outside of their native software environments, and enable the linking of different DE model type files that may not previously be interoperable. Model splicing further enables the scripting and codification of DE operations encompassing disparate DE tools into a corpus of normative program code, facilitating the generation and training of artificial intelligence (AI) and machine learning (ML) models for the purpose of manipulating DE models through various DE tools across different stages of a DE process, DE workflow, or a DE life cycle.

Digital threads are created through user-directed and/or autonomous linking of model splices. A digital thread is intended to connect two or more DE models for traceability across the systems engineering life cycle, and collaboration and sharing among individuals performing DE tasks. In a digital thread, appropriate outputs from a preceding digital model are provided as inputs to a subsequent digital model, allowing for information flow. That is, a digital thread may be viewed as a communication framework or data-driven architecture that connects traditionally siloed elements to enable the flow of information between digital models. The extensibility of model splicing over many different types of DE models and DE tools enables the scaling and generalization of digital threads to represent each and every stage of the DE life cycle.

A digital twin (DTw) is a real-time virtual replica of a physical object or system, with bi-directional information flow between the virtual and physical domains, allowing for monitoring, analysis, and optimization. Model splicing allows for making individual DE model files into executable splices that can be autonomously and securely linked, thus enabling the management of a large number of DE models as a unified digital thread. Such a capability extends to link previously non-interoperable DE models to create digital threads, receive external performance and sensor data streams (e.g., data that is aggregated from DE models or linked from physical sensor data), calibrate digital twins with data streams from physical sensors outside of native DTw environments, and receive expert feedback that provides opportunity to refine simulations and model parameters.

Unlike a DTw, a virtual replica, or simulation, is a mathematical model that imitates real-world behavior to predict outcomes and test strategies. Digital twins use real-time data and have bidirectional communication, while simulations focus on analyzing scenarios and predicting results. In other words, a DTw reflects the state of a physical system in time and space. A simulation is a set of operations done on digital models that reflects the potential future states or outcomes that the digital models can progress to in the future. A simulation model is a DE model within the context of the IDEP as disclosed herein.

When testing different designs, such as variations in wing length or chord dimensions, multiple DTws (sometimes numbering in 100s to 1,000s) may be created, as a bridge between design specifications and real-world implementations of a system, allowing for seamless updates and tracking of variations through vast numbers of variables, as detailed in the context of FIG. 1. As an example, if three variations of a system are made, each one would have its own DTw with specific measurements. These DTws may be accessed and updated via API function scripts, which allow for easy input of new measurements from the physical parts during the manufacturing process. By autonomous linking with appropriate data, a DTw may be updated to reflect the actual measurements of the parts, maintaining traceability and ensuring accurate data representation through hundreds or thousands of models.

### Exemplary Model Splicing Setup

FIG. 7 is a schematic showing an exemplary model splicing setup, according to some embodiments of the present invention. Specifically, FIG. 7 is a schematic showing an embedded CAD model splicing example.

In the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. A model splice may take on the form of a digital file or a group of digital files. A locator refers to links, addresses, pointers, indexes, access keys, Uniform Resource Locators (URL) or similar references to the aforementioned DE digital artifacts and splice functions, which themselves may be stored in access-controlled databases, cloud-based storage buckets, or other types of secure storage environments. The splice functions provide unified and standardized input and output API or SDK endpoints for accessing and manipulating the DE model data. The DE model data are model-type-specific, and a model splice is associated with model-type-specific input and output schemas. One or more different model splices may be generated from the same input DE model file, based on the particular user application under consideration, and depending on data access restrictions. In some contexts, the shorter terms “splice”, “wrapper”, and/or “graft” are used to refer to spliced, wrapped, and/or grafted models.

Model splicing is the process of generating a model splice from a DE model file. Correspondingly, model splicers are program codes or uncompiled scripts that perform model splicing of DE models. A DE model splicer for a given DE model type, when applied to a specific DE model file of the DE model type, retrieves, extracts, and/or derives DE model data associated with the DE model file, generates and/or encapsulates splice functions, and instantiates API or SDK endpoints to the DE model according to input/output schemas. In some embodiments, a model splicer comprises a collection of API function scripts that can be used as templates to generate DE model splices. “Model splicer generation” refers to the process of setting up a model splicer, including establishing an all-encompassing framework or template, from which individual model splices may be deduced.

Thus, a DE model type-specific model splicer extracts or derives model data from a DE model file and/or stores such model data in a model type-specific data structure. A DE model splicer further generates or enumerates splice functions that may call upon native DE tools and API functions for application on DE model data. A DE model splice for a given user application contains or wraps DE model data and splice functions that are specific to the user application, allowing only access to and enabling modifications of limited portions of the original DE model file for collaboration and sharing with stakeholders of the given user application.

Additionally, a document splicer is a particular type of DE model splicer, specific to document models. A “document” is an electronic file that provides information as an official record. Documents include human-readable files that can be read without specialized software, as well as machine-readable documents that can be viewed and manipulated by a human with the help of specialized software such as word processor and/or web services. Thus, a document may contain natural language-based text and/or graphics that are directly readable by a human without the need of additional machine compilation, rendering, visualization, or interpretation. A “document splice”, “document model splice” or “document wrapper” for a given user application can be generated by wrapping document data and splice functions (e.g., API function scripts) that are specific to the user application, thus revealing text at the component or part (e.g., title, table of contents, chapter, section, paragraph) level via API or SDK endpoints, and allowing access to and enabling modifications of portions of an original document or document template for collaboration and sharing with stakeholders of the given user application, while minimizing manual referencing and human errors.

In the CAD model splicing example shown in FIG. 7, a CAD model file diesel-engine.prt 704 proceeds through a model splicing process 710 that comprises a data extraction step 720 and a splice function generation step 730. This input DE model 704 is in a file format (.prt) native to certain DE tools. Data extraction may be performed via a DE model crawling agent implemented as model crawling scripts within a model splicer to crawl through the input DE model file and to distill model data with metadata 722. Metadata are data that can be viewed without opening the entire input DE model file, and may include entries such as file name, file size, file version, last modified date and time, and potential user input options as identified from a user input 706. Model data are extracted and/or derived from the input DE model, and may include but are not limited to, parts (e.g., propeller, engine cylinder, engine cap, engine radiator, etc.), solids, surfaces, polygon representation, and materials, etc. When a model splicer crawls through the model file, it determines how model data may be organized and accessed, as fundamentally defined by a DE tool 702 that is being used in splicing the DE model, and establishes a model data schema. This data schema describes the structure and format of the model data, some of which are translated into, or used to create input/output API endpoints with corresponding input/output schemas. In some embodiments, model data with metadata 722 may be stored in an access-restricted storage 726, such as the “customer buckets” 312 within customer environment 310 in FIG. 3, so that model splices such as 742, 744, and 746 may be generated on-demand once an input DE model 704 has been crawled through.

The model splicer further generates splice functions (e.g., API function scripts) 732 from native APIs 702 associated with the input CAD model. In the present disclosure, “native” and “primal” refer to existing DE model files, functions, and API libraries associated with specific third-party DE tools, including both proprietary and open-source ones. Native API 702 may be provided by a proprietary or open-source DE tool. For example, the model splicer may generate API function scripts that call upon native APIs of native DE tools to perform functions such as: HideParts (parts_list), Generate 2DView ( ) etc. These model-type-specific splice functions may be stored in a splice function database 736, again for on-demand generation of individual model splices. A catalog or specification of splice functions provided by different model splices supported by the IDEP, and orchestration scripts that link multiple model splices, constitutes a Platform API. This platform API is a common, universal, and externally-accessible platform interface that masks native API 702 of any native DE tool integrated into the IDEP, thus enabling engineers from different disciplines to interact with unfamiliar DE tools, and previously non-interoperable DE tools to interoperate freely.

Next, based on user input or desired user application 706, one or more model splices or wrappers 742, 744, and 746 may be generated, wrapping a subset or all of the model data needed for the user application with splice functions or API function scripts that can be applied to the original input model and/or wrapped model data to perform desired operations and complete user-requested tasks. In various embodiments, a model splice may take on the form of a digital file or a group of digital files, and a model splice may comprise locators to or copies of the aforementioned DE digital artifacts and splice functions, in any combination or permutation. Any number of model splices/wrappers may be generated by combining a selective portion of the model data such as 722 and the API function scripts such as 732. As the API function scripts provide unified and standardized input and output API endpoints for accessing and manipulating the DE model and DE model data, such API handles or endpoints may be used to execute the model splice and establish links with other model splices without directly calling upon native APIs. Such API endpoints may be formatted according to an input/output scheme tailored to the DE model file and/or DE tool being used, and may be accessed by orchestration scripts or platform applications that act on multiple DE models.

In some embodiments, when executed, an API function script inputs into or outputs from a DE model or DE model splice. “Input” splice functions or “input nodes” such as 733 are model modification scripts that allow updates or modifications to an input DE model. For example, a model update may comprise changes made via an input splice function to model parameters or configurations. “Output” splice functions or “output nodes” 734 are data/artifact extraction scripts that allow data extraction or derivation from a DE model via its model splice. An API function script may invoke native API function calls of native DE tools. An artifact is an execution result from an output API function script within a model splice. Multiple artifacts may be generated from a single DE model or DE model splice. Artifacts may be stored in access-restricted cloud storage 726, or other similar access-restricted customer buckets.

One advantage of model splicing is its inherent minimal privileged access control capabilities for zero-trust implementations of the IDEP as disclosed herein. In various deployment scenarios discussed with reference to FIG. 4, and within the context of IDEP implementation architecture discussed with reference to FIG. 3, original DE input model 704 and model data storage 726 may be located within customer buckets 312 in customer environment 310 of FIG. 3. Splice functions 732 stored in database 736 call upon native APIs 702. The execution or invocation of splice functions 732 may rely on job-specific authentication or authorization via proprietary licenses of DE tools (e.g., residing within customer environment 310 of FIG. 3 and/or information security clearance levels of the requesting user. Thus, model splicing unbundles monolithic access to digital model-type files as whole files and instead provides specific access to a subset of functions that allow limited, purposeful, and auditable interactions with subsets of the model-type files built from component parts or atomic units that assemble to parts.

### Digital Threading of DE Models via Model Splicing

FIG. 8 is a schematic showing digital threading of DE models via model splicing, according to some embodiments of the present invention. A digital thread is intended to connect two or more DE models for traceability across the systems engineering lifecycle, and collaboration and sharing among individuals performing DE tasks.

Linking of model splices generally refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first splice and a second splice (e.g., input splice functions from both model splices are called upon). In the present disclosure, “model linking” and “model splice linking” may be used interchangeably, as linked model splices map to correspondingly linked DE models. Similarly, linking of DE tools generally refers to jointly accessing two or more DE tools via model splices, where model splice functions that encapsulate disparate DE tool functions may interoperate and call each other, or be called upon jointly by an orchestration script to perform a DE task.

Thus, model splicing allows for making individual digital model files into model splices that can be autonomously and securely linked, enabling the management of a large number of digital models as a unified digital thread written in scripts. Within the IDEP as disclosed herein, a digital thread is a platform script that calls upon the platform API to facilitate, manage, or orchestrate a workflow through linked model splices. Model splice linking provides a communication framework or data-driven architecture that connects traditionally siloed elements to enable the flow of information between digital models via corresponding model splices. The extensibility of model splicing over many different types of digital models enables the scaling and generalization of digital threads to represent each and every stage of the DE lifecycle and to instantiate and update DTws as needed.

In the particular example shown in FIG. 8, an orchestration script 894 is written in Python code and designed to interact via API endpoints such as 892 to determine if a CAD model meets a total mass requirement. API endpoint 892 is an output splice function and part of a platform API 890. Platform API 890 comprises not only splice functions but also platform scripts or orchestration scripts such as 894 itself. Orchestration script 894 is divided into three main steps:
1. Get Data From a CAD Model Splice: A POST request may be sent via the IDEP platform API to execute a computer-aided design (CAD) model splice 871. This model splice provides a uniform interface to modify and retrieve information about a CAD model 881. The parameters for the CAD model, such as hole diameter, notch opening, flange thickness, etc., may be sent in the request and set via an input splice function. The total mass of the CAD model may be derived from model parameters and retrieved via an output splice function. The response from the platform API includes the total mass of CAD model 881, and a Uniform Resource Identifier/Locator (URL) for the CAD model. The response may further comprise a URL for an image of the CAD model.
2. Get Data From a SysML Model Splice: Another POST request may be sent via the IDEP platform API to execute a Systems Modeling Language (SysML) model splice 872. SysML is a general-purpose modeling language used for systems engineering. Output function 892 of model splice 872 retrieves the total mass requirements for the system from a SysML model 882. The response from the platform API includes the total mass requirement for the system.
3. Align the Variables and Check If Requirement Met: The total mass from CAD model 881 is compared with the total mass requirement from SysML model 882. If the two values are equal, a message is printed indicating that the CAD model aligns with the requirement. Otherwise, a message is printed indicating that the CAD model does not align with the requirement.

In short, orchestration script 894, which may be implemented in application plane 160 of IDEP 100 shown in FIG. 1, links digital models 881 and 882 via model splice API calls. Orchestration script 894 is a scripted platform application that modifies a CAD model, retrieves the total mass of the modified CAD model, retrieves the total mass requirement from a SysML model, and compares the two values to check if the CAD model meets the requirement. In some embodiments, a platform application within IDEP 100 utilizes sets of functions to act upon more than one DE model.

### Model Splice Plane

FIG. 9 is a schematic illustrating the linking of DE model splices in a splice plane and comparing digital threading with and without model splicing, according to some embodiments of the present invention. The bottom model plane 180 demonstrates current digital threading practices, where each small oval represents a DE model, and the linking between any two DE models, such as models 982 and 984, requires respective connections to a central platform 910, and potential additional linkages from every model to every other model. The central platform 910 comprises program code that is able to interpret and manipulate original DE models of distinct model types. For example, platform 910 under the control of a subject matter expert may prepare data from digital model 982 into formats that can be accessed by digital model 984 via digital model 984's native APIs, thus allowing modifications of digital model 982 to be propagated to digital model 984. Any feedback from digital model 984 to digital model 982 would require similar processing via platform 910 so that data from digital model 984 are converted into formats that can be accessed by digital model 982 via digital model 982's native APIs. This hub-and-spoke architecture 934 is not scalable to the sheer number (e.g., hundreds or thousands) of digital models involved within typical large-scale DE projects, as model updates and feedback are only possible through central platform 910.

In contrast, once the DE models are spliced, each original model is represented by a model splice comprising relevant model data, unified and standardized API endpoints for input/output, as shown in the upper splice plane 170. Splices within splice plane 170 may be connected through scripts (e.g., python scripts) that call upon API endpoints or API function scripts and may follow a DAG architecture, as described with reference to FIG. 1 and FIG. 6. Note that in FIG. 1, only the set of generated splices are shown within splice plane 170, while in FIG. 9, scripts that link model splices are also shown for illustrative purposes within the splice plane. Such scripts are referred to as orchestration scripts or platform scripts in this disclosure, as they orchestrate workflow through a digital thread built upon interconnected DE model splices. Further note that while splice plane 170 is shown in FIG. 1 as part of IDEP 100 for illustrative purposes, in some embodiments, splice plane 170 may be implemented behind a customer firewall and be part of an agent of the DE platform, as discussed in various deployment scenarios shown in FIG. 4. That is, individual API function scripts generated via model splicing by a DE platform agent may be tailored to call upon proprietary tools the customer has access to in its private environment. No centralized platform 910 with proprietary access to all native tools associated with all individual digital models shown in FIG. 9 is needed. Instead, orchestration scripts call upon platform API function scripts that may be implemented differently in different customer environments.

Hence, model splicing allows model splices such as model splice 972 from digital model 982 and model splice 974 from digital model 984 to access each other's data purposefully and directly, thus enabling the creation of a model-based “digital mesh” 944 via platform scripts and allowing autonomous linking without input from subject matter experts.

An added advantage of moving from the model plane 180 to the splice plane 170 is that the DE platform enables the creation of multiple splices per native model (e.g., see FIG. 7), each with different subsets of model data and API endpoints tailored to the splice's targeted use. For example, model splices may be used to generate multiple digital twins (DTws) that map a physical product or process or object design into the virtual space. Two-way data exchanges between a physical object and its digital object twin enable the testing, optimization, verification, and validation of the physical object in the virtual world, by choosing optimal digital model configuration and/or architecture combinations from parallel digital twins built upon model splices, each reacting potentially differently to the same feedback from the physical object.

Supported by model splicing, digital threading, and digital twining capabilities, the IDEP as disclosed herein connects DE models and DE tools to enable simple and secure collaboration on digital engineering data across engineering disciplines, tool vendors, networks, and model sources such as government agencies and institutions, special program offices, contractors, small businesses, Federally Funded Research and Development Centers (FFRDC), University Affiliated Research Centers (UARC), and the like. An application example 950 for the IDEP is shown on the right side of FIG. 9, illustrating how data from many different organizations may be integrated to enable cross-domain collaboration while maintaining data security, traceability, and auditability. Here DE models from multiple vendors or component constructors are spliced or wrapped by IDEP agents, and data artifacts are extracted with data protection. Turning DE models into data artifacts enables cross-domain data transfer and allows for the protection of critical information, so that model owners retain complete control over their DE models using their existing security and IT stack, continue to use DE tools that best fit their purposes, and also preserve the same modeling schema/ontology/profile that best fit their purposes. The IDEP turns DE models into micro-services to provide minimally privileged data bits that traverse to relevant stakeholders without the DE models ever leaving their home servers or being duplicated or surrogate. The IDEP also provides simple data access and digital threading options via secure web applications or secure APIs.

### DAG Representation of Threaded Tasks

Model splicing provides a unified interface among DE models, allowing model and system updates to be represented by interconnected and pipelined DE tasks. FIG. 10 shows an exemplary directed acyclic graph (DAG) representation 1000 of pipelined DE tasks related to digital threads, in accordance with some embodiments of the present invention. In diagram 1000, tasks performed through a digital thread orchestration script (e.g., 894) are structured as nodes within a DAG. Actions are therefore interconnected and carried out in a pipeline linking the DE model splices with a range of corresponding parameter values. Therefore, a digital thread can be created by establishing, via interpretable DE platform scripts, the right connections between any model splices for their corresponding models at the relevant endpoints.

Referring to FIGS. 1 and 8, DAGs of threaded tasks are built from digital threads and are part of the DE platform's application plane 160. Different DAGs may target different DE actions. For example, in FIG. 1, building or updating a DTw 122 in the virtual environment 120 has its own DAG 124. Model splicing turns DE models into data structures that can be accessed via API, thus enabling the use of software development tools, from simple python scripts to complex DAGs, in order to execute DE actions. A digital thread of model splices eliminates the scalability issue of digital thread management, and speeds up the digital design process, including design updates based on external feedback.

### Inner/Outer Loop Architecture for Digital Threads in Cyber-Physical Systems

FIG. 11 illustrates the interplay between a digital thread and the individual models or artifacts it uses, thus defining outer and inner loop processes, according to one embodiment of the present invention.

In various embodiments of the IDMP, the architecture for managing digital threads and their associated models in cyber-physical systems involves an interaction between the Outer Loop (representing the digital thread) and the Inner Loop (representing individual models or artifacts). This structure enables secure, permission-based collaboration across multiple models, ensuring traceability, controlled data flow, and efficient interaction within the digital workflow. Based on software engineering principles, this inner/outer loop design is modular: the Outer Loop manages high-level coordination and communication, while the Inner Loop handles the detailed, iterative operations of each model or system. While the Outer Loop and Inner Loop interactions commonly seen in software packages may involve access to all of the software packages within the same IDE, the Outer Loop/Inner Loop interactions for cyber-physical systems must manage to link interoperably with different digital models and tools, while also ensuring zero trust security. Various embodiments of the IDMP are well suited to manage such digital threads for cyber-physical systems as the platform is able to interoperably link with various digital models and tools (in different Inner Loops) through the model splicer architecture (see FIGS. 7 and 8). Additionally, the IDMP uses zero trust and zero knowledge security, ensuring that every interaction-whether within the same security network or across different networks—is strictly authorized, while keeping sensitive data private (e.g., through tokenization).

In the embodiment shown in 1102, the Outer Loop (1104) manages the sequence of tasks in a digital workflow, where user actions are authorized for access through 1120 in the Inner Loop (1116). The Outer Loop can issue instructions to the Inner Loop to:
Create models by defining structure, behavior, and parameters.
Fetch data artifacts from a model.
Update artifacts with controlled, traceable changes.

For example, when the Outer Loop commands a data artifact retrieval, the IDMP platform manages it using zero trust principles, as described in FIG. 3. Each user request in the Outer Loop is authorized through the enclave (302) and its Control Plane service cell, coordinated with the platform exclave (316). Different Inner Loops exist within Customer Tools (314), each operating in specific Customer Environments (310) where each request is authorized for access to the necessary data operations. After retrieving data artifacts from the Inner Loop, the Outer Loop handles configuration control (1106), versioning, and integrates the artifacts into the broader digital thread (1108) for testing or validation (1112).

The Inner Loop (1116), by contrast, is responsible for localized operations related to individual digital models, including:
Model creation, where digital models are initialized or updated.
Model execution, through automation, simulations or data analysis.
Saving results, preserving outcomes from model runs.
Analyzing data, providing insights and validation for digital workflow improvements.

The Outer Loop (1104) interacts with any step in the Inner Loop to access or update data artifacts. Outer loop computations often compare the current workflow to a baseline (1110).

The Outer and Inner Loops work together in an iterative process, integrating localized model adjustments with system-wide digital workflow coordination and validation. The Outer Loop manages tasks like configuration control, system integration, and VVUQ (Verification, Validation, and Uncertainty Quantification), while the Inner Loop handles model-based operations. FIG. 11 shows the Outer Loop performing authorized access (1120), configuration control (1106), digital thread integration (1108), and VVUQ/testing (1112). In various implementations of digital threads in the IDMP, these steps can vary in sequence or iterate as needed. Ultimately, the outer and inner loop architecture enables continuous integration and development (CI/CD) of digital workflows and digital threads across the digital platform.

### Decentralized Digital Threads in the IDMP

The IDMP enables decentralized management of digital threads across different models, security networks, and user permissions under a zero trust security principle. This architecture enforces strict access controls and permission-based interactions between models, ensuring security across diverse environments. In some embodiments, a zero knowledge approach further secures sensitive data during orchestration, ensuring no unauthorized access (e.g., by using tokenization).

In FIGS. 11, 1122 and 1132 show IDMP embodiments with decentralized digital threads across different security networks. In 1122, Outer Loop 1 operates within Security Network 1, connecting to multiple Inner Loops (e.g., Inner Loop 1, Inner Loop 2, and Inner Loop 3). These Inner Loops manage data operations within the same security framework, allowing collaboration while maintaining security.

In 1132, Outer Loop 2 operates in a separate Security Network 2, linking to additional Inner Loops (e.g., Inner Loop 4, Inner Loop 5, and Inner Loop 6). For links from Outer Loop 1, dotted lines and “X” symbols represent isolated models or components, indicating access restrictions enforced by the zero trust framework. Only authenticated users can access authorized models and artifacts.

In various implementations, 1122 and 1132 can be regarded as different instances of the Customer environment 310 shown in FIG. 3.

In the IDMP, digital threads handle both simple and complex model connections. FIG. 6 shows a simple thread with sequential model links (e.g., 602, 604), while FIG. 11, element 1142 shows a more complex digital thread, similar to the embodiment in 606. Simple threads propagate changes in a linear fashion, while complex threads manage branching dependencies, where changes in one model affect multiple downstream models. In complex threads implemented by the IDMP, the Outer Loop coordinates interactions across multiple Outer loops and Inner loops, ensuring secure, scalable execution of the entire digital workflow with appropriate permission controls.

Converting Digital Workflows into Digital Threads with Data Relationships

The IDMP links different types of digital model files in a decentralized fashion with zero-trust security. When a user requests a data operation on a digital model file using a specific DE tool, IDMP executes the request via tool-specific and platform agents within the customer's environment. These agents extract data artifacts and, when changes to a digital artifact occur, a newer version of the digital model file is made. During the versioning step, platform agents ensure sensitive data is protected through tokenized version control.

Extracted data artifacts are securely stored in the customer's cloud data storage (e.g., an S3 bucket). If changes are made to the digital model, the agents save the updated version of the model or data artifact, extract the relevant data artifacts, and store it securely.

Using the IDMP, users are able to link data artifacts into a magic doc for documentation and commentary, which can include AI-assistance in various embodiments. A digital thread accompanying the magic doc lists data artifacts in sequence, creating a digital workflow. The IDMP further tracks data relationships between data artifacts (e.g., derivation, grouping, or data flow). This digital workflow of user actions and data relationships is stored in a non-proprietary format within the customer's environment.

Emergent digital workflows and sequence of tasks captured by data relationships of various types:
1. Generational-(Between version 1 and version 2 of a model)
2. Parent/Child-(The Model and Derived information from a model)
3. Sibling-(Different bits of derived data from the same model (e.g., an image view of a CAD model and an associated parameter)
4. Generational (derived)—The same piece of data extracted from version 1 or version 2 of a model
5. Data Context (Connected by how they are used for a mission or business purpose in a Magic Doc)
6. Data Flow (Connected via digital threads-data from one model into another)

Such data relationships can vary from one user to another even for the same overall digital workflow task.

Converting Digital Workflows into Digital Thread Scripts in an API-First Manner

FIG. 12 illustrates an exemplary digital engineering process in the aerospace industry, showing outer loop processes, according to one embodiment of the present invention. The left of FIG. 12 contains a simplified depiction 1202 of current engineering processes related to a digital engineering operation in the aerospace industry. The digital platform is instrumental in mapping those processes 1204 to digitized (software-defined) workflows. Each process step may be connected to software-defined digital threads (outer loop) using Git Workbooks or Runbooks. The generated workflows may belong to the inner or outer loops, as depicted in FIG. 11. For completeness and compliance, the digital platform may further add tests for the key steps and tasks of the digitized workflows in the outer loop 1206. These outer-loop threads incorporate built-in feature tests and unit tests, ensuring the digital thread is validated as it is being created. Finally, the scripts for the digital threads are executed, generating outputs that can be presented as dynamic reports, such as magic docs, linked to digital models or data artifacts. The digital platform may hence generate dynamic reports 1208 (e.g., Magic Docs) linked to the inner-loop models used by the digital workflows. In various implementations, the IDMP adopts an API-first approach, where digital workflows are structured around secure and modular API integrations. In the IDMP, digital threads link to specific data artifacts through authorized API endpoints in a zero-trust framework, ensuring secure access. Process steps are connected to software-defined workflows using tools like Git Workbooks or Runbooks, with user intent driving both platform and tool-specific API calls. This approach enables seamless integration, modularity, and validation, with built-in feature and unit tests ensuring the reliability of each API interaction throughout the system.

### AI-Assisted Digital Engineering

The advent of model splicing as described below, and as further described in PCT applications No. PCT/US24/18278 (Docket No. IST-02.001PCT), No. PCT/US24/19297 (Docket No. IST-01.002PCT), No. PCT/US24/18278 (Docket No. IST-02.001PCT), and No. PCT/US24/27898 (Docket No. IST-03.001PCT), enables the scripting of DE model operations encompassing disparate DE tools into a corpus of normative program code. As a consequence, a large space of DE activities can be threaded into program code, including DE model generation, model modification, model data sharing, DE thread generation, thread modification, thread data extraction, thread data sharing, digital twin generation, digital twin modification, digital twin data extraction, digital twin sharing, etc. In turn, the transformation of DE operations into code enables the generation and training of AI modules for the purpose of manipulating digital engineering models, digital threads, and digital twins.

An Artificial Intelligence (AI)-assisted approach to the creation, manipulation, linking, sharing, and modification of the data encompassed within digital engineering model files may therefore utilize a combination of machine learning (ML) techniques to create scripts that analyze and extract relevant information, implement appropriate operations, functions and parameters, control digital engineering tools, and implement the optimal sequence of steps for creating or modifying a digital twin, a digital thread, or an underlying digital engineering model file. This allows for programmable, machine-learnable, and dynamic changes to the model files, and ultimately to the digital or physical twin, throughout the product lifecycle.

The ML engine(s) may be trained on a dataset of user inputs and example model splicer, digital thread, and digital twin creation or manipulation scripts, allowing for greater customization and flexibility. This approach may be further enhanced by the use of fine-tuned transformers and language models, which are better suited to capture the specific language and context of the target model files. Moreover, the generation and use of customer data sovereignty-preserving embeddings is expected to ensure customer data sovereignty. Additional measures are described below to improve AI model performance.

The methods and systems described herein enable AI-assisted cross-tool scripting of any DE operation for the creation and manipulation of digital engineering model files, digital threads, and digital twins, thus leading to dramatic reductions in cost and delays throughout all phases of any digitally engineered product's lifecycle.

### Cross-Tool Simulation Example

The methods and systems disclosed herein include an improved method for efficiently generating, revising, and evaluating CAD models within a simulation environment. FIGS. 19-22 from PCT application No. PCT/US24/27898 (Docket No. IST-03.001PCT) show how an illustrative example of evaluating CAD models within a simulation environment can be enhanced through the IDEP. FIGS. 19-22 from PCT application No. PCT/US24/27898 and their descriptions are incorporated by reference in their entirety herein.

In particular, elements from FIGS. 19-22 from PCT application No. PCT/US24/27898 are reproduced as FIG. 13 in this disclosure, and show the example of evaluating CAD models within a simulation environment, further enhanced through AI-enabled processes over the IDEP, in accordance with the examples disclosed herein. FIG. 13 illustrates AI-assistance in orchestration of a digital thread featuring CAD modeling, meshing, CFD/FEA simulations and cost modeling.

In one embodiment, the user (1320) generating the DE prompt is the SME, and the DE prompt is converted into a set of orchestration instructions aimed at carrying out a simulation task by a context AI model (not shown in FIG. 13-see PCT application No. PCT/US24/38878 (Docket No. IST-03.002PCT)). The AI model (1314) responsible for generating the orchestration script (1330) from the orchestration instructions is a syntax AI model (see PCT application No. PCT/US24/38878 (Docket No. IST-03.002PCT)). The generated orchestration script (1330), then executed over the IDEP, includes DAG-organized (1334) API scripts (1336) aimed at the DE task of accessing and/or executing a set of DE model files (1302-1312) in order to carry out the simulation task. At various steps of the orchestration script, various API script calls activate the AI-enabled model splicing modules (1340-1350) required to access or execute the relevant DE model files (1302-1312). The orchestration script (1330) includes program code to collect the output simulation performance data and to generate a report (1332) such as a simulation performance report, or a magic doc. The report or magic doc (1332) is then made available to the user (1320).

Individual process steps such as API script calls and report generation may be carried out in a distributed and modular fashion, via a microservice architecture. In such a microservice architecture, the orchestration script (1330) includes program and function calls to multiple microservice modules, and receives specifically-formatted microservice outputs to be included in the output report or magic doc (1332).

The use of model splicing and orchestration scripts facilitates adaptability and flexibility in the CAD model analysis and revision processes. In addition, the methods described herein enable a more scalable and comprehensive workflow for analyzing and refining CAD models across various tools.

### Graphical User Interface (GUI) for Operating a Digital Thread

FIG. 14 shows a screenshot of an exemplary graphical user interface (GUI) used to operate a digital thread over the IDMP, according to one embodiment of the present invention.

The GUI provides the user of the interconnected digital engineering platform (IDEP) with the digital thread creation capabilities described herein. FIG. 14 shows a browser window header 1402 which includes a digital thread link for easy navigation. Below the header, a domain and security access level banner 1404 displays the domain, platform software version, and security access level, ensuring that users are aware of the domain they are operating in and the security protocols in place. The security access level indicator 1406 displays the user's maximum security access level within the platform (e.g., “Level 1”).

The interface also includes a search bar 1412, allowing the user to carry out comprehensive cross-platform searches through the IDEP for digital engineering models, files, digital threads and documents, thus facilitating efficient retrieval of information across the platform. Adjacent to this, the user & domain field 1410 provides information on the user's domain (e.g., client name). The user and domain field may allow the user to login and to access user profile and subscription information.

The top menu of the GUI offers additional functionalities. For example, the digital thread name field 1420 displays the digital thread's name, and may include its version. The digital thread security access level indicator 1422 displays the security access level (e.g., “Level 1”) of the digital thread being accessed. In one embodiment, using an expandable security access level menu adjacent to the digital thread security access level indicator 1422, the user may select the digital thread's target security access level “view”, thus filtering only the parts of the digital thread accessible through a given security access level. In other embodiments, the user may also use the digital thread security access level indicator 1422 to down-select the security access level while sharing the digital thread or an associated magic document for the digital thread, thus sharing portions of the digital thread that correspond to the specified security access level. Only security access levels below the user's security access level (e.g., “Level 1” in FIG. 14) would be available for the user to view and share. The user interface buttons 1424 include options to copy the digital thread link, open a comment section, access digital thread information, manage sharing access, and export the digital thread.

In some embodiments, the granular dynamic info security tags (e.g., 1406 and 1422, and the like) are an important element of the digital thread and magic doc system, as well as its associated GUI. The model splicer and the IDEP system enable the granular dynamic information security tags 1406 and 1422. In various embodiments, the digital thread system in the IDEP uses metadata of DE models or documents to cross-reference against authorizations, licenses, or regulations to update. In some embodiments, the granular dynamic information security tags 1406 and 1422 are dynamic, and are refreshed ahead of any digital thread updates to confirm the right authenticated user has the right authorized access to the digital artifacts and data to perform or view the updates.

As discussed above, digital threads are a set of orchestration scripts to orchestrate the selective exchange of data among documents and DE model files. Digital threads therefore link all the resources relevant to accomplishing a given DE task, including the various sections of an orchestration script, the relevant DE models, as well as relevant context information and metadata.

For a secure digital thread organization and navigation, the illustrative GUI of FIG. 14 features a digital thread outline viewer 1430 on the left of FIG. 14, providing links to the digital thread's individual sections, including code blocks that may carry out individual subtasks within the orchestration script, text blocks that may provide contextual, parametric, requirement-related, and/or certification-related information on linked DE models. Text blocks may also include text paragraphs and/or orchestration code comments and data sources. Within the digital thread outline viewer 1430, a digital thread detailed viewer 1432 shows sections of the secure digital thread along with the linked digital engineering (DE) model(s), the associated magic documents, the source IT domain, and the last update timestamp, each tagged with the appropriate information security access level (e.g., “Ll” or “Level 1”). In some embodiments, the information security tag on a code block indicates a restriction on executing the code block. That is, a code block may only be run by an user entity with an equal or higher information security access level. In some embodiments, the information security tag may indicate a viewing privilege, so the code block is only presented and viewable by an user entity with an equal or higher information security access level.

In some embodiments, if sections of a secure digital thread contain content requiring a higher security access level for viewing, the user may be presented with an option to request access. Were the user to request such access, an authorized user with access at a higher security access level is notified for their review. In other embodiments, if sections of a digital thread contain content requiring a higher security access level for viewing, such sections will not be shown for display, nor will the user be provided with any prompt for requesting access.

At the center of FIG. 14, the section viewer 1440 displays the content of each secure digital thread section and ensures that every orchestration script code, code comment, and text block is updated based on the data of the DE models that are linked to it. The model data and associated security access may be provided through model splicing, as discussed previously.

On the right of FIG. 14, a graph view pane 1450 exhibits the digital thread in graph format. In some embodiments, partial and full graph views may be selected by the user using a graph view pane menu button 1450. The graph view pane 1450 may show the current user view of the digital thread in a graph format, including the visible workflow tasks that are part of the digital thread 1454, and the connections between the workflow tasks 1456. In the embodiment of FIG. 14, each workflow node exhibits a workflow task and the security access level associated with it. In some embodiments, the user may select a workflow task to view the code and/or text blocks associated with it. In some embodiments, the user may select a workflow connection to view the data elements (e.g., digital artifacts) flowing from one workflow task to another. In one embodiment, a graph optimization tool may be launched 1452 from this pane, enabling one or more graph optimization tools, as disclosed herein.

Optimizing a Digital Workflow within a Digital Platform

FIG. 15 shows an exemplary flow chart for optimizing a digital workflow within a digital platform, in accordance with some embodiments of the present invention. At step 1510, a user request is received from a user related to the digital workflow in the digital platform. At step 1520, a decentralized digital thread associated with the digital workflow is generated based on the user request, where the decentralized digital thread provides access to at least two different digital artifacts from two or more distinct security networks and/or from two or more distinct software tools. At step 1530, a workflow data structure is generated based on the decentralized digital thread, where the workflow data structure comprises one or more workflow nodes representing one or more workflow tasks, and one or more workflow connections representing data flow required by the one or more workflow tasks. At step 1540, a workflow cost associated with executing the one or more workflow tasks in the workflow data structure is calculated.

At step 1550, at least one modification to the workflow data structure is identified by processing the workflow data structure, where the at least one modification to the workflow data structure reduces the workflow cost. In one embodiment, the cost-reducing modification is identified through user feedback. In such an embodiment, the digital platform may provide a visual representation of the updated workflow data structure to the user and receive feedback data from the user to update the workflow data structure. In one embodiment, a diagramming and charting tool such as Mermaid (available at mermaid.js.org) may be used to visualize the workflow data structures, enabling the user to provide feedback. In another embodiment, a graph optimization algorithm such as minimum spanning tree (MST) may be used to identify the cost-reducing modification to the workflow data structure. In yet another embodiment, a workflow optimization machine learning model, or a prediction machine learning model, may be used, as discussed in FIG. 16.

At step 1560, an updated workflow data structure is generated based on the workflow data structure and the at least one modification. Finally, at step 1570, an updated decentralized digital thread is generated based on the updated workflow data structure.

### Workflow Data Structure

FIG. 10 illustrates the representation of a digital thread as a DAG of connected digital tasks. More generally, a digital thread carrying out a set of tasks corresponds to a digital workflow. Therefore, the digital thread may be mapped to a workflow data structure over a digital platform, where the workflow data structure may include a set of connected nodes. As discussed in the context of FIG. 10, the workflow data structure may be a graph or a DAG. In the workflow data structure, the nodes may represent the workflow tasks, and the connections may represent the data flowing from one task to another. Alternatively, the workflow nodes may represent data (e.g., digital artifacts or models), and the connections may represent tasks transforming the data represented by the nodes. The described task-node and data-node representations of a workflow data structure may be considered as dual representations. In both representations, a cost may be associated with each task and each inter-task data flow based on a cost function, and the summation of such costs over a selected subset of nodes and connections of a workflow data structure yields the cost of the selected partial workflow data structure (i.e., the partial “workflow cost”). A similar principle may be applied to a weight or to any performance metric, whereby a value applies to each node and/or connection, and the summation of such values yields a total for the workflow.

### Workflow Hierarchy

In some embodiments, the generated workflow data structure may represent the entirety of the decentralized digital thread. In other embodiments, the generated workflow data structure may represent a portion of the decentralized digital thread. In one embodiment, a partial workflow data structure is selected by a user for optimization using a graphical user interface (GUI), as illustrated in FIG. 14. Therefore, in various embodiments, multiple alternative workflows may be selected by the user for optimization.

In some embodiments, the digital platform is configured to generate, modify, and execute a hierarchy of digital threads, whereby a digital thread may include instructions for carrying out one or more underlying digital threads. Similarly, the digital platform is configured to generate, modify, and execute a hierarchy of digital workflows, whereby a digital workflow may include instructions for carrying out one or more underlying digital workflows. Consequently, the individual workflow nodes may represent more than one task.

In various embodiments, an individual workflow node may encompass an entire nested workflow. In one embodiment, the workflow cost of a given workflow node corresponds to the cost of all workflows nested within the given workflow node. In one embodiment, the digital platform may enable a user to optimize a single workflow layer. In another embodiment, the digital platform may enable the user to optimize more than one workflow layer. In yet another embodiment, the digital platform may enable the user to optimize a workflow recursively, thus implying the optimization of all underlying workflows.

### Cost Functions

In one embodiment, a digital thread implemented on an Integrated Digital Model Platform (IDMP) is represented as a directed acyclic graph (DAG), wherein nodes represent various actions performed, and edges represent the exchange of data artifacts between process steps-such that the output of one node serves as the input to another. In alternative embodiments, nodes may represent individual data artifacts themselves, reflecting parent-child relationships or source-to-current artifact relationships, thereby encompassing the extraction of information from one node to the next. Although the actions performed along the edges may not be explicitly revealed, there is time and effort required to implement the actions associated with these edges.

These parameters may be presented to the user through exemplary visualizations of individual steps within the digital thread, as depicted in FIGS. 12, 14, 22, and 23.

During the execution of digital threads corresponding to complex digital workflows on the IDMP, various cost functions may be aggregated to provide a comprehensive understanding of the total operational expenses. Exemplary cost functions include:
an API Call Cost Function, which calculates costs based on the number of API calls made during execution;
a Bandwidth Cost Function, which determines expenses arising from network bandwidth usage and data transferred across network boundaries; and
a License Cost Function, which computes software licensing fees on a fractional basis assigned to each node based on usage.

Additional cost functions contributing to the overall cost aggregation may include:
a Compute Resource Cost Function, accounting for computational resources such as CPU and GPU time utilized;
a Data Storage Cost Function, considering costs associated with storing data artifacts across the digital thread;
a Data Transfer Cost Function, computing expenses for data movement between nodes or networks;
a Security and Compliance Cost Function, encompassing costs related to implementing security measures and ensuring regulatory compliance; and
a Human Resource Cost Function, calculating expenses associated with human intervention or manual processing steps.

By aggregating these diverse cost functions, an organization can gain valuable insights into the total cost of executing digital threads, thereby enabling improved budgeting, optimization, and strategic decision-making in complex digital workflows.

For example, costs may be incurred per API call, bandwidth costs may be apportioned according to execution time, or license costs may be provided on a fractional basis and assigned back at each step. When an action is performed at a given node of a workflow DAG, the user may be presented with cost details pertaining to that particular node. In an exemplary two-node workflow, two users may make distinct choices: one opting for free, open-source APIs with local compute resources, while the other chooses premium APIs, commercial software tools, and cloud compute resources. In some embodiments, the platform may use a token-based system to manage and aggregate the total effort based on these choices. Platform-specific tokens are assigned at each task level, representing effort, and these tokens may map to license costs, track workloads across agents, or API calls, and are fungible within the workflow. This token-based system may serve as a simple proxy for monetary costs, avoided effort, or even avoided carbon emissions, offering users a flexible and efficient way to manage resources and workflow decisions. Aggregated cost functions can then be evaluated for the execution of the entire digital thread or its various individual components.

Furthermore, two users implementing the same digital workflow on the IDMP may have different cost functions and total operational costs due to variations in their chosen implementations of the digital thread. These differences can arise from the selection of different tools, services, or configurations at each node or edge within the digital thread. For instance, one user may opt for premium APIs, licensed software, or high-performance computational resources, incurring higher costs but potentially achieving faster execution times or enhanced capabilities. In contrast, another user may utilize open-source tools, free APIs, or local computational resources, resulting in lower costs but possibly longer execution times or reduced functionality. Consequently, even when executing the same underlying workflow, the aggregated cost functions and total costs may vary significantly between users based on their individual choices and resource allocations within the digital thread.

### Zero-Knowledge Enabled Digital Threads, Workflows, and Datasets

In one embodiment, a zero-knowledge (ZK) architecture for the IDMP is implemented where the IDMP's Software Development Kit (SDK) prevents any customer data that is deemed sensitive to be sent through an IDMP API. This ZK objective is achieved through a process of cryptographic tokenization. Cryptographic tokenization identifies sensitive data (e.g., through customer input) and maps each sensitive data element (e.g., digital model, digital artifact, document) with a cryptographic token and a cryptographic identifier. Each cryptographic token includes metadata describing the data element. In cryptographic tokenization, metadata from the cryptographic tokens, rather than the data elements themselves, are used to train the workflow optimization ML models, the workflow prediction ML models, or the syntax AI models (see PCT application No. PCT/US24/38878 (Docket No. IST-03.002PCT)). A workflow dataset, prediction dataset, or syntax AI model training data set may hence include a customer data sovereignty-preserving training data set that consists of sample contextual data associated with sample digital tasks, and corresponding sample template scripts. The generation of each sample template script includes the steps of receiving an orchestration script implementing an associated digital task, identifying sensitive data elements within the orchestration script, and replacing each sensitive data element with its mapped metadata.

Cryptographic tokenization replaces sensitive data with the cryptographic identifier when a data element is to be used outside the customer environment, and exchanges the cryptographic token back for the mapped data elements for use within the customer environment, in a process step called cryptographic de-tokenization. The ZK architecture hence stores the sensitive data elements within the customer's environment (e.g., on the customer's network).

Parameter substitution is a further component of the ZK architecture. Specifically, the parameter substitution process contributes to the ZK architecture by mapping generic parameter names or generic API function details (e.g., function names, inputs, outputs) to specific software tool resources or software tool functions within a customer environment. Consequently, the orchestration scripts generated by the syntax AI model support the ZK architecture by requiring an explicit parameter substitution step within the customer environment. Similarly, the workflows generated by a workflow optimization ML model and/or the predicted workflow elements generated by a workflow prediction ML model support the ZK architecture by requiring an explicit parameter substitution step within the customer environment.

Hence, a ZK-enabled digital thread is a digital thread using metadata from a cryptographic token generated from a data element, such as a digital artifact, or that uses a data element that requires parameter substitution. Similarly, a ZK-enabled digital workflow is a digital workflow having at least one edge and/or node that uses metadata from a cryptographic token generated from a data element, such as a digital artifact, or including a data element that requires parameter substitution. Moreover, a ZK-enabled data set is a data set that uses metadata from a cryptographic token generated from a data element, such as a digital artifact, or including a data element that requires parameter substitution. Consequently, a ZK-enabled ML/AI model is a ML/AI model trained using at least one ZK-enabled dataset.

### AI-Enabled Embodiments

FIG. 16 shows an alternative exemplary flow chart for optimizing a digital workflow within a digital platform, in accordance with some embodiments of the present invention. At step 1610, a user request is received from a user related to the digital workflow in the digital platform. At step 1620, a decentralized digital thread associated with the digital workflow is generated based on the user request, where the decentralized digital thread provides access to at least two different digital artifacts from two or more distinct security networks and/or from two or more distinct software tools. At step 1630, a workflow data structure based on the decentralized digital thread is generated, where the workflow data structure includes one or more workflow nodes representing one or more workflow tasks, and one or more workflow connections representing data flow required by the one or more workflow tasks. At step 1640, an updated workflow data structure is generated based on the workflow data structure using a workflow optimization machine learning (ML) model trained using a workflow dataset of the digital platform. The workflow dataset may include a plurality of sample workflow data structures and a plurality of corresponding modified sample workflow data structures, where a workflow cost of a given sample workflow data structure of the workflow dataset is higher that a modified workflow cost of a given corresponding modified sample workflow data structure. The workflow cost of the given sample workflow data structure may be associated with executing one or more given workflow tasks of the given sample workflow data structure. Finally, at step 1650, an updated decentralized digital thread is generated based on the updated workflow data structure.

In one alternative embodiment, after the workflow data structure is generated at step 1630, a predicted data structure element is predicted at step 1660, using a workflow prediction machine learning (ML) model trained using a prediction dataset of the digital platform. The prediction dataset may include two or more sample workflow data structures and two or more corresponding predicted data structure elements, and the predicted data structure element may include at least one of a workflow node and a workflow connection. In this embodiment, at step 1670, an updated workflow data structure including the predicted data structure element is generated based on the workflow data structure. Finally, at step 1650, an updated decentralized digital thread is generated based on the updated workflow data structure.

### System Embodiments

FIG. 17 shows an exemplary system illustrating the generation of a sharable script and the optimization of a digital workflow using a machine learning (ML) engine 1730, in accordance with some embodiments of the present invention.

### Machine Learning (MI) Generated Sharable Script

A non-transitory physical storage medium 1790 is provided to store program code 1792, the program code executable by a hardware processor 1795 to cause the hardware processor to execute computer-implemented processes, including embedding generation, template selection, or generating a sharable script 1770 for an input digital model file 1710 to complete a user-requested digital task 1706.

In some embodiments, program code 1792 comprises code to receive a digital model file 1710 of an input digital model, in a source file format (e.g., in a native document file format such as.dwg). In some embodiments, digital model file 1710 may be received from a user 1702 through a user interface (UI) 1704. User 1702 may be a human or a computing entity, and UI 1704 may be a graphical UI (GUI), a code interface such as an API/SDK interface, or a multimodal interface as discussed with reference to FIG. 5. For example, user 1702 may represent an artificial intelligence (AI) module that intends to complete a digital task of linking a first digital model (e.g., a CAD model) to a second digital model (e.g., a document) to, by running a digital thread, update the second digital model with data extracted from the first digital model. User 1702 may provide an input 1706 that describes or is indicative of the desired digital task. Another example of user input 1706 may be a request for specific document artifacts that can be retrieved via splice functions on the input digital model file 1710. In some embodiments, digital model file 1710 may be received directly from a data source, for example, retrieved from an internal database, a cloud-based storage service, or the world wide web.

A model analysis engine 1732 then analyzes input digital model file 1710 to extract characteristic digital model attributes 1740 that may be stored in a data storage area 1733, which may be access-restricted, cloud-based, or may be located in customer buckets within customer environments for a zero-trust implementation. In some embodiments, model analysis engine 1732 may comprise a crawler or parser script that calls upon native functions of native digital tools associated with input file 1710 to parse the input digital model in detail to extract component data, identify metadata associated with the model file and/or component data, and generate a list of components. In some embodiments, model analysis engine 1732 may generate derivative data from the extracted model data, with or without AI-assistance. When a derivative datum is generated and stored in storage 1733, associated metadata may be stored as well, for example, to identify a time of the derivation, code used for the derivation, user authorizing the derivation, and/or a version of the input digital model file at the time of the derivation. Such metadata may be crucial in applications that require near-instantaneous auditability and clear traceability to original sources of truth.

In some embodiments, an embedding generator 1734 within a template engine 1736 generates embedding vectors in a joint vector space. Template vector embeddings may be stored in a vector database 1735. In various embodiments of the ML engine 1730, template engine 1736 may utilize various data artifacts within the platform to create a joint embedding space and suggest templates as described below in more detail.

Once a template is suggested by template engine 1736, a script generator 1737 may build a digital thread orchestration script 1770 from a template suggested by template engine 1736. In some embodiments, script generator 1737 may interact with user 1702 to receive user feedback on the selected template and on the script generation process. Note that a splice function may be viewed as a degenerate digital thread (e.g., 607 in FIG. 6) that retrieves a digital artifact from a digital model. Digital thread orchestration script 1770 may be interpreted and executed as an IDMP application 1780, and may be shared with another user.

While model analysis engine 1732, database 1733, template engine 1736, and script generator 1737 are shown as separate modules within FIG. 17, in various embodiments of the present invention, these modules may be integrated in any combination to facilitate seamless data exchange and functional collaboration to optimize the overall performance of the ML engine 1730. In some embodiments, parts of ML engine 1730 may be implemented within a customer environment behind a customer firewall and be managed by an IDMP agent, so that customer data within storage 1733 is fully protected under a zero trust setting. Template vector database 1735, which may be desensitized from specific customer data, may be provided by the IDMP and accessed via the IDMP agent. In some implementations, as users interact with these suggested templates, their feedback provided through 1706 is collected and used to further refine the ML engine, continuously improving the accuracy and relevance of future template suggestions.

### An Exemplary Template Engine Implementation

In various embodiments, template engine 1736 may be implemented using a number of techniques, including but not limited to, retrieval-augmented generation (RAG) architecture, low-rank adaptation of LLMs (LoRA), graph transformers, and reinforcement learning. In one example, the following steps may be carried out by the template engine.

First, template engine 1736 may ingest a variety of input data types integral to its operation within the IDMP. This data may include, but is not limited to, graph data, image data, and text data. Graph data encompasses representations of functions executed on the IDMP, exemplified by magic documents and digital threads, where each function constitutes a node in the graph. Additionally, model data such as CAD models, simulation results (spanning electrical, mechanical, thermodynamic, and fluid domains), electrical circuit models, and mechanical models are incorporated. This diverse set of inputs ensures comprehensive coverage and applicability of the template engine across multiple domains and use cases.

Next, embeddings for different data types may be generated by embedding generator 1734. For graph data, an autoencoder may be employed, utilizing an adjacency matrix for edge connections and a node feature matrix to produce a lower-dimensional representation of the graph. An autoencoder is a type of artificial neural network architecture used for unsupervised learning and dimensionality reduction. An autoencoder typically consists of an encoder network that compresses the input data into a lower-dimensional representation, and a decoder network that attempts to reconstruct the original input from this compressed representation. Features learned in this process by the autoencoder can serve in other ML tasks such as constructing one or more templates. As autoencoders are trained to reconstruct their input data, they effectively use the input as both the features and the target output, thus can be considered as performing unsupervised or self-supervised learning. This autoencoder architecture for graph data embedding, through a constricting layer, derives the embedding vectors by minimizing reconstruction loss, typically using a mean square error loss function. To avoid overgeneralization and high training costs, separate autoencoders may be used for distinct graph classes. On the other hand, image data embeddings may be generated using pre-existing encoder models suited for image processing. Similarly, text data embeddings may leverage established encoders like BERT (Bidirectional Encoder Representations from Transformers) and Word2Vec, facilitating the integration of textual information into the system.

Template engine 1736 may further create the joint embedding space to enable the integration and processing of diverse data types autonomously. This joint embedding space functions as a common language, allowing the ML engine 1730 to relate and interpret different data classes without manual labeling or classification. Aligning embeddings from various encoders into this joint space can be achieved through methods such as concatenation and projection, bilinear transformations, and attention mechanisms. Concatenation and projection involve combining embeddings from different modalities and projecting them into a unified space via a neural network. Bilinear transformations offer another technique for embedding alignment, while attention mechanisms dynamically weigh and merge embeddings, enhancing the model's focus on relevant features. This joint embedding space enables the template engine 1736 to predict graph representations of workflows based on user input effectively, as discussed in detail with reference to FIG. 17 in PCT application No. PCT/US24/40624 (Docket No. IST-03.003PCT), and in turn suggest templates for script generation by script generator module 1737.

### A Graph Transformer Network for the Template Engine

Thus, the template engine seeks to represent disparate data sources in a common lingua franca to enable similarity search between different data sources. It consists of a set of encoder models, each designed to handle a specific type of data, such as graph data, image data, and text data. Graph data is a special subset within the IDMP, representing digital threads involving different types of digital models and digital artifacts in different formats. In one perspective, graph data may overlap with other data modalities; for example, edge connections may be stored in text or numerical formats, and function nodes may be associated with digital artifacts of various formats.

A Graph Transformer Network (GTN) may be utilized as an encoder model to generate embeddings for graph data. However, the joint embedding space created by the template engine 1736 may be broader and more generic than that by a GTN. This joint embedding space serves as a comprehensive framework to reason about all types of engineering models and data within the IDMP Platform, integrating various encoder models to establish a unified representation.

### Workflow Optimization

In one embodiment, FIG. 17 illustrates an exemplary system for optimizing a digital workflow over a digital platform. In that embodiment, the non-transitory storage medium 1790 stores program code 1792 executable by a hardware processor 1795 for optimizing a digital workflow within a digital platform.

The program code 1792 may include instructions to receive a user request 1706 from a user 1702 related to the digital workflow in the digital platform. The program code 1792 may also include instructions to generate a decentralized digital thread 1770 associated with the digital workflow based on the user request 1706, wherein the decentralized digital thread 1770 provides access to at least two different digital artifacts from two or more distinct security networks and/or from two or more distinct software tools. In FIG. 17, each of the two digital artifacts may be extracted from a digital model file 1710 through the aforementioned steps.

The program code 1792 may also include instructions to generate a workflow data structure (e.g., 1772) based on the decentralized digital thread. The workflow data structure (e.g., 1772) may include one or more workflow nodes representing one or more workflow tasks, and one or more workflow connections representing data flow required by the one or more workflow tasks.

In FIG. 17, the script generator 1737 may use a workflow optimization machine learning (ML) model. The program code 1792 may thus include instructions to generate an updated workflow data structure based on the workflow data structure (e.g., 1772) using a workflow optimization machine learning (ML) model. The workflow optimization machine learning (ML) model may be trained using a workflow dataset 1742 of the digital platform located within the access-restricted storage 1733. The workflow dataset 1742 may include a plurality of sample workflow data structures and a plurality of corresponding modified sample workflow data structures. Each unmodified workflow data structure of the workflow dataset 1742 may be characterized by a workflow cost that is higher than its corresponding modified workflow data structure, thus enabling the workflow optimization machine learning (ML) model to learn workflow cost reduction, where the workflow cost of a given workflow data structure is associated with executing one or more workflow tasks of the given workflow data structure.

The program code 1792 may also include instructions to generate an updated decentralized digital thread based on the updated workflow data structure.

In another embodiment, the script generator 1737 may use a workflow prediction machine learning (ML) model to predict a predicted data structure element of the workflow data structure. The workflow prediction machine learning (ML) model may be trained using a prediction dataset 1744 of the digital platform located within the access-restricted storage 1733. The prediction dataset 1744 may include a plurality of sample workflow data structures and a plurality of corresponding predicted data structure elements. The predicted data structure element may include at least one of a workflow node and a workflow connection, and the updated workflow data structure may include the predicted data structure element.

In one embodiment, at least one workflow of the workflow dataset 1742 may be derived from one or more sample user actions stored by the digital platform in a user action database 1746 of the digital platform. Similarly, in another embodiment, at least one predicted data structure element of the prediction dataset 1744 may be derived from one or more sample user actions stored by the digital platform in a user action database 1746 of the digital platform.

Finally, the program code 1792 may also include instructions to provide a visual representation of the updated workflow data structure to the user 1702 (e.g., through the user interface 1704), receive feedback data from the user, and further update the workflow data structure based on the feedback data.

### DE Model Splicing and Document Splicing

A DE model type-specific model splicer stores model data extracted from a DE model file in a model type-specific data structure. A DE model splicer further generates Application Programming Interface (API) function scripts that can be applied to the DE model data. A DE “model splice” or “wrapper” for a given user application can be generated by wrapping DE model data and API function scripts that are specific to the user application, thus allowing only access to and enabling modifications of limited portions of the original engineering model file for collaboration and sharing with stakeholders of the given user application.

Similarly, a document splicer is a document-specific model splicer, where the input model is a human-readable document. A “document” refers to a piece of text or graphics that is directly readable by a human without the need of additional machine compilation, rendering, visualization, or interpretation. A “document splice”, “document model splice” or “document wrapper” for a given user application can be generated by wrapping document data and API function scripts that are specific to the user application, thus revealing text at the component (e.g., paragraph) level via API endpoints, and allowing access to and enabling modifications of portions of an original document or document template for collaboration and sharing with stakeholders of the given user application, while minimizing manual referencing and human errors.

In this disclosure, the term “model splicer” refers to a software module or collection of templates that can be used to generate DE model or document model splices/wrappers. “Model splicer generation” refers to the process of setting up a model splicer, or establishing an all-encompassing framework or template, from which individual model splices can be deduced. Furthermore, the terms “model splice,” “model wrapper,” “splice node,” “splicer node,” and “wrapper node” may be used interchangeably to represent a DE model or document model splicing result.

A model splice or wrapper makes available a subset of a model file through a set of API endpoints. “API endpoints” generated via splicing provide access for inputs and/or outputs to one or more API scripts encapsulated in the model splice. Corresponding API endpoints can be linked between different DE model splices and document splices, wherein output from a preceding model splice may be provided as inputs to a subsequent model splice, allowing for information flow, thus creating a digital thread to propagate requirement and/or design changes throughout a complex engineering system, and to enable seamless collaboration and sharing among individuals performing digital engineering tasks.

### Model Splice and Document Splice Linking

Once spliced, a document may be linked to other document splices and/or DE model splices via API endpoints, enabling the propagation of model data from one model splice to a document splice. “Linking”, “connecting”, or “combining” two splices refers to jointly accessing constituting splices via API endpoints. For example, data may be retrieved from one splice to update another splice (e.g., one splice as data source and one splice as data sink); data may be retrieved from both splices to generate new output (e.g., both splices as data sources); data from a third splice may be used to update both a first and a second splice (e.g., both splices as data sinks). Granular linking at the document component (e.g., paragraph) level further makes live updates more computationally efficient, aids in the prefiltering of document components for use in DE review, and enables the aggregation and summarization of model data independently of the native DE tool or development platform used to generate the input DE model. Similarly, document components may be linked for propagating a model update throughout a document, at multiple positions within the document. Comments may be implemented as an action that can be performed on a wrapper. For example, API functions may be implemented to add comments, remove comments, or return a list of comments in the wrapper, by date, by reviewer, or by status, etc. Comments by individual reviewers of a document may be separately spliced/wrapped to have API endpoints that are linked with specific document splices.

### DE Model-to-Document Linking for Data Update and Parameter Substitution

FIG. 18 shows exemplary setups for digital model splice and document splice linking, illustrating exemplary digital workflows, according to some embodiments of the present invention.

Workflow 1810 is a visual representation of a process flow to generate an expense report from a template. Here an expense report in Excel is spliced and linked/combined with an expense report template splice to generate an expense report splice with associated API endpoints and scripts. The scripts may be written as python code that uses API scripts from the Excel model and document splices.

In workflow 1820, an input DE model (e.g., CAD model for airplane wing design) is spliced and linked to a design report template splice, to generate a wing design report splice with additional API endpoints and scripts written in Python for further access and handling of the wing design report data.

In workflow 1830, multiple DE models are spliced and linked with a single document template. In setup 1840, multiple DE models and multiple document templates are spliced and used to generate multiple output document splices with associated API endpoints and scripts. The examples shown in FIG. 18 are for illustrative purposes only and do not limit the scope of the invention. In various embodiments, DE model splices and document splices may be linked in appropriate combinations and/or permutations, depending on the user case and/or user input.

Model and document splice linking and versioning are further described in detail in PCT application Nos. PCT/US24/44938 (Docket No. IST-03.006PCT) and PCT/US24/27912 (Docket No. IST-02.003PCT), incorporated by reference in their entirety herein.

### Documenting Digital Threads in a Technical Review Process

An exemplary use case for DE model-to-document model linking via model splicing and document splicing is in major program review workflows. The IDEP is designed to facilitate user interfaces that aid in decision-making based on dynamic data updates. This platform is particularly useful in contexts where users are tasked with making decisions based on rapidly changing data, for example, in multidisciplinary technical reviews.

In particular, FIG. 19 illustrates the complex process 1900 of documenting digital threads in a technical review, in accordance with example embodiments of the present invention. The top portion of FIG. 19 illustrates the overall process beginning with various digital tools 1902 and digital model-type files 1906. Each file may have its own related schema 1910 and contain data 1914 specific to the process under review. These files are then evaluated and properly connected to the specific paragraphs 1918, sections 1922, and documents 1926 that are requisite for technical review. That is, DE tools 1902 are used to author 1904 DE models 1906, which may be spliced to extract 1908 input and output schemas 1910. Model data 1914 parsed 1912 from the DE models 1906 according to the schemas 1910 may be mapped 1916 to paragraphs 1918 that make up 1920 sections 1922 contained 1924 within a DE review document 1926.

The bottom portion of FIG. 19 zooms into various steps of the top portion, showing exemplary data generated in each step of the digital thread documentation process for an Alternative Systems Review (ASR). An ASR produces a draft performance specification for the preferred material solution, and typically takes place during a Materiel Solution Analysis phase of the DE lifecycle. The ASR aims to evaluate the technical maturity, feasibility, and risk of the preferred material solution, ensuring it meets the operational capability requirements outlined in an Initial Capabilities Document (ICD).

In FIG. 19, a DE tool 1938 is used to generate a DE model file, for example, a multi-attribute tradespace exploration (MATE) file 1936 (MATE.mat) that evaluates and compares different options or alternatives based on multiple attributes or criteria to identify the best possible solution that balances various factors or objectives. Model splicing the DE model file provides specific model data in a standardized function schema 1934, from which specific data 1932 may be parsed 1930, for use in specific paragraph(s) 1928 or in more precise functions in a trade study report 1942. Such model data are then linked to a trade study report document splice to either carry out parameter substitution in specific paragraphs of the document, or to generate such paragraphs or parts of paragraphs with AI-assistance. This can be done for more than direct variable/parameter substitution, but can also be done for more qualitative aspects. For example, while sections and paragraphs of a document may inherently form a hierarchical structure within a document splice, certain paragraphs may be grouped together based on specific contexts and/or their dependencies on the same or related DE models, such that paragraph updates in response to model data changes may occur for paragraphs within a group, in parallel, sequentially, or in any appropriate combination thereof.

Paragraphs 1928 are in turn combined into sections (e.g., 1940) of the trade study report document 1942, to be used in the ASR review 1944. In this specific example, the final MATE report document comprises multiple sections, with section 6 being “Design Variables & Constraints” 1940, subsection 6.1 being “Design Variables”, and subsection 6.2 being “Constraints.”

When a DE model undergoes changes, all associated elements within the same document, such as titles, subtitles, paragraphs, sections, and subsections, need to be updated to reflect those changes. There is more than one reason for this. First, well-written individual paragraphs may not necessarily form coherent sections or documents when combined. Second, it is inefficient to make API calls to the DE model for each single paragraph, when the same data has already been retrieved for other paragraphs. An iterative approach can be employed to update from the bottom-up, starting with a specific target paragraph, then its related sections, and finally the entire document. In the subsequent iteration, updates to paragraphs, sections, and the whole document may be carried out in sequence. For a generated document to be easily comprehensible, at least two iterations may be necessary.

### Reducing Workflow Complexity

Digital operations involve a set of tasks that may be represented through a digital thread. In the following sections, certification workflows are used as examples of digital workflows to be enhanced and/or optimized. Workflow optimization is defined herein to describe the process of adjusting the structure or weights of a workflow data structure (e.g., a graph) to achieve a specific goal, such as minimizing the total weight of a spanning tree, maximizing the flow in a network, or balancing the load in a distributed system. In our context, workflow optimization also includes reducing duplication or repetition in the workflow process steps. Specifically, within the workflow data structure, a potential optimization may include any combination of the following: deleting a node, deleting an edge, adding a node, adding an edge, adding an edge weight, modifying a node, modifying an edge, and modifying an edge weight.

Note that while various embodiments illustrated herein describe optimizing certification workflows, the methods and systems described herein are not limited to certification workflows and are readily extended to any digital workflow that can be represented using a workflow data structure (e.g., DAG).

Digital certification involves the creation of digital threads for specific certification requirements, beginning with the digital models and linking them to various digital artifacts and eventually to the specific documentation of the certification requirements. Digital certification steps may be enabled by a digital platform with an architecture including model and document splices, and multimodal user interfaces. For example, the conversion of airworthiness certification into digital certification will achieve lower program risks, higher process efficiency and thus lower costs.

As discussed above, a large regulatory certification requirement, such as 516C, may have multiple places of duplication (e.g., where the same model is assessed multiple times in order to complete multiple distinct requirements). Digital certification approaches reduce the complexity of human effort involved in certification but may not eliminate duplicative or redundant steps in the process themselves. For different complex digital certification processes, users will want an assessment at each step of whether their current approach reduces risks and will eventually be successful for certification. More broadly, any certification process that involves multiple sources, phases, or stakeholders is likely to benefit from such a meta-analysis, whereby redundancies and inefficiencies in the process itself are identified, with expert guidance or system feedback provided to users.

In summary, digital certification approaches, while reducing the complexity of human effort, fail to eliminate inefficiencies and/or redundancy within the process itself. There is thus a need for a system through which the certifying entity can progress through the certification steps while simultaneously evaluating the risks involved and the success potential of the chosen pathway.

During a digital certification process, individual digital models, tools and documents are linked into a digital thread towards compliance with specific validation and verification (V&V) requirements. The linked digital thread may take the form of a directed acyclic graph (DAG). While an extremely complex digital thread of various links has been replaced with a DAG (see FIGS. 6 and 10), the redundancy or duplication in the certification process may still be reflected in the DAG, as redundant nodes or edges across different stages of the digital certification process.

The DAG workflow data structure format can be used to optimize workflows in this process. DAGs are particularly useful in representing tasks or jobs where some tasks depend on the completion of others. In such scenarios, DAGs can help identify the sequence in which tasks can be executed to optimize the overall workflow. They can also help identify tasks that can be executed in parallel, thereby reducing the total execution time. Furthermore, DAGs can be used to detect and eliminate redundancies in the workflow. By representing the workflow as a DAG, it becomes easier to identify tasks that are being repeated unnecessarily and remove them from the workflow. This can lead to substantial efficiency gains and cost savings.

Owing to model splicing, a scripted digital platform uniquely presents the ability to analyze and process DAGs of digital certification threads, with the objective of reducing process complexity and enhancing user experience.

FIG. 20 presents an overview 2000 of approaches within the digital platform to simplify certification workflows. Like the ASR documentation process described in FIG. 19, the certification process 2004 involves the use of various digital tools to process digital model-type files in order to extract schema. The parsed data are to be mapped to paragraphs in order to build sections that constitute the target certification document. Such a complex process may be represented by a workflow data structure, where each node represents a specific task, and each inter-node connection represents the data flow required between related tasks. In FIG. 20, the certification workflow data structure is represented as a DAG 2002.

The workflow optimization process may be carried out at the analysis and control plane 2006 (see FIG. 1). FIG. 20 shows three illustrative approaches within the digital platform to simplify certification workflows:
1. Representing User Journey Progress: This method 2008 uses visual management of progress to enable users to better prepare for the overall certification process. It involves the use of the digital platform's UI tools to represent DAG progress towards certification (see FIG. 10), thus enabling the detection of redundancies and inefficiencies. In one embodiment, the digital platform may keep a database of user actions in order to reconstruct workflows of specific processes (e.g., certification). Workflow datasets may thus be assembled over the digital platform to train machine learning models to detect inefficiencies and reduce redundancies, or to predict efficient task orders, as discussed below.
2. Workflow Simplification: This method 2010 uses graph theory algorithms to simplify workflow data structures (e.g., DAGs). Multiple algorithms may be applied, including algorithms that generate a minimal spanning tree of a DAG, identify the most prominent nodes in the DAG, or eliminate redundant nodes and/or edges.
3. Workflow Prediction: This method 2012 uses machine learning models to offer predictive analysis to users based on their current action (e.g., a selected digital model, a step of the certification process, etc.). In one embodiment, a certification workflow prediction ML model may train on training datasets composed of multiple digital certification workflows represented as DAGs. More generally, the ML models may be trained on training data sets composed of workflows represented as DAGs, where the workflows are not limited to certification workflows. In one embodiment, a dataset including various workflows, each paired with an efficient followup task, may be used to train a workflow prediction machine learning model to predict the next task of a workflow.

The use of a digital platform that converts certification processes into scripted digital threads simplifies the certification process, enhancing operational efficiency and resource management. In the context of the three outlined approaches, the system is effective in identifying and reducing redundancy, thereby optimizing the utilization of time and resources. Visual management of the certification process is facilitated through the visualization of the digital thread and workflow within the digital platform UI tools 2020, including the various user interfaces described in FIG. 5, including 3D visualization interfaces with VR, AR, audio, text, and/or code 2022, dashboard-style interfaces 2024, and workflow-based interfaces 2026. As described in FIG. 14, the use of visualization tools assists in the early detection and mitigation of workflow inefficiencies. The methods also provide cost-effective solutions by increasing efficiencies and eliminating unnecessary processes. The integration of machine learning models provides a predictive analytics capability, enabling users to make informed decisions at each step of the certification process, enhancing the overall approach to certification.

In the context of the three outlined strategies, the guidance offered to the users helps users navigate the complexities inherent to the certification process and streamline their efforts towards efficient certification. These strategies also manage users' expectations and enhance the user experience. Overall, these guidance methods, coupled with the capacity to reduce redundant steps and predict potential process pathways, improve the overall efficiency of the certification system. The methods and processes described herein apply beyond certification to any digital thread represented by a workflow data structure.

### User Journey Progress & Manual Workflow Enhancement

Digital threads simplify ineffective manual steps in digital workflows such as certification processes. Yet, human users will need to understand the progress step by step towards specific approvals and certifications. Based on prior history of certifications, the digital platform may provide, through its UI tools, a user-journey progress towards certification by system and subsystem. For example, a user may be in the middle of an ASR across multiple systems and subsystems (see FIG. 19). FIG. 21 shows an exemplary user's view of a digital platform dashboard 2100 indicating the progress of individual systems and subsystems towards a given certification. In FIG. 21, the workflow data structure is a DAG 2102 showing individual DE tasks. As discussed in the context of FIG. 10, the striped shading on some of the workflow nodes indicates a pending task status.

In FIG. 21, a progress bar 2106 shows the overall system progress toward the certification requirements 2104. A total number of requirements “4,300 total” is listed on the progress bar 2106. Progress by subsystem 2108 is shown below the progress bar, with a separate progress bar for each subsystem (e.g., progress bars 2110, 2116, 2118, and 2120 corresponding to subsystems 1, 2, 3, and 4, respectively).

Each subsystem may be further subdivided hierarchically, and the digital platform UI may provide tools for viewing the subdivisions at any level (e.g., by clicking on any given progress bar). For example, clicking on the progress bar of subsystem 1 2110 may reveal progress bars for two constituent sub-subsystems (sub-subsystems 1.1 2112 and 1.2 2114). As shown in the workflow data structure view 2102, the completion of the tasks related to sub-subsystems 1.1 2112 and 1.2 2114 leads to the completion of subsystem 1 2110. Similarly, the completion of all subsystems and their nested sub-subsystems leads to the completion of the overall requirements 2104, thus the completion of the digital workflow 2102.

FIG. 22 shows an alternative exemplary user's view of a digital platform dashboard 2200 indicating the progress of individual systems and subsystems towards a given certification. As shown in FIG. 22, the digital platform can also display progress by milestone, in addition to progress by system/subsystem. In addition to the subsystem progress bars 2214, the dashboard 2200 in FIG. 22 shows an overall progress bar 2202 indicating the overall system progress toward requirements. The overall progress bar 2202 exhibits progress nodes corresponding to various workflow milestones (e.g., progress nodes 2204, 2206, and 2208 indicating milestones 1, 2, and 3, respectively), where the positioning of each progress node along the overall progress bar 2202 indicates the completion status of its corresponding milestone. A final progress node 2210 is reached when all requirements of the workflow are met. In some embodiments, the digital platform allows the user to define the systems and/or subsystems and/or workflow tasks (i.e., workflow nodes) and/or task groups (i.e., workflow node groups) corresponding to each milestone. In some embodiments, a filter menu 2212 or button allows the user to select the requirements or subsystems of a given selected milestone.

In the case of certification workflows, such visual management tools can be informed by historical data of digital certifications on the platform, and further fine-tuned by human expert feedback. In particular, such visuals may allow a digital engineer to detect a redundancy (e.g., a redundant or useless sub-process represented by a redundant node, edge, or subgraph) and modify the corresponding DAG to remove the redundancy. Specifically, a Subject Matter Expert (SME), such as a certification process specialist, is able to provide feedback on a visualization of the certification process. Leveraging visual representations of the user journey and of specific aspects of the digital thread enables the SME to identify priority steps, detect redundancies, and pinpoint potential duplications accurately. Moreover, the digital engineering platform can capture and associate the SME's real-time feedback with specific steps in the digital thread, enhancing targeted improvements.

### Workflow Simplification

A second approach for optimizing and simplifying a digital certification process brings in computational techniques, facilitated by the analysis of its workflow data structure (e.g., its directed acyclic graph (DAG)). Workflow simplification is a type of workflow optimization that refers to the reduction of the number of nodes and/or connections of a workflow data structure while accomplishing the workflow tasks. The digital platform may represent the digital threads in the application plane as DAGs (see FIG. 1). Visuals of the DAG portray the underlying process more clearly, and the data structures in the DAG make them suitable for further analysis in the Analysis/Control plane.

The digital platform can deploy different graph theory algorithms and approaches in the Analysis/Control plane to further simplify the DAG. Two exemplary options for such graph theoretic methods include (1) determining a minimal spanning tree for a DAG (e.g., using Chu-Liu/Edmond's algorithm) and (2) analyzing nodes and edges by rank ordered weights, depending on how the nodes and edges encode the complexity of the digital thread. Such simplification steps further elucidate avenues for streamlining the certification process. In combination, such approaches provide a well-rounded solution for process improvement in certification workflows. By integrating the expertise of a SME with visual representations of the process, and utilizing algorithmic simplification of the DAG, the methodology ensures an efficient and thorough analysis for workflow simplification.

FIG. 23 illustrates the exemplary methods for workflow simplification 2300, according to embodiments of the present invention. In FIG. 23, the user seeks to review a certification workflow to find simplification options 2306.

An analysis of the digital thread and the user journey is carried out. In some embodiments, this analysis may include identifying process bottlenecks or redundancies and reviewing user action and user feedback databases collected by the digital platform 2308. The analysis may be carried out through expert Verification and Validation (V&V) reviewer feedback 2310, a process that involves any of the following steps 2312:
1. Highlighting priority review steps.
2. Removing duplicate steps from the DAG.
3. Removing redundant steps from the DAG.

Such an analysis may be supported by the visualization of the workflow data structure (e.g., DAG) 2302 through a user interface of the digital platform. Alternatively, the analysis may be carried out through DAG graph analysis (2314), a process that involves any of the following steps:
1. Analyzing nodes and edges of the graph to identify redundancy.
2. Using graph theory methods on DAGs (e.g., applying Minimal Spanning Tree on part or all of the DAG).
   Optimizing a Digital Thread using Minimal Spanning Tree (MST)

This approach is exemplary of DAG graph analysis 2318 and may incorporate the use of a workflow's directed acyclic graph (DAG) representation and the minimal spanning tree (MST) algorithm to simplify the digital certification process 2316. By interpreting digital tasks and artifacts as a DAG, and by applying MST algorithms to the DAG, an optimal sequence for certification analysis may be determined. The implementation and successful solution of this formulation may simplify the analysis processes for specific certifications. Sample implementation steps may include:
1. Creation of Digital Threads: Begin by structuring digital threads that connect digital models to the certification documentation.
2. Construction of the DAG: Convert digital tasks and artifacts into nodes and connections within a workflow data structure (e.g., a DAG). Store and manage these nodes and their connections using a graph database. Each node and edge should be assigned a unique identifier or hashcode for easy identification.
3. Encoding DAG Representations: Develop a systematic encoding process for the DAG representations to make the MST interpretable, detailing what each node, edge, and their weights represent. (See, for example, the workflow prediction section below on one embodiment of DAG edge weights).
4. Algorithm Application and Utilization: Implement and test the arborescence or MST algorithms. Chu-Liu/Edmonds' Algorithm can be invoked for identifying the optimal MST on the DAG. Subsequent to successfully generating the MST, execute a graph traversal algorithm to derive the optimal sequence of tasks and the optimal flow of data between tasks for the workflow (e.g., the certification analysis).
5. Validation of the MST: Experimentally verify the resultant MST by contrasting it with existing certification paths or processes. With a successful implementation, this technique can be iterated cyclically, leading to progressive improvements in the certification workflows.

In other embodiments of the present invention, improvements to the DAG representation for digital threads involve using subgraph compression, graph pruning, cycle detection, and topological sorting. Subgraph compression simplifies the DAG by consolidating recurring task sequences, reducing complexity and improving both visualization and user understanding. Graph pruning simplifies workflows by detecting nodes (and/or edges) that are unused in specific workflows and removing them (i.e., deleting them). Cycle detection ensures that the graph remains acyclic by identifying and resolving circular dependencies, preventing deadlocks, and enabling precise task sequencing. Topological sorting provides the optimal execution order of tasks, maintaining dependency integrity while identifying opportunities for parallel execution. Individually or in combination with the minimal spanning tree (MST), these techniques collectively improve DAG structures by ensuring correctness, minimizing redundancy, and optimizing workflow efficiency.

In another aspect of the present invention, a DAG optimization machine learning (ML) model may be trained-using a workflow dataset comprising sample workflow DAGs provided by the digital platform—to analyze an input DAG and generate an optimized output DAG or DAG optimization suggestions. In one embodiment, the digital platform creates such a workflow dataset by storing and maintaining a plurality of original (unmodified) and modified workflows for training, where each modified workflow corresponds to one original workflow. Any modified workflow must exhibit a lower workflow cost compared to its original workflow counterpart. In addition, any modified workflow must accomplish the same workflow tasks as its original workflow counterpart.

Workflow cost functions may capture any workflow performance metric such as workflow size (e.g., number of nodes and/or connections). Workflow cost functions are further discussed below. A workflow optimization machine learning (ML) model may thus be trained by the digital platform to receive a workflow and generate an optimized workflow in response.

### Workflow Prediction

FIG. 24 illustrates exemplary methods for workflow prediction 2400, according to embodiments of the present invention. The initial step for creating a workflow prediction engine involves pre-processing 2406 a digital thread into a directed acyclic graph (DAG) 2402. In various embodiments, this process may encompass several steps such as:
1. defining the structure of data,
2. constructing the graph to visualize the workflow,
3. assembling node metadata, and
4. assigning weights to the edges.

The steps above are mentioned in the context of FIG. 10. Each of these steps plays a critical role in preparing the training that enables the successful operation of the ML engine, with the end goal of predicting, streamlining, or optimizing workflows within the digital platform.

The second stage in developing the workflow prediction engine centers around the training of workflow prediction ML models 2408. The workflow prediction ML models may be trained on a specific type of workflow data structure. In the example of FIG. 24, they are trained on directed acyclic graphs (DAGs). The crux of this step lies in curating a diverse set of DAGs originating from various workflows (e.g., certifications). Once collated, these DAGs form a rich and broad training dataset for the workflow prediction ML models.

In the workflow prediction engine within a digital engineering platform, two exemplary machine learning methodologies are presented:
1. Probabilistic inference involving bayesian networks 2404, and
2. Categorical prediction utilizing neural networks 2414.

The two described approaches utilize machine learning (ML) models within a digital platform to provide users with predictive insights about their workflow (e.g., certification process), and thus drive better user awareness of the process and overall user experience.

Probabilistic Inference using Bayesian Networks

For probabilistic inference 2404, bayesian networks are methodically trained using directed acyclic graph (DAG) instances as the fundamental input, where nodes symbolize diverse workflow stages, and edges represent the interdependencies between those stages. The objective during the training phase is to identify and learn the conditional probability distributions that represent the likelihood of proceeding from one given node or workflow stage to another. The resulting output from this computational model is a scientifically computed probability distribution, spread across the nodes, that represents the probable likelihood of achieving successful workflow completion (e.g., certification completion) at each respective node 2410. This model aids in pinpointing smaller segments in the workflow that may represent higher risk or lower certainty, offering a critical predictive analysis tool.

Therefore, in one embodiment, probabilistic inference using bayesian networks may be implemented through the following steps:
1. Generate directed acyclic graphs (DAGs) from the digital threads of diverse certifications to use as training data.
2. Construct a bayesian network using nodes and edges from the DAG to model stages of a workflow and their dependencies.
3. Train the bayesian network to learn conditional probability distributions that represent the likelihood of transitioning from one workflow stage to another.
4. Evaluate the trained model using test data to validate its accuracy in predicting certification success at specific workflow stages.
5. Utilize the output probability distribution from the model to identify potential risk or uncertainty at different stages in the workflow.

Other probabilistic inference methodologies are within the scope of the present invention.

Categorical Prediction using Neural Networks

Alternatively, categorical prediction 2414 may incorporate the implementation of neural networks that are trained on equivalent DAG examples, where equivalence denotes workflow completion. The key aim of this methodology is enabling these neural networks to learn the task sequences in a workflow and configure predictions about upcoming tasks accordingly 2416. The input to this methodology mirrors the Bayesian approach, comprising nodes and edges of workflow data structures (e.g., DAGs). However, each edge possesses an associated weight that indicates the frequency or the impactful significance of transitioning from one node to another. The essential training phase involves iterative and systematic adjustments of these weights in order to minimize the categorical prediction error across the entire dataset. The consequential output is a sequentially organized prediction of the next set of potential tasks and nodes, effectively enhancing the efficiency and continuity of workflow progression.

Therefore, in one embodiment, categorical prediction using neural networks may be implemented through the following steps:
1. Collect directed acyclic graphs (DAGs) from multiple workflows (e.g., certification processes) to use as training data for the neural network.
2. Configure a neural network using nodes and edges of the DAGs as inputs.
3. Implement a weighting system for the edges representing the frequency or importance of transitioning between nodes.
4. Train the neural network through iterative adjustments of weights using a suitable optimization method, aiming to minimize the categorical prediction error on the training data.
5. Validate the trained model on a separate test dataset and evaluate its accuracy in predicting subsequent tasks in a workflow.
6. Use the trained neural network to predict the next set of potential tasks or nodes in the certification process, contributing to increased workflow efficiency and smoother progression.

Other categorical prediction methodologies are within the scope of the present invention. By combining these two machine learning methodologies, the workflow prediction engine may be capable of optimizing a variety of digital workflows (e.g., certification processes). The digital platform may thus utilize 2412 and combine the insights from various ML models to improve user experience during the creation and operation of digital workflows such as certification workflows.

Integration of Reinforcement Learning with Expert Feedback

The workflow prediction machine learning methodologies described above may include human expert feedback at multiple steps. Hence, an expert may identify a discrepancy or a better path than the one predicted by the ML models. Such expert feedback may contribute to the prediction dataset, and hence to the subsequent iterations of the model training.

The workflow prediction engine uses interactive feedback and reinforcement learning, and integrates prediction, expert feedback, and model refinement cycles, to leverage the strengths of machine learning and human expertise. This fosters an iterative learning environment within the digital platform, resulting in enhanced reliability and performance of the digital workflow (e.g., digital certification process) over time.

### Multimodal User Interfaces for Workflow Prediction Engine

The digital engineering platform may incorporate multimodal user interfaces (UIs) that facilitate the comprehension and utilization of prediction outcomes by the users. An interactive and intuitive interface may effectively visualize the digital thread and/or its associated workflow (see FIG. 14), the probabilities of workflow (e.g., certification) success at different stages and/or nodes, and the predicted subsequent tasks. This system may guide the users to understand the finer details of the workflow (e.g., certification) process and predictions, ultimately aiding them in making strategic decisions. Users can explore alternative paths, understand the risks and benefits associated with each step, and eventually choose the most favorable strategy for their specific scenario. By integrating these advanced user interfaces, the platform may further enhance communication, understanding, and collaboration, thereby improving the overall user experience.

### Machine Learning (ML) and Neural Networks

Machine learning (ML) algorithms are characterized by the ability to improve their performance at a task over time without being explicitly programmed with the rules to perform that task (i.e., learn). An artificial intelligence (AI) model, or an ML model, is the trainable software module associated with an ML algorithm. As described herein, embodiments of the present invention use one or more ML algorithms to perform different operations required for the optimization of digital workflows over a digital platform, as disclosed herein. Various exemplary ML algorithms are within the scope of the present invention. The following description describes illustrative ML techniques for implementing various embodiments of the present invention.

### Neural Networks

A neural network is a computational model comprising interconnected units called “neurons” that work together to process information. It is a type of ML algorithm that is particularly effective for recognizing patterns and making predictions based on complex data. Neural networks are widely used in various applications such as image and speech recognition and natural language processing, due to their ability to learn from large amounts of data and improve their performance over time. FIG. 25 describes neural network operation fundamentals, according to exemplary embodiments of the present invention.

FIG. 25 shows a single-layered neural network, also known as a single-layer perceptron. The operation of a single-layered neural network involves the following steps:
1. Input: Receiving a digital task input (or a process step input) vector v (2504) with elements vⱼ, with j ∈ [1, n] representing the j^{th} digital task input, and where each element of the vector corresponds to an element 2506 in the input layer. For an exemplary neural network model trained to predict a workflow element (e.g., a node or a connection) from an input workflow, the digital task input vector v (2504) may take the form of an input workflow representation (e.g., a DAG representation). A digital task input may also be a user prompt, a template script, and/or any data relevant to the digital task, as described herein.
2. Transfer Function: Multiplying each element of the digital task input vector by a corresponding weight wⱼ (2508). These weighted inputs are then summed together (2510) as the transfer function, yielding the net input to the activation function

$${\sum }_{j = 1}^{n} {v}_{j} \cdot {w}_{j}$$

Each neuron in a neural network may have a bias value 2512, which is added to the weighted sum of the inputs to that neuron. Both the weights and bias values are learned during the training process. The purpose of the bias is to provide every neuron with a trainable constant value that can help the model fit the data better. With biases, the net input to the activation function is

$${\sum }_{j = 1}^{n} \{ {v}_{j} \cdot {w}_{j} \} + b .$$

In the exemplary neural network model described above (e.g., to implement a workflow prediction ML model), the value of the transfer function 2510 may represent the probability that a given workflow element will be output.
3. Activation Function: Passing the net input through an activation function 2514. The activation function σ determines the activation value o (2518), which is the output of the neuron. It is typically a non-linear function such as a sigmoid or ReLU (Rectified Linear Unit) function. The threshold 0 2516 of the activation function is a value that determines whether a neuron is activated or not. In some activation functions, such as the step function, the threshold is a specific value. If the net input is above the threshold, the neuron outputs a constant value, and if it's below the threshold, it outputs a zero value. In other activation functions, such as the sigmoid or ReLU (Rectified Linear Unit) functions, the threshold is not a specific value but rather a point of transition in the function's curve.
In the exemplary neural network model described above (e.g., to implement a workflow prediction ML model), the activation function σ (2514) may be a ReLU that is activated at a threshold 0 (2516) representing the minimum probability for a given workflow element to be generated. Hence, the activation function 2514 will yield the given workflow element when the implementation likelihood exceeds the threshold 0 (2516).
4. Output: The activation value o (2518) is the output of the activation function. This value is what gets passed on to the next layer in the network or becomes the final digital task (or process step) output in the case of the last layer. In the exemplary neural network model described above (e.g., to implement a workflow prediction ML model), multiple activation values o (2518) from multiple layers of a neural network may be combined to generate a workflow element that has the highest likelihood of satisfying a given digital task input 2504 (e.g., accomplishing a given workflow). A digital task (or process step) output may alternatively be an optimized workflow, a contextual data, an orchestration script, or any form of data relevant to the digital task, as described herein.

In the exemplary neural network discussions of FIG. 25, examples are provided with respect to a particular workflow prediction ML model implementation using neural networks. Analogous approaches can be used to implement workflow optimization ML models or any other NN-based components of the systems and subsystems described herein.

FIG. 26 shows an overview of an IDMP neural network training process, according to exemplary embodiments of the present invention. The training of the IDMP neural network involves repeatedly updating the weights and biases 2610 of the network to minimize the difference between the predicted output 2604 and the true or target output 2606, where the predicted output 2604 is the result produced by the network when a set of inputs from a dataset is passed through it. The predicted output 2604 of an IDMP neural network 2602 corresponds to the digital task output 2518 of the final layer of the neural network. The true or target output 2606 is the true desired result. The difference between the predicted output and the true output is calculated using a loss function 2608, which quantifies the error made by the network in its predictions.

The loss function is a part of the cost function 2608, which is a measure of how well the network is performing over the whole dataset. The goal of training is to minimize the cost function 2608. This is achieved by iteratively adjusting the weights and biases 2610 of the network in the direction that leads to the steepest descent in the cost function. The size of these adjustments is determined by the learning rate 2608, a hyperparameter that controls how much the weights and biases change in each iteration. A smaller learning rate means smaller changes and a slower convergence towards the minimum of the cost function, while a larger learning rate means larger changes and a faster convergence, but with the risk of overshooting the minimum.

For an IDMP neural network model 2602 based on the exemplary neural network model (e.g., to implement a workflow prediction ML model) discussed above in the context of FIG. 25, and trained to determine whether a given workflow element is to be added to the input workflow based:
the weights and biases 2610 are the IDMP neural network's hyperparameters that get updated at each iteration of the training process, as discussed in the context of FIG. 25,
the predicted output 2604 may be the binary prediction on whether a given workflow element is to be added based on the input workflow, (or a normalized score ranking prioritizing the order of workflow elements to be displayed to the user),
the true/target output 2606 is the correct decision (i.e., sample ground truth output) on whether to generate the given workflow element based on the input workflow,
the loss function 2608 is the difference between the evaluation and the true output (e.g., a binary error indicating whether the IDMP neural network's decision was correct),
the cost function 2608 is the average of all errors over a training dataset including sample workflows, and corresponding sample workflow elements implementing the required digital tasks, and
the learning rate 2608 is the rate at which the cost function 2608 in consecutive training epochs approaches a pre-specified tolerable cost function.

Neural network training combines the processes of forward propagation and backpropagation. Forward propagation is the process where the input data is passed through the network from the input layer to the output layer. During forward propagation, the weights and biases of the network are used to calculate the output for a given input. Backpropagation, on the other hand, is the process used to update the weights and biases 2610 of the network based on the error (e.g., cost function) 2608 of the output. After forward propagation through the IDMP neural network 2602, the output 2604 of the network is compared with true output 2606, and the error 2608 is calculated. This error is then propagated back through the network, starting from the output layer and moving towards the input layer. The weights and biases 2610 are adjusted in a way that minimizes this error. This process is repeated for multiple iterations or epochs until the network is able to make accurate predictions.

The neural network training method described above, in which the network is trained on a labeled dataset (e.g., sample pairs of input user prompts and corresponding output recommendations), where the true outputs are known, is called supervised learning. In unsupervised learning, the network is trained on an unlabeled dataset, and the goal is to discover hidden patterns or structures in the data. The network is not provided with the true outputs, and the training is based on the intrinsic properties of the data. Furthermore, reinforcement learning is a type of learning where an agent learns to make decisions from the rewards or punishments it receives based on its actions. Although reinforcement learning does not typically rely on a pre-existing dataset, some forms of reinforcement learning can use a database of past actions, states, and rewards during the learning process. Any neural network training method that uses a labeled dataset is within the scope of the methods and systems described herein, as is clear from the overview below.

FIG. 27 provides additional details on the training process or an IDMP machine learning model such as a workflow prediction ML model or a workflow optimization ML model, according to exemplary embodiments of the present invention.

### Transformer Model Architecture

The transformer architecture is a neural network design that was introduced in the paper “Attention is All You Need” by Vaswani et al. (arxiv: 1706.03762, 2017), and incorporated herein by reference as if fully set forth herein. Large Language Models (LLMs) heavily rely on the transformer architecture.

The architecture (see FIG. 1 in Vaswani et al.) is based on the concept of “attention”, allowing the model to focus on different parts of the input sequence when producing an output. Transformers consist of an encoder and a decoder. The encoder processes the input data and the decoder generates the output. Each of these components is made up of multiple layers of self-attention and point-wise, fully connected layers.

The layers of self-attention in the transformer model allow it to weigh the relevance of different parts of the input sequence when generating an output, thereby enabling it to capture long-range dependencies in the data. On the other hand, the fully connected layers are used for transforming the output of the self-attention layers, adding complexity and depth to the model's learning capability.

The transformer model is known for its ability to handle long sequences of data, making it particularly effective for tasks such as machine translation and text summarization. In the transformer architecture, positional encoding is used to give the model information about the relative positions of the words in the input sequence. Since the model itself does not have any inherent sense of order or sequence, positional encoding is a way to inject some order information into the otherwise order-agnostic attention mechanism.

### The Embeddings Vector Space

In the context of neural networks, tokenization refers to the process of converting the input and output spaces, such as natural language text or programming code, into discrete units or “tokens”. This process allows the network to effectively process and understand the data, as it transforms complex structures into manageable, individual elements that the model can learn from and generate.

In the training of neural networks, embeddings serve as a form of distributed word representation that converts discrete categorical variables (i.e., tokens) into a continuous vector space (i.e., embedding vectors). This conversion process captures the semantic properties of tokens, enabling tokens with similar meanings to have similar embeddings. These embeddings provide a dense representation of tokens and their semantic relationships. Embeddings are typically represented as vectors, but may also be represented as matrices or tensors.

The input of a transformer typically requires conversion from an input space (e.g., the natural language token space) to an embeddings' space. This process, referred to as “encoding”, transforms discrete inputs (tokens) into continuous vector representations (embeddings). This conversion is a prerequisite for the transformer model to process the input data and understand the semantic relationships between tokens (e.g., words). Similarly, the output of a transformer typically requires conversion from the embeddings' space to an output space (e.g., natural language tokens, programming code tokens, etc.), in a process referred to as “decoding”. Therefore, the training of a neural network and its evaluation (i.e., its use upon deployment) both occur within the embeddings' space.

In this document, the processes of tokenization, encoding, decoding, and de-tokenization may be assumed. In other words, the processes described below occur in the “embeddings' space”. Hence, while the tokenization and encoding of training data and input prompts may not be represented or discussed explicitly, they may nevertheless be implied. Similarly, the decoding and de-tokenization of neural network outputs may also be implied.

### Training and Fine-Tuning Machine Learning (ML) Modules

FIG. 27 is an illustrative flow diagram showing the different phases and datasets involved in training an IDMP ML model such as a workflow prediction ML model or a workflow optimization ML model, according to exemplary embodiments of the present invention.

The training process starts at step 2710 with digital task data acquisition, retrieval, assimilation, or generation. At step 2720, acquired digital task data is pre-processed, or prepared. At step 2730, the IDMP ML model is trained using training data 2725. At step 2740, the IDMP ML model is evaluated, validated, and tested, and further refinements to the IDMP ML model are fed back into step 2730 for additional training. Once its performance is acceptable, at step 2750, optimal IDMP ML parameters are selected.

Training data 2725 is a dataset containing multiple instances of system inputs (e.g., user inputs, user actions, workflows, user prompts, DTw/PTw performance data, simulation data, and/or certification/requirement documents, etc.) and correct outcomes (e.g., optimal workflows, improved workflows, orchestration scripts, etc.). It trains the IDMP ML model to optimize the performance for a specific target task, such as the prediction of a specific target output data field within a specific target document. In FIG. 27, training data 2725 may also include subsets for validating and testing the IDMP ML model, as part of the training iterations 2730 and 2740. For an NN-based ML model, the quality of the output may depend on (a) NN architecture design and hyperparameter configurations, (b) NN coefficient or parameter optimization, and (c) quality of the training data set. These components may be refined and optimized using various methods. For example, training data 2725 may be expanded via a document database augmentation process.

In some embodiments, an additional fine-tuning 2760 phase including iterative fine-tuning 2760 and evaluation, validation, and testing 2770 steps, is carried out using fine-tuning data 2755. Fine-tuning in machine learning is a process that involves taking a selected 2750 pre-trained model and further adjusting or “tuning” its parameters to better suit a specific task or fine-tuning dataset 2755. This technique is particularly useful when dealing with deep learning models that have been trained on large, general training datasets 2725 and are intended to be applied to more specialized tasks or smaller datasets. The objective is to leverage the knowledge the model has already acquired during its initial training (often referred to as transfer learning) and refine it so that the model performs better on a more specific task at hand.

The fine-tuning process typically starts with a model that has already been trained on a large benchmark training dataset 2725, such as ImageNet for image recognition tasks. The model's existing weights, which have been learned from the original training, serve as the starting point. During fine-tuning, the model is trained further on a new fine-tuning dataset 2755, which may contain different classes or types of data than the original training set. This additional training phase allows the model to adjust its weights to better capture the characteristics of the new fine-tuning dataset 2755, thereby improving its performance on the specific task it is being fine-tuned for.

In some embodiments, additional test and validation 2780 phases are carried out using digital task test and validation data 2775. Testing and validation of a ML model both refer to the process of evaluating the model's performance on a separate dataset 2775 that was not used during training, to ensure that it generalizes well to new unseen data. Validation of a ML model helps to prevent overfitting by ensuring that the model's performance generalizes beyond the training data.

While the validation phase is considered part of ML model development and may lead to further rounds of fine-tuning, the testing phase is the final evaluation of the model's performance after the model has been trained and validated. The testing phase provides an unbiased assessment of the final model's performance that reflects how well the model is expected to perform on unseen data, and is usually carried out after the model has been finalized to ensure the evaluation is unbiased.

Once the IDMP ML model is trained 2730, selected 2750, and optionally fine-tuned 2760 and validated/tested 2780, the process ends with the deployment 2790 of the IDMP ML model. Deployed IDMP ML models 2795 usually receive new digital task data 2785 that was pre-processed 2780.

In machine learning, data pre-processing 2720 is tailored to the phase of model development. During model training 2730, pre-processing involves cleaning, normalizing, and transforming raw data into a format suitable for learning patterns. For fine-tuning 2760, pre-processing adapts the data to align with the distribution of the specific targeted task, ensuring the pre-trained model can effectively transfer its knowledge. Validation 2780 pre-processing mirrors that of training to accurately assess model generalization without leakage of information from the training set. Finally, in deployment 2790, pre-processing ensures real-world data matches the trained model's expectations, often involving dynamic adjustments to maintain consistency with the training and validation stages.

### Machine Learning Algorithms

Various exemplary ML algorithms are within the scope of the present invention. Such machine learning algorithms include, but are not limited to, random forest, nearest neighbor, decision trees, support vector machines (SVM), Adaboost, gradient boosting, Bayesian networks, evolutionary algorithms, various neural networks (including deep learning networks (DLN), convolutional neural networks (CNN), and recurrent neural networks (RNN)), etc.

ML modules based on transformers and Large Language Models (LLMs) are particularly well suited for the tasks described herein. The online article “Understanding Large Language Models—A Transformative Reading List”, by S. Raschka, describes various LLM architectures that are within the scope of the methods and systems described herein, and is hereby incorporated by reference in its entirety herein as if fully set forth herein.

The input to each of the listed ML modules is a feature vector comprising the input data described above for each ML module. The output of the ML module is a feature vector comprising the corresponding output data described above for each ML module.

Prior to deployment, each of the ML modules listed above may be trained on one or more respective sample input datasets and on one or more corresponding sample output datasets. The input and output training datasets may be generated from a database containing a history of input instances (e.g., user inputs, user actions, user prompts, workflows, contextual data files, task-related documents, template scripts, placeholder variables) and output instances (e.g., optimal workflows, contextual data files, template scripts, orchestration scripts, placeholder variables), or may be generated synthetically by subject matter experts.

### Exemplary System Architecture

An exemplary embodiment of the present disclosure may include one or more servers (management computing entities), one or more networks, and one or more clients (user computing entities). Each of these components, entities, devices, and systems (similar terms used herein interchangeably) may be cloud-based, and in direct or indirect communication with, for example, one another over the same or different wired or wireless networks. All of these devices, including servers, clients, and other computing entities or nodes may be run internally by a customer (in various architecture configurations including private cloud), internally by the provider of the IDMP (in various architecture configurations including private cloud), and/or on the public cloud.

FIG. 28 provides illustrative schematics of a server (management computing entity) 2810 connected via a network 2820 to a client (user computing entity) 2830 used for documentation within an interconnected digital model platform (IDMP), according to some embodiments of the present invention. While FIG. 28 illustrates the various system entities as separate, standalone entities, the various embodiments are not limited to this particular architecture. Additionally, the terms “client device”, “client computing entity”, “edge device”, and “edge computing system” are equivalent and are used interchangeably herein.

### Exemplary Management Computing Entity

An illustrative schematic is provided in FIG. 28 for a server or management computing entity 2810. In general, the terms computing entity, computer, entity, device, system, and/or similar words used herein interchangeably may refer to, for example, one or more cloud servers, computers, computing entities, desktop computers, mobile phones, tablets, phablets, notebooks, laptops, distributed systems, gaming consoles, watches, glasses, iBeacons, proximity beacons, key fobs, radio frequency identification (RFID) tags, earpieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, crawling, displaying, storing, determining, creating/generating, monitoring, evaluating, and/or comparing (similar terms used herein interchangeably). In one embodiment, these functions, operations, and/or processes can be performed on data, content, and/or information (similar terms used herein interchangeably), as they are used in a digital task or process step.

In one embodiment, management computing entity 2810 may be equipped with one or more communication interfaces 2812 for communicating with various computing entities, such as by exchanging data, content, and/or information (similar terms used herein interchangeably) that can be transmitted, received, operated on, processed, displayed, stored, and/or the like. For instance, management computing entity 2810 may communicate with one or more client computing devices such as 2830 and/or a variety of other computing entities. Network or communications interface 2812 may support various wired data transmission protocols including, but not limited to, Fiber Distributed Data Interface (FDDI), Digital Subscriber Line (DSL), Ethernet, Asynchronous Transfer Mode (ATM), frame relay, and data over cable service interface specification (DOCSIS). In addition, management computing entity 2810 may be capable of wireless communication with external networks, employing any of a range of standards and protocols, including but not limited to, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High-Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

As shown in FIG. 28, in one embodiment, management computing entity 2810 may include or be in communication with one or more processors 2814 (also referred to as processors and/or processing circuitry, processing elements, and/or similar terms used herein interchangeably) that communicate with other elements within management computing entity 2810, for example, via a bus. As will be understood, processor 2814 may be embodied in a number of different ways. For example, processor 2814 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. The term circuitry may refer to an entire hardware embodiment or a combination of hardware and computer program products. Thus, processor 2814 may be embodied as integrated circuits (ICs), application-specific integrated circuits (ASICs), field-programmable gate arrays (FPGAs), programmable logic arrays (PLAs), hardware accelerators, other circuitry, and/or the like. As will therefore be understood, processor 2814 may be configured for a particular use or configured to execute instructions stored in volatile or non-volatile (or non-transitory) media 2816 and 2818, or otherwise accessible to processor 2814. As such, whether configured by hardware or computer program products, or by a combination thereof, processor 2814 may be capable of performing steps or operations according to embodiments of the present disclosure when configured accordingly.

In one embodiment, management computing entity 2810 may further include or be in communication with non-transitory memory 2818 (also referred to as non-volatile media, non-volatile storage, non-transitory storage, physical storage media, memory, memory storage, and/or memory circuitry—similar terms used herein interchangeably). In one embodiment, the non-transitory memory or storage may include one or more non-transitory memory or storage media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile (or non-transitory) storage or memory media may store cloud storage buckets, databases, database instances, database management systems, data, applications, programs, program modules, scripts, source code, object code, byte code, compiled code, interpreted code, machine code, executable instructions, and/or the like. The term database, database instance, and/or database management system (similar terms used herein interchangeably) may refer to a collection of records or data that is stored in a computer-readable storage medium using one or more database models, such as a hierarchical database model, network model, relational model, entity-relationship model, object model, document model, semantic model, graph model, and/or the like.

In one embodiment, management computing entity 2810 may further include or be in communication with volatile memory 2816 (also referred to as volatile storage, memory, memory storage, memory and/or circuitry-similar terms used herein interchangeably). In one embodiment, the volatile storage or memory may also include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, processor 2814. Thus, the cloud storage buckets, databases, database instances, database management systems, data, applications, programs, program modules, scripts, source code, object code, byte code, compiled code, interpreted code, machine code, executable instructions, and/or the like may be used to control certain aspects of the operation of management computing entity 2810 with the assistance of processor 2814 and an operating system.

Although not shown, management computing entity 2810 may include or be in communication with one or more input elements, such as a keyboard input, a mouse input, a touch screen/display input, motion input, movement input, audio input, pointing device input, joystick input, keypad input, and/or the like. Management computing entity 2810 may also include or be in communication with one or more output elements, also not shown, such as audio output, visual output, screen/display output, motion output, movement output, spatial computing output (e.g., virtual reality or augmented reality), and/or the like.

As will be appreciated, one or more of the components of management computing entity 2810 may be located remotely from other management computing entity components, such as in a distributed system. Furthermore, one or more of the components may be combined and additional components performing functions described herein may be included in management computing entity 2810. Thus, management computing entity 2810 can be adapted to accommodate a variety of needs and circumstances. As will be recognized, these architectures and descriptions are provided for exemplary purposes only and are not limited to the various embodiments.

### Exemplary User Computing Entity

A user may be a human individual, a company, an organization, an entity, a department within an organization, a representative of an organization and/or person, an artificial user such as algorithms, artificial intelligence, or other software that interfaces, and/or the like. FIG. 28 further provides an illustrative schematic representation of a client user computing entity 2830 that may be used in conjunction with embodiments of the present disclosure. In various embodiments, computing device 2830 may be a general-purpose computing device with dedicated modules for performing digital engineering-related tasks. It may alternatively be implemented in the cloud, with logically and/or physically distributed architectures.

As shown in FIG. 28, user computing entity 2830 may include a power source 2831, an antenna 2870, a radio transceiver 2832, a network and communication interface 2834, and a processor unit 2840 that provides signals to and receives signals from the network and communication interface. The signals provided to and received may include signaling information in accordance with air interface standards of applicable wireless systems. In this regard, user computing entity 2830 may be capable of operating with one or more air interface standards, communication protocols, modulation types, and access types. More particularly, user computing entity 2830 may operate in accordance with any of a number of wireless communication standards and protocols, such as those described above with regard to management computing entity 2810. Similarly, user computing entity 2830 may operate in accordance with multiple wired communication standards and protocols, such as those described above with regard to management computing entity 2810.

Via these communication standards and protocols, user computing entity 2830 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). User computing entity 2830 may also download changes, add-ons, and updates, for instance, to its firmware, software (e.g., including executable instructions, applications, program modules), and operating system.

In some implementations, processing unit 2840 may be embodied in several different ways. For example, processing unit 2840 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. Further, processing unit 2840 may be embodied as one or more other processing devices or circuitry. The term circuitry may refer to an entirely hardware embodiment or a combination of hardware and computer program products. Thus, processing unit 2840 may be embodied as integrated circuits, application specific integrated circuits (ASICs), field programmable gate arrays (FPGAs), programmable logic arrays (PLAs), hardware accelerators, other circuitry, and/or the like. As will therefore be understood, processing unit 2840 may be configured for a particular use or configured to execute instructions stored in volatile or non-volatile media or otherwise accessible to the processing unit. As such, whether configured by hardware or computer program products, or by a combination thereof, processing unit 2840 may be capable of performing steps or operations according to embodiments of the present invention when configured accordingly.

In some embodiments, processing unit 2840 may comprise a control unit 2842 and a dedicated arithmetic logic unit (ALU) 2844 to perform arithmetic and logic operations. In some embodiments, user computing entity 2830 may comprise a graphics processing unit (GPU) 2846 for specialized parallel processing tasks, and/or an artificial intelligence (AI) module or accelerator 2848, also specialized for applications including artificial neural networks and machine learning. In some embodiments, processing unit 2840 may be coupled with GPU 2846 and/or AI accelerator 2848 to distribute and coordinate digital workflow related tasks.

In some embodiments, computing entity 2830 may include a user interface, comprising an input interface 2850 and an output interface 2852, each coupled to processing unit 2840. User input interface 2850 may comprise any of a number of devices or interfaces allowing computing entity 2830 to receive data, such as a keypad (hard or soft), a touch display, a mic/speaker for voice/speech/conversation, a camera for motion or posture interfaces, and appropriate sensors for spatial computing interfaces. User output interface 2852 may comprise any of a number of devices or interfaces allowing computing entity 2830 to provide information to a user, such as through the touch display, or a speaker for audio outputs. In some embodiments, output interface 2852 may connect computing entity 2830 to an external loudspeaker or projector, for audio and/or visual output. In some embodiments, user interfaces 2850 and 2852 integrate multimodal data in an interface that caters to human users. Some examples of human interfaces include a dashboard-style interface, a workflow-based interface, conversational interfaces, and spatial-computing interfaces. As shown in FIG. 5, computing entity 2830 may also support bot/algorithmic interfaces such as code interfaces, text-based API interfaces, and the like.

User computing entity 2830 can also include volatile and/or non-volatile storage or memory 2860, which can be embedded and/or may be removable. For example, the non-volatile or non-transitory memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile (or non-transitory) storage or memory 2860 may store an operating system 2862, application software 2864, data 2866, databases, database instances, database management systems, data, applications, programs, program modules, scripts, source code, object code, byte code, compiled code, interpreted code, machine code, executable instructions, and/or the like to implement functions of user computing entity 2830. As indicated, this may include a user application that is resident on the entity or accessible through a browser or other user interface for communicating with management computing entity 2810 and/or various other computing entities.

In some embodiments, user computing entity 2830 may include one or more components or functionalities that are the same or similar to those of management computing entity 2810, as described in greater detail above. As will be recognized, these architectures and descriptions are provided for exemplary purposes only and are not limited to the various embodiments.

In some embodiments, computing entities 2810 and/or 2830 may communicate to external devices like other computing devices and/or access points to receive information such as software or firmware, or to send information from the memory of the computing entity to external systems or devices such as servers, computers, smartphones, and the like.

In some embodiments, two or more computing entities such as 2810 and/or 2830 may establish connections using a network such as 2820 utilizing any of the networking protocols listed previously. In some embodiments, the computing entities may use network interfaces such as 2812 and 2834 to communicate with each other, such as by communicating data, content, information, and/or similar terms used herein interchangeably that can be transmitted, received, operated on, processed, displayed, stored, and/or the like.

### Additional Hardware & Software Implementation Details

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus.

Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The terms “processor”, “computer,” “data processing apparatus”, and the like encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, code, program code, and the like) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a backend component, e.g., as an information/data server, or that includes a middleware component, e.g., an application server, or that includes a frontend component, e.g., a client computer having a graphical user interface or a web browser through which a user can interact with an implementation of the subject matter described herein, or any combination of one or more such back end, middleware, or front end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship with each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service), and increases user satisfaction and ease of use. Various business models, revenue models, and delivery mechanisms for the present invention are envisioned, and are all to be considered within the scope of the present invention.

In general, the method executed to implement the embodiments of the invention, may be implemented as part of an operating system or a specific application, component, program, object, module, or sequence of instructions referred to as “program code,” “computer program(s)”, “computer code(s),” and the like. The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually affect the distribution. Examples of computer-readable media include but are not limited to recordable type media such as volatile and non-volatile (or non-transitory) memory devices, floppy and other removable disks, hard disk drives, optical disks, which include Compact Disk Read-Only Memory (CD ROMS), Digital Versatile Disks (DVDs), etc., as well as digital and analog communication media.

### Terminology

Some illustrative terminologies used with the IDMP are provided below to assist in understanding the present invention, but these are not to be read as restricting the scope of the present invention. The terms may be used in the form of nouns, verbs, or adjectives, within the scope of the definition.

Digital Engineering
Digital engineering (DE): According to the Defense Acquisition University (DAU) and the Department of Defense (DOD) Digital Engineering Strategy published in 2018, digital engineering is “an integrated digital approach to systems engineering, using authoritative sources of systems' data and models as a continuum across disciplines to support lifecycle activities from concept through disposal.” Digital engineering incorporates digital technological innovations into an integrated, model-based approach that empowers a paradigm shift from the traditional design-build-test methodology of systems engineering to a new model-analyze-build methodology, thus enabling systems design, prototyping, and testing all in a virtual environment.
DE data: Digital engineering (DE) data includes project management, program management, product management, design review, and/or engineering data.
DE data field: A data field for DE data, for example, in a DE document template.
Phases: The stages within a DE product lifecycle, including but not limited to, stakeholder analysis, concept studies, requirements definition, preliminary design and technology review, system modeling, final design, implementation, system assembly and integration, prototyping, verification and validation on system, sub-system, and component levels, and operations and maintenance.
DE model: A computer-generated model that represents characteristics or behaviors of a complex product, system, or process. A DE model can be created or modified using a DE tool, and a DE model may be represented by one or more DE model files. A DE model file is the computer model file created or modified using the DE tool. In the present disclosure, the terms “digital model”, “DE model” and “DE model file” may be used interchangeably, as the context requires. A DE model within the IDEP as disclosed herein refers to any digital file uploaded onto the platform, including documents that are appropriately interpreted, as defined below. For example, a computer-aided design (CAD) file, a Systems Modeling Language (SysML) file, a Systems Requirements Document (SDR) text file, and a Neural Network Model JSON file may each be considered a DE model, in various embodiments of the present invention. A DE model may be machine-readable only, may be human-readable as well but written in programming codes, or may be human-readable and written in natural language-based texts. For example, a word-processing document comprising a technical specification of a product, or a spreadsheet file comprising technical data about a product, may also be considered a DE model. A DE model is a type of digital model, defined below. In general, any reference to a DE model in the specification and drawings may be considered equivalent to a reference to a digital model, and vice versa.
Digital Model: A computer-generated model that represents characteristics or behaviors of a complex product, system, or process. Digital models include DE models but are not limited to the field of digital engineering. For example, digital models include medical model files used to build digital twins of patients (e.g., digital patients), such as clinical documentation, laboratory results, physiological test results, psychological test results, patient communications and reports, patient medical data, health records, remote monitoring data, and the like. Digital models also include the financial models used to build digital twins of financial assets, such as enterprise data, business financial data, process data (e.g., manufacturing, logistics, sales, supply chain), research results, etc. Other examples of digital models are also within the scope of the present invention, for example, scientific models, geophysical models, climate models, biological models, biochemical models, chemical models, drug models, petrochemical models, oceanographic models, business process models, management science models, economic models, econometric models, sociological models, population dynamics models, socioeconomic models, planetary science models, mining models, mineral models, metallurgical models, supply chain logistics models, manufacturing models, and so on. Digital models include one or more digital artifacts, where each digital artifact is accessible with a security network. A model file can be created or modified using a software tool. A model file within the Interconnected Digital Model Platform (IDMP) as disclosed herein refers to any digital file uploaded onto the platform. All the terms and concepts defined above and included herein, including model splicing, model splices, and software-defined digital threads, apply in the context of the digital model and within the context of the IDMP.
Verification: According to the DAU, verification “confirms that a system element meets design-to or build-to specifications. Through the system's life cycle, design solutions at all levels of the physical architecture are verified through a cost-effective combination of analysis, examination, demonstration, and testing.” Verification refers to evaluating whether a product, service, or system meets specified requirements and is fit for its intended purpose, checking externally against customer or stakeholder needs. For example, in the aerospace industry, a verification process may include testing an aircraft component to ensure it can withstand the forces and conditions it will encounter during flight.
Validation: According to the DAU, validation is “1) the review and approval of capability requirement documents by a designated validation authority. 2) The process by which the contractor (or as otherwise directed by the DoD component procuring activity) tests a publication/technical manual for technical accuracy and adequacy. 3) The process of evaluating a system or software component during, or at the end of, the development process to determine whether it satisfies specified requirements.” Thus, validation refers to evaluating whether the overall performance of a product, service, or system is suitable for its intended use, including its compliance with regulatory requirements, and its ability to meet the needs of its intended users, checking internally against specifications and regulations. For example, for an industrial product manufacturing, a validation process may include consumer surveys that inform product design, modeling and simulations for validating the design, prototype testing for failure limits and feedback surveys from buyers.
Common Verification & Validation (V&V) products: Regulatory and certification standards, compliances, calculations, and tests (e.g., for the development, testing, and certification of products and/or solutions) are referred to herein as “common V&V products.”
DE tool: A tool or DE tool is a DE application software (e.g., a CAD software), computer program, and/or script that creates or manipulates a DE model during at least one stage or phase of a product lifecycle. A DE tool may comprise multiple functions or methods.

### IDMP/IDEP and the Digital Platform

Interconnected Digital Engineering Platform (IDEP), also referred to as a “Digital Engineering and Certification Ecosystem”: According to the DAU, a “DE ecosystem” is the “interconnected infrastructure, environment, and methodology (process, methods, and tools) used to store, access, analyze, and visualize evolving systems' data and models to address the needs of the stakeholders.” Embodiments of the IDEP as disclosed herein comprise software platforms running on hardware to realize the aforementioned capabilities under zero-trust principles. Specifically, an embodiment of the IDEP is a software platform that interconnects a plurality of spliced DE model files through one or more software-defined digital threads (see FIGS. 1-4). A DE and certification ecosystem performs verification and validation tasks, defined next. An IDEP may be considered a type of Interconnected Digital Model Platform (IDMP) when one or more of the digital models are engineering or science related, the IDMP being defined below. In general, any reference to an IDEP in the specification and drawings can be considered equivalent to a reference to an IDMP, and vice versa, and any feature, embodiment, or description in relation to one applies analogously to the other. The terms “Interconnected” and “Integrated” are used interchangeably herein.
Interconnected Digital Model Platform (IDMP): Embodiments of the IDMP as disclosed herein include interconnected infrastructure, environment, and methodology (process, methods, and tools) used to store, access, analyze, visualize, and modify data and digital models associated with a product or system. In some embodiments, IDMPs include software platforms running on hardware to realize the aforementioned capabilities under zero-trust principles. Specifically, an embodiment of the IDMP is a software platform that interconnects a plurality of spliced model files through one or more software-defined digital threads. IDEP is a special class of IDMP for use in the field of digital engineering with digital engineering model files. IDEP and IDMP may both be known more simply as “digital model platform”, “digital software platform,” and/or “digital platform.”
Hyperscale capabilities: The ability of a system architecture to scale adequately when faced with massive demand.
IDEP enclave or DE platform enclave: A central command hub responsible for the management and functioning of DE platform operations. An enclave is an independent set of cloud resources that are partitioned to be accessed by a single customer (i.e., single-tenant) or market (i.e., multi-tenant) that does not take dependencies on resources in other enclaves.
IDEP exclave or DE platform exclave: A secondary hub situated within a customer environment to assist with customer DE tasks and operations. An exclave is a set of cloud resources outside enclaves managed by the IDEP, to perform work for individual customers. Examples of exclaves include virtual machines (VMs) and/or servers that the IDEP maintains to run DE tools for customers who may need such services.
Admins or Administrators: Project managers or other authorized users. Admins may create templates in the documentation system and have high-level permissions to manage settings in the IDEP.
Requesters: Users who use the platform for the implementation of the modeling and simulations towards certification and other purposes, and who may generate documentation in the digital documentation system, but do not have admin privileges to alter the required templates, document formats, or other system settings.
Reviewers/Approvers: Users who review and/or approve templates, documents, or other system data.
Contributors: Users who provide comments or otherwise contribute to the IDEP.
AI Agent or Tool Agent: a software entity or module that takes instructions from the enclave and acts on behalf of a user or another program to perform specific tasks or operations related to an AI model or a DE tool. An AI agent or a tool agent may be designed as part of the IDMP but deployed by a customer within a secured customer environment to interface in-between the IDMP, AI models, and/or proprietary tools the customer is licensed for. Inside the customer environment, modular agents interact directly with the domain-specific tools and models to allow for bi-directional data flow across distributed tools.
Resource-capability mapping: A framework for identifying and linking available resources with the capabilities they enable or support. An exemplary resource-capability mapping is the IDMP API, or platform API, where the resource refers to third-party tools and functions integrated into and accessible via the IDMP, and where the exemplary capability refers to IDMP functions written in scripts for completing certain tasks using the available resource. Such resource-capability mappings may be used to identify how tool-specific resources such as tool functions, access and control capabilities, human-machine interfaces, processes, and objects can be allocated, invoked, and utilized efficiently and effectively to achieve specific IDMP platform functions or tasks. Resource capability mapping also assists with zero-knowledge implementations where the capability details are available to a user while the specific digital tool resource or its functions are only mapped within the customer environment. Another example of the resource-capability mapping framework is the variable mapping table disclosed herein.
User intent: The goal, objective, or desired outcome that a user aims to achieve when interacting with the IDMP/IDEP. User intent may be expressed through various forms of input, such as user actions, natural language prompts, commands, or selections within the platform interface.
User actions: Specific interactions, inputs, or operations performed by a user within the IDMP/IDEP. User actions may include, but are not limited to, mouse clicks, keyboard inputs, voice commands, or any other form of interaction with the platform's interface or components.

### Model Splicing on IDMP/IDEP

Application Programming Interface (API): A software interface that provides programmatic access to services by a software program, thus allowing application software to exchange data and communicate with each other using standardized requests and responses. It allows different programs to work together without revealing the internal details of how each works. A DE tool is typically provided with an API library for code-interface access.
Script: A computer-executable sequence of instructions that is interpreted and run within or carried out by another program, without compilation into a binary file to be run by itself through a computer processor without the support of other programs.
API scripts: Scripts that implement particular functions available via the IDEP as disclosed herein. An API script may be an API function script encapsulated in a model splice, or an “orchestration script” or “platform script” that orchestrates a workflow through a digital thread built upon interconnected model splices.
Platform API or IDMP/IDEP API: A library of API scripts available on the IDEP/IDMP as disclosed herein.
API function scripts, “splice functions,” “splice methods,” “ISTARI functions,” or “function nodes”: A type of API scripts. When executed, an API function script inputs into or outputs from a DE model or DE model splice. An “input” function, input method, or “input node” allows updates or modifications to an input DE model. An “output” function, output method, or “output node” allows data extraction or derivation from an input DE model via its model splice. An API function script may invoke native API function calls of native DE tools, where the terms “native” and “primal” may refer to existing DE model files, functions, and API libraries associated with specific third-party DE tools, including both proprietary and open-source ones.
Endpoints: an endpoint in the context of software and networking is a specific digital location or destination where different software systems communicate with each other. It enables external systems to access the features or data of an application, operating system, or other services. An API endpoint is the point of interaction where APIs receive requests and return data in response. A software development kit (SDK) endpoint or SDK-defined endpoint similarly provides a service handle for use with an SDK. References to API endpoints in the present disclosure are equally applicable to SDK endpoints.
Artifact: According to the DAU, a digital artifact is “an artifact produced within, or generated from, a DE ecosystem” to “provide data for alternative views to visualize, communicate, and deliver data, information, and knowledge to stakeholders.” In the present disclosure, a “digital artifact” or “artifact” is an execution result from an output API function script within a model splice. Multiple artifacts may be generated from a single DE model or DE model splice. In some embodiments, as a matter of design choice, a digital artifact is atomic and indivisible in terms of security levels, so that permissions for users to access and/or modify the digital artifact apply to the digital artifact as a whole, and may not apply to segments of the digital artifact. In other embodiments, a digital artifact includes segments that may have different access (e.g., viewing) and modification (e.g., updating) security levels. Consequently, for a given user, an “authorized artifact” for access is an artifact for which all segments fall under an access security level that allows the given user to access (e.g., view) it. Similarly, for a given user, an “authorized artifact” for modification is an artifact for which all segments fall under a modification security level that allows the given user to modify (e.g., update) it.
Model splice: Within the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. The splice functions provide unified and standardized input and output API endpoints for accessing and manipulating the DE model data. The DE model data are model-type-specific, and a model splice is associated with model-type-specific input and output schemas. One or more different model splices may be generated from the same input DE model file(s), based on the particular user application under consideration, and depending on data access restrictions. In some contexts, the shorter terms “splice”, “wrapper”, and/or “graft” are used to refer to spliced, wrapped, and/or grafted DE models.
Model representation: Within the present disclosure, “model representation” of a given DE model includes any embodiment of the engineering model in the form of DE model file(s), model splices, or collections of digital artifacts derived from the DE model. In some embodiments, a DE model representation comprises model-type-specific locators to DE model data and metadata, potentially including standardized input and output API endpoints for accessing and manipulating the DE model data. Discussions related to the usage of model splices in the present disclosure are applicable to any other forms of model representation as well.
Model splicing or DE model splicing: A process for generating a model splice from a DE model file. DE model splicing encompasses human-readable document model splicing, where the DE model being spliced is a human-readable text-based document.
Model splicer: Program code or script (uncompiled) that performs model splicing of DE models. A DE model splicer for a given DE model type, when applied to a specific DE model file of the DE model type, retrieves, extracts, or derives DE model data associated with the DE model file, generates and/or encapsulates splice functions and instantiates API endpoints according to input/output schemas.

### Digital Threads

Model splice linking: Generally, model splice linking refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first and a second splice (e.g., input splice functions from both model splices are called upon). In the present disclosure, “model linking” and “model splice linking” may be used interchangeably, as linked model splices map to correspondingly linked DE models.
Digital thread, Software-defined digital thread, Software-code-defined digital thread, or Software digital thread: According to the DAU, a digital thread is “an extensive, configurable and component enterprise-level analytical framework that seamlessly expedites the controlled interplay of authoritative technical data, software, information, and knowledge in the enterprise data-information-knowledge systems, based on the digital system model template, to inform decision makers throughout a system's lifecycle by providing the capability to access, integrate, and transform disparate data into actionable information.” Within the IDEP as disclosed herein, a digital thread is a platform script that calls upon the platform API to facilitate, manage, or orchestrate a workflow through linked model splices to provide the aforementioned capabilities. That is, a digital thread within the IDEP is a computer-executable script that connects data from one or more DE models, data sources, or physical artifacts to accomplish a specific mission or business objective, and may be termed a “software-defined digital thread” or “software digital thread” that implements a communication framework or data-driven architecture that connects traditionally siloed DE models to enable seamless information flow among the DE models via model splices. In various embodiments, a digital thread associated with a digital twin is configured to execute a scripted workflow associated with the digital twin.
Tool linking: Similar to model splice linking, tool linking generally refers to jointly accessing two or more DE tools via model splices, where model splice functions that encapsulate disparate DE tool functions are called upon jointly to perform a DE task.
Workflow: A workflow typically representing an entire process or sequence of operations that achieves a specific goal or outcome. It encompasses the complete set of activities, from initiation to completion, that are required to fulfill a business process or software function. Workflows often involve multiple participants, systems, or departments and can be complex, involving branching paths, decision points, and parallel processes.
Digital Workflow: A digital workflow refers to a series of digital tasks and process steps that are carried out electronically to achieve a specific outcome. Digital workflows involve the use of digital tools, software applications, and technologies to streamline and manage various activities within an organization or project. They often enable full or partial automation, and typically include elements such as data input, information processing, task assignment, approval processes, and document management, all conducted in a digital environment.
Tasks and Process Steps: A task is usually a subset of a workflow and represents a discrete unit of work that needs to be completed as part of the larger process. Tasks are more specific and focused than workflows and are often assigned to individual agents. They have defined inputs, outputs, and objectives. Multiple tasks typically make up a workflow, and each task contributes to the overall goal of the workflow. A process step, or simply “step”, in turn, is the smallest unit of work within this hierarchy. Process steps are the individual actions or operations that, when combined, form a task. They are highly specific, often atomic actions that represent the most granular level of detail in a workflow. Multiple process steps are usually required to complete a single task, and the successful execution of all steps results in the completion of the task. In the context of digital workflows, the terms “digital task”, “digital workflow task”, and “digital engineering task” are used interchangeably herein.
Digital Task Implementation: An orchestration script, or a platform script, may be generated over the IDMP to implement a digital task including one or more process steps, where the “implementation” of the digital task through an orchestration script means that the orchestration script includes instructions carrying out each process step required to complete the digital task.

### Digital Twins

Digital twin: According to the DAU, a digital twin is “a virtual replica of a physical entity that is synchronized across time. Digital twins exist to replicate configuration, performance, or history of a system. Two primary sub-categories of digital twin are digital instance and digital prototype.” A digital instance is “a virtual replica of the physical configuration of an existing entity; a digital instance typically exists to replicate each individual configuration of a product as-built or as-maintained.” A digital prototype is “an integrated multi-physical, multiscale, probabilistic model of a system design; a digital prototype may use sensor information and input data to simulate the performance of its corresponding physical twin; a digital prototype may exist prior to realization of its physical counterpart.” Thus, a digital twin is a real-time virtual replica of a physical object or system, with bi-directional information flow between the virtual and physical domains. In some embodiments, a digital twin is a digital replica configured to run in a virtual environment and instantiated through a scripted digital thread, where the digital thread accesses data (e.g., digital artifacts) from a set of digital models through splicing. A digital twin may be instantiated, run, or executed, through a digital thread. Updating a digital twin may include the actions of modifying, deleting, and/or adding data to its twin configuration, to an associated digital thread, or to an associated digital model associated with the updated digital twin. In one embodiment, digital twins may be ephemeral and may have in-built time and space restrictions (see “twin configuration” definition below). In various embodiments, a physical twin is a physical object instantiated in a physical environment based on a set of model files through an MBSE manufacturing and/or prototyping process. In various embodiments, digital twins can be created for both physical products and physical processes. They are not limited to tangible items like machinery or vehicles; they can also simulate complex physical processes, such as manufacturing workflows or supply chain logistics, to improve efficiency and predict outcomes. This flexibility allows digital twins to be applied across various industries and scenarios.
Authoritative twin: A reference design configuration at a given stage of a product life cycle. At the design stage, an authoritative twin is the twin configuration that represents the best design target. At the operational stage, an authoritative twin is the twin configuration that best responds to the actual conditions on the ground or “ground-truths”.
External Feedback: In various embodiments, external feedback comprises feedback data from at least one source external to a given digital twin, including digital twin performance data as received, analyzed or processed by the IDMP. External feedback may also include physical twin performance data, data from a virtual sensor, data from a physical sensor, user input (e.g., a user prompt, or a user response over a GUI), data from a simulation, a product certification file, or a product requirements file. In some embodiments, external feedback may also include feedback from control algorithms or processes in the IDMP that track digital twin performance (e.g., tracking error levels and/or tolerance between digital and corresponding physical twin data). External feedback data can also include feedback data that is external to the IDMP.
Twin Configuration: A twin configuration includes data specifying the configuration of a digital or a physical twin. Twin configurations may include a twin version identifier identifying the digital twin, one or more digital thread identifiers identifying the digital threads responsible for instantiating and running a twin, one or more model representation identifiers (e.g., URIs) identifying the model representations that are used by the twin, and an authoritative twin indicator (e.g., a boolean or binary variable) indicating whether the twin is an authoritative twin. The various twin configurations associated with the various physical and digital twins of a given product may be stored in a twin configuration set of the IDMP. In some embodiments, the twin configuration set acts as a specification database for the various digital and physical twins for one or more products or systems. In some embodiments, the twin configuration of a digital twin may include time and space restrictions on the associated digital twin, such as a validity time frame, a validity cutoff time, a validity space, or a validity geographical area (e.g., geofencing, proximity to another twin configuration).

### Security

Zero-trust security: An information security principle based on the assumption of no implicit trust between any elements, agents, or users. Zero trust may be carried out by implementing systematic mutual authentication and least privileged access, typically through strict access control, algorithmic impartiality, and data isolation. Within the IDEP as disclosed herein, least privileged access through strict access control and data isolation may be implemented via model splicing and the IDEP system architecture.
Zero-knowledge approach: A zero-knowledge approach in data operations refers to a method where computational processes and data analyses are conducted such that the underlying data remains completely confidential and undisclosed to the parties performing the operations. This technique enables the validation, aggregation, and processing of data without exposing the actual data content, thereby preserving privacy and confidentiality.
Security Network: Information security networks are security networks that are configured to maintain the confidentiality, integrity, and availability of digital information (e.g., digital model data) through cybersecurity measures such as encryption, firewalls, intrusion detection systems, and access controls. A “security network” is a set of networked resources having identical access control restrictions, where each networked resource provides access to one or more digital model files. In various embodiments, the networked resources of a security network may be determined by one or a combination of the following factors: (1) having a minimum security access level, (2) belonging to a given physical network, (3) belonging to a given customer organization, and (4) belonging to a given business division.
Information Security (Infosec) Levels: Also referred to as “security levels” or “security access levels”, information security (Infosec) levels designate classifications assigned to data and operations based on sensitivity and security requisites, dictating access control and data handling procedures across networks. In some embodiments, an infosec level may define a security network.

### Testing

Testing: The process of evaluating and verifying the functionality, performance, and reliability of software components, digital workflows, or systems within a software platform such as the IDMP/IDEP. Testing may include assessing various aspects such as quality assurance (QA), quality control (QC), usability, and end-to-end functionality of the platform, its components, or the digital tasks executed on it.
Human-readable test scenarios: Descriptions of test cases or testing situations written in natural language that are easily understandable by human users or testers. These scenarios may outline the steps, conditions, and expected outcomes of a particular test. The test scenarios usually include a sequence of human-readable testing steps that are carried out on the software platform. In some embodiments, the testing steps are configured to evaluate the performance of the software platform in accomplishing the user intent. In other embodiments, they are configured to verify the ability of the software platform to accomplish the user intent.
Test script: A set of instructions, typically in the form of computer code or a structured sequence of commands, designed to automate the execution of a specific test scenario within the IDMP/IDEP. Test scripts may be generated based on human-readable test scenarios and may be used to perform automated testing of various platform components, digital workflows, or system functionalities.

### CONCLUSIONS

One of ordinary skill in the art knows that the use cases, structures, schematics, flow diagrams, and steps may be performed in any order or sub-combination, while the inventive concept of the present invention remains without departing from the broader scope of the invention. Every embodiment may be unique, and step(s) of method(s) may be either shortened or lengthened, overlapped with other activities, postponed, delayed, and/or continued after a time gap, such that every active user and running application program is accommodated by the server(s) to practice the methods of the present invention.

For simplicity of explanation, the embodiments of the methods of this disclosure are depicted and described as a series of acts or steps. However, acts or steps in accordance with this disclosure can occur in various orders and/or concurrently, and with other acts or steps not presented and described herein. Furthermore, not all illustrated acts or steps may be required to implement the methods in accordance with the disclosed subject matter. In addition, those skilled in the art will understand and appreciate that the methods could alternatively be represented as a series of interrelated states via a state diagram or events or their equivalent.

As used herein, the singular forms “a,” “an,” and “the” include plural references unless the context clearly indicates otherwise. Thus, for example, reference to “a cable” includes a single cable as well as a bundle of two or more different cables, and the like.

The terms “comprise,” “comprising,” “includes,” “including,” “have,” “having,” and the like, used in the specification and claims are meant to be open-ended and not restrictive, meaning “including but not limited to.”

In the foregoing description, numerous specific details are set forth, such as specific structures, dimensions, processes, parameters, etc., to provide a thorough understanding of the present invention. The particular features, structures, materials, or characteristics may be combined in any suitable manner in one or more embodiments. The words “example”, “exemplary”, “illustrative” and the like, are used herein to mean serving as an example, instance, or illustration. Any aspect or design described herein as “example” or its equivalents is not necessarily to be construed as preferred or advantageous over other aspects or designs. Rather, use of the words “example” or equivalents is intended to present concepts in a concrete fashion.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A, X includes B, or X includes both A and B, then “X includes A or B” is satisfied under any of the foregoing instances.

Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment” throughout this specification are not necessarily all referring to the same embodiment.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. For example, in some exemplary embodiments, the term “about” may include the recited number±10%, such that “about 10” would include from 9 to 11. In other exemplary embodiments, the term “about” may include the recited number±X %, where X is considered the normal variation in said measurement by one of ordinary skill in the art.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom. Features of the transitory physical storage medium described may be incorporated into/used in a corresponding method, digital documentation system and/or system, and vice versa.

Although the present invention has been described with reference to specific exemplary embodiments, it will be evident that the various modifications and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention, as defined by the claims.

What is claimed is:

1. One or more non-transitory storage media storing program code executable by a hardware processor, the program code when executed by the hardware processor causing the hardware processor to implement a process for optimizing a digital workflow within a digital model platform, the one or more non-transitory storage media comprising program code to:
receive a user request from a user related to the digital workflow in the digital model platform, wherein the digital workflow comprises a plurality of digital engineering tasks on the digital model platform;
generate a decentralized digital thread associated with the digital workflow based on the user request, wherein the decentralized digital thread comprises a computer-executable script written in a scripting language, wherein the decentralized digital thread comprises a plurality of orchestration scripts, wherein the plurality of digital engineering tasks of the digital workflow are carried out through the plurality of orchestration scripts, and wherein the decentralized digital thread accesses two different digital artifacts extracted from two or more digital models;
generate a workflow data structure based on the decentralized digital thread, wherein the workflow data structure comprises workflow nodes representing the plurality of digital engineering tasks, and workflow connections representing data flow required by the plurality of digital engineering tasks;
calculate a workflow cost associated with executing the plurality of digital engineering tasks in the workflow data structure;
identify a modification to the workflow data structure by processing the workflow data structure, wherein the modification to the workflow data structure reduces the workflow cost;
generate an updated workflow data structure based on the workflow data structure and the modification; and
generate an updated decentralized digital thread based on the updated workflow data structure.

2. The one or more non-transitory storage media of claim 1, wherein the two different digital artifacts have at least two distinct security access levels from two or more distinct security networks.

3. The one or more non-transitory storage media of claim 1, wherein the workflow cost comprises a weighted sum of workflow connection costs, and wherein a given workflow connection cost is associated with a given data flow between two or more given workflow nodes.

4. The one or more non-transitory storage media of claim 1, wherein the workflow cost comprises a weighted sum of workflow node costs, and wherein a given workflow node cost is associated with a given workflow task represented by a given workflow node.

5. The one or more non-transitory storage media of claim 1, wherein the modification comprises at least one of deleting a workflow node, deleting a workflow connection, adding a workflow node, and adding a workflow connection.

6. The one or more non-transitory storage media of claim 1, wherein the modification comprises modifying at least one of a workflow node, a workflow connection, a connection cost, and a node cost.

7. The one or more non-transitory storage media of claim 1, wherein the workflow data structure is a graph.

8. The one or more non-transitory storage media of claim 7, wherein the graph is a directed acyclic graph (DAG).

9. The one or more non-transitory storage media of claim 7, wherein the program code to process the workflow data structure utilizes a graph optimization algorithm, and wherein the updated workflow data structure is generated based on an output of the graph optimization algorithm.

10. The one or more non-transitory storage media of claim 9, wherein the graph optimization algorithm is a minimum spanning tree (MST) algorithm.

11. The one or more non-transitory storage media of claim 1, wherein one of the two different digital artifacts is accessed by the decentralized digital thread through a model representation.

12. The one or more non-transitory storage media of claim 11, wherein the model representation comprises a model splice connected to a digital model file, wherein the model splice comprises one or more splice data items and a splice function providing an Application Programming Interface (API) or Software Development Kit (SDK) endpoint to access to the digital artifact.

13. The one or more non-transitory storage media of claim 1, wherein the digital workflow is a certification workflow in a digital engineering process.

14. The one or more non-transitory storage media of claim 1, further comprising program code to:
provide a visual representation of the updated workflow data structure to the user;
receive feedback data from the user; and
further update the updated workflow data structure based on the feedback data.

15. The one or more non-transitory storage media of claim 1, wherein at least one connection and/or at least one node of the workflow data structure comprises metadata from a cryptographic token generated based on one of the two different digital artifacts.

16. A computer-implemented method for optimizing a digital workflow within a digital model platform, comprising:
receiving a user request from a user related to the digital workflow in the digital model platform, wherein the digital workflow comprises a plurality of digital engineering tasks on the digital model platform;
generating a decentralized digital thread associated with the digital workflow based on the user request, wherein the decentralized digital thread comprises a computer-executable script written in a scripting language, wherein the decentralized digital thread comprises a plurality of orchestration scripts, wherein the plurality of digital engineering tasks of the digital workflow are carried out through the plurality of orchestration scripts, and wherein the decentralized digital thread accesses two different digital artifacts extracted from two or more digital models;
generating a workflow data structure based on the decentralized digital thread, wherein the workflow data structure comprises workflow nodes representing the plurality of digital engineering tasks, and workflow connections representing data flow required by the plurality of digital engineering tasks;
calculating a workflow cost associated with executing the plurality of digital engineering tasks in the workflow data structure;
identifying a modification to the workflow data structure by processing the workflow data structure, wherein the modification to the workflow data structure reduces the workflow cost;
generating an updated workflow data structure based on the workflow data structure and the modification; and
generating an updated decentralized digital thread based on the updated workflow data structure.

17. The computer-implemented method of claim 16, wherein the workflow data structure is a graph, wherein processing the workflow data structure uses a graph optimization algorithm, and wherein the updated workflow data structure is generated based on an output of the graph optimization algorithm.

18. The computer-implemented method of claim 16, further comprising:
providing a visual representation of the updated workflow data structure to the user;
receiving feedback data from the user; and
further updating the updated workflow data structure based on the feedback data.

19. One or more non-transitory storage media storing program code executable by a hardware processor, the program code when executed by the hardware processor causing the hardware processor to implement a process for optimizing a digital workflow within a digital model platform, the one or more non-transitory storage media comprising program code to:
receive a user request from a user related to the digital workflow in the digital model platform, wherein the digital workflow comprises a plurality of digital engineering tasks on the digital model platform;
generate a decentralized digital thread associated with the digital workflow based on the user request, wherein the decentralized digital thread comprises a computer-executable script written in a scripting language, wherein the decentralized digital thread comprises a plurality of orchestration scripts, wherein the plurality of digital engineering tasks of the digital workflow are carried out through the plurality of orchestration scripts, and wherein the decentralized digital thread accesses two different digital artifacts extracted from two or more digital models;
generate a workflow data structure based on the decentralized digital thread, wherein the workflow data structure comprises workflow nodes representing the plurality of digital engineering tasks, and workflow connections representing data flow required by the plurality of digital engineering tasks;
generate an updated workflow data structure based on the workflow data structure using a workflow optimization machine learning (ML) model trained using a workflow dataset of the digital model platform comprising a plurality of sample workflow data structures and a plurality of corresponding modified sample workflow data structures, wherein a workflow cost of a given sample workflow data structure of the workflow dataset is higher that a modified workflow cost of a given corresponding modified sample workflow data structure, wherein the workflow cost of the given sample workflow data structure is associated with executing one or more given digital engineering tasks of the given sample workflow data structure, and wherein the workflow data structure is updated by modifying a data structure element of the workflow data structure; and
generate an updated decentralized digital thread based on the updated workflow data structure.

20. The one or more non-transitory storage media of claim 19, wherein the program code to generate the updated workflow data structure further comprises program code to:
predict a predicted data structure element using a workflow prediction machine learning (ML) model trained using a prediction dataset of the digital model platform comprising two or more sample workflow data structures and two or more corresponding predicted data structure elements, wherein the predicted data structure element comprises at least one of a workflow node and a workflow connection, and
wherein the updated workflow data structure comprises the predicted data structure element.

21. The one or more non-transitory storage media of claim 19, wherein at least one workflow of the workflow dataset is derived from one or more sample user actions stored by the digital model platform in a user action database of the digital model platform.

22. The one or more non-transitory storage media of claim 19, further comprising program code to:
provide a visual representation of the updated workflow data structure to the user;
receive feedback data from the user; and
further update the workflow data structure based on the feedback data.

23. One or more non-transitory storage media storing program code executable by a hardware processor, the program code when executed by the hardware processor causing the hardware processor to implement a process for optimizing a digital workflow within a digital model platform, the one or more non-transitory storage media comprising program code to:
receive a user request from a user related to the digital workflow in the digital model platform, wherein the digital workflow comprises a plurality of digital engineering tasks on the digital model platform;
generate a decentralized digital thread associated with the digital workflow based on the user request, wherein the decentralized digital thread comprises a computer-executable script written in a scripting language, wherein the decentralized digital thread comprises a plurality of orchestration scripts, wherein the plurality of digital engineering tasks of the digital workflow are carried out through the plurality of orchestration scripts, and wherein the decentralized digital thread accesses two different digital artifacts extracted from two or more digital models;
generate a workflow data structure based on the decentralized digital thread, wherein the workflow data structure comprises workflow nodes representing the plurality of digital engineering tasks, and workflow connections representing data flow required by the plurality of digital engineering tasks;
provide a visual representation of the workflow data structure to the user;
calculate a workflow cost associated with executing the plurality of digital engineering tasks in the workflow data structure;
receive a modification to the workflow data structure from the user, wherein the modification to the workflow data structure reduces the workflow cost;
generate an updated workflow data structure based on the workflow data structure and the modification; and
generate an updated decentralized digital thread based on the updated workflow data structure.
